(19) United States
(12) Patent Application Publication
(10) Pub. No.: US 2006/0003841 A1
(43) Pub. Date: Jan. 5, 2006

(54) Game system, server and game control method

(75) Inventors: Takahiko Kobayashi, Tokyo (JP); Junichi Kogo, Tokyo (JP)

Correspondence Address: SNIDER & ASSOCIATES, P. O. BOX 27613, WASHINGTON, DC, 20038-7613, US

(73) Assignee: Aruze Corporation, Tokyo (JP)

(21) Appl. No.: 11/171,582

(22) Filed: Jul. 1, 2005

(30) Foreign Application Priority Data
Jul. 1, 2004 (JP) 2004-196030
Jul. 1, 2004 (JP) 2004-196031

(51) Int. Cl. G06F 17/00

(52) U.S. Cl. 463/42

(57) ABSTRACT

A game system which provides a game system which can rouse competitive spirits of players and create strategic characteristics to the way of carrying out a game. Specifically, the present invention provides a game system in which a plurality of terminal devices are connected to a server via communication lines, and in which a game can be executed by each of a plurality of players operating each of the terminal devices, the game system comprising: level storing means for storing a level value of a player; level setting means for setting a predetermined level for the player to store it as the level value in the level storing means; condition setting means for setting a condition in a game for the player; condition achievement determination means for determining whether or not the player clears the condition; and game result determination means for determining a game result on the basis of, when the condition achievement determination means determines that the player clears a condition, the condition cleared by the player, and the level value of the player which is stored in the level storing means.

### RELATED APPLICATIONS

This application claims the priority of Japanese Patent Application Nos. 2004-196030 and 2004-196031 filed on Jul. 1, 2004, which is incorporated herein by reference. Further, this application is related to two U.S. patent applications, which will be filed with the U.S. Patent Office by Jul. 1, 2005 based on Japanese Patent Application Nos. 2004-196033 (filed on Jul. 1, 2004); and based on Japanese Patent Application Nos. 2004-196032 (filed on Jul. 1, 2004) and 2004-344679 (filed on Nov. 29, 2004) respectively. These applications including specifications, drawings, and claims are expressly incorporated herein by reference in their entirety.

### BACKGROUND OF THE INVENTION

1. Field of the Invention

The present invention relates to a game system in which a plurality of terminal devices are connected to a server via communication lines, a server which configures the game system, and a game control method which is executed by the server. Particularly, the present invention relates to a game system in which massively multiplayer online games such as MMORPG (Massively Multiplayer Online Role Playing Game), RTS (Real Time Strategy), FPS (First Person Shooting Game) and the like can be executed, a server which configures the game system, and a game control method which is executed by the server.

2. Description of the Prior Art

In recent years, along with development of information and communications technology, a game system is widely used in which a plurality of terminal devices for game-arcade use or domestic use are connected to the servers by means of communication lines, and various online games can be executed in the game system. Recently, for example, massively multiplayer online games such as MMORPG (Massively Multiplayer Online Role Playing Game), RTS (Real Time Strategy), FPS (First Person Shooting Game) and the like are provided as the online games.

From the perspective of a player, in such massively multiplayer online games, the player can play a game with an unspecified number of players through the network such as Internet in remote locations nationally or internationally, without even knowing each other's face. The big attraction of the massively multiplayer online games is that the players can communicate with each other by means of such a medium as a game, thus it is strongly supported by many countries in the world. From the perspective of a game production company, in the massively multiplayer online games, the data or programs related to a new event, character, item and the like are sequentially updated and distributed to each terminal device via the network, thus a game environment can be constructed in which the player can continue playing a game semipermanently without getting bored with it. Therefore, it has the advantage of being able to secure the stability of earnings.

In the massively multiplayer online games, generally a character corresponding to each player is established, and the player participates in a game in a virtual space of the game by operating the player's own character (see Japanese Unexamined Patent Publication No. 2002-224448, for example). As the player acquaints himself with the game, the corresponding character clears various conditions (so called “mission”) to gain experience. As a result, the player or the character operated by the player can increase the level (level value) established inside the game, and the capability or position improves inside the game as the level (level value) increases, whereby various functions can be operated.

Further, when the conditions (subject) are cleared, the amount of cash according to the degree of difficulty of the condition (subject) is granted to the player as a reward so as to be used during a game, thus the more conditions (subject) the player clears, the more cash which can be used in a game the player can acquire, whereby the player can purchase a weapon, item, and the like which can be used in a game so as to play the game advantageously.

In an online game, normally the game axis in a virtual game space is shared by all players. Therefore, when the players play a game frequently or for a long period of time, some of the players sometimes clear most of the conditions that can be set in the game. When such situation arises, there are not many conditions that other player can challenge, and the fascinating aspect of the game may overly diminish, which is a problem. Therefore, as a conventional game system, for example there is a game system in which the number of conditions that are cleared within a predetermined time is limited for each player (for example, see Japanese Unexamined Patent Publication No. 2002-224448). According to the game system described in this publication document, some of the players cannot clear most of the conditions that can be set in the game, thus other player can also challenge various conditions, which makes it possible to provide a game which can be enjoyed by numbers of players.

However, according to the game system described in the above publication document, challenge to a new condition is restricted for a player who plays a game enthusiastically, clears numbers of conditions, and increases the level value, whereas a player who plays the game later can challenge the condition and increase the level value. Therefore, there is a problem (first problem) that it is difficult for the player, who plays the game enthusiastically, to gain an advantage over the abovementioned other player, thus competitive spirits of both players are reduced.

Further, in accordance with each condition, an award (for example, money which can be used in a game, and the like), which is granted to a player when the player clears the condition, is set in advance, thus the game can be carried out most smoothly if the player challenges a condition with a low difficulty level and thereafter challenges a condition with a high difficulty level sequentially in accordance with the increase of the level value. Therefore, the strategic characteristics are low with respect to proceeding a game, i.e., the sequence of challenging a plurality of conditions, whereby a game lacks in spice, which is a problem (first problem).

On the other hand, recently there is an online game which is provided with some effects in which a plurality of players have to deal with a specific subject. When such effects are provided, a player has to search for other player who becomes a partner in a game, so the player can have a communication with this other player spontaneously. Further, in general, in the case of a game in which a plurality of types of subjects are sequentially set for one player, and which involves effects for clearing all of the plurality of types of subjects, if there is a subject among the plurality of types of subjects which the player is not good at, the player cannot clear the subject, and the game cannot be carried out any further, thus the player might give up continuing the game. Therefore, even if the player is given a chance to select a subject, the player eventually has to clear the subject that he is not good at. However, when a plurality of players challenge the same subject, even if the player cannot clear the subject, if other player clears the subject, the game can be carried out ongoingly.

However, the amount of money which can be obtained when clearing a subject, and which can be used in a game is already set. Therefore, in the case where there are provided effects in which a subject has to be challenged by a plurality of players, it is boring for the players who are good at the subject to challenge the same subject with the players who are not good at the subject, which is a problem.

Particularly, in an online game, the game skills vary considerably among the unspecified number of players who carry out a game in the same virtual game space. Therefore, when the effects in which a subject has to be challenged by a plurality of players together are provided, the players having low game skills depend on the players having high skills, which is burdensome. At the same time, since the players having high skills have to challenge the same subject with other players, it is inevitable for the players with high skills to throw in with the players with low skills. However, in such conditions where the relationship among the players with high skills and the players with low skills becomes twisted, making a communication easy to be performed by both players might worsen the relationship between the both players (second problem).

### SUMMARY OF THE INVENTION

The present invention is contrived in view of the above-described first problem, and the object thereof is to provide a game system which can rouse competitive spirits of players and create strategic characteristics to the way of carrying out a game, a server which configures the game system, and a game control method which is executed by the server.

In order to solve the first problem described above, the present invention (sometimes referred to as “the first invention” hereinafter) provides the following. (1) A game system in which a plurality of terminal devices are connected to a server via communication lines, and in which a game can be executed by each of a plurality of players operating each of the terminal devices, the game system comprising:

level value storing means for storing a level value of a player;

level value setting means for setting a predetermined level in accordance with a game result, and storing a level, which is set with respect to the ID data of the player, in the level value storing means as the level value;

condition setting means for setting a condition that the player should achieve as a game result;

condition achievement determination means for determining whether or not the player clears the condition which is set in the condition setting means; and

game result determination means for determining, when the condition achievement determination means determines that the condition set by the condition setting means is cleared, a game result on the basis of the condition cleared by the player, and the level value of the player which is stored in the level value storing means.

According to the invention described in (1), a game result is determined on the basis of the condition cleared by the player and on the level value of the player. Therefore, for example, even if the degree of difficulty of the condition is low, and the level value of the player is high, the player can acquire a large amount of reward as a game result, in comparison with a player having a low level value. Further, for example, in the case where the level value of the player is high, even if he clears a condition of high degree of difficulty, the player acquires only a small amount of reward in comparison with the player having a low level value. In this manner, the invention described above can achieve an effect allowing that the fascinating aspect of the game itself can be extended in various ways. Furthermore, the invention can be applied to a match-up game so as to function to grant the level value as a handicap of each other. Therefore, although the game system described in Japanese Unexamined Patent Publication No. 2002-224448 is configured such that the number of conditions that can be cleared by each player is restricted to be the same in general, and that numbers of players can enjoy a game by challenging various conditions, according to the invention described in (1), a player who plays a game enthusiastically can acquire a reward corresponding to his own level value, and can gain an advantage over other player. As a result, it is possible to prevent the competitive spirits of both players from being reduced.

Moreover, even in a condition with low degree of difficulty, by making it possible for a player to acquire a large amount of reward in comparison with a player having a low level value as long as the level value of the former player is high, it is possible to create an environment which proves that the way of carrying out a game where conditions are challenged in the order of low degree of difficulty to high degree of difficulty is not necessarily the desirable way of carrying out a game. Consequently, diversification can be generated in the ways of carrying out a game, whereby a strategic, complicated, and yet interesting game can be provided.

Further, the present invention provides the following. (2) The game system according to (1) described above, comprising condition selecting means for selecting any one condition from a plurality of types of conditions in accordance with an input operation performed by a player, wherein the condition setting means sets a condition selected by the condition selecting means.

According to the invention described in (2), since a player can select a condition to challenge, the player can realize a way of carrying out a game that he has in mind, and the strategic characteristics can be increased and the spice of the game can be improved.

The present invention further provides the following. (3) The game system according to (1) described above, wherein the game result determination means determines the amount of money which is available in a game and is granted to the player as a game result.

According to the invention described in (3), the amount of available money which is granted to the player is determined based on the condition cleared by the player and on the level value of the player. Thus, for example, even in a condition with low degree of difficulty, as long as the player has a high level value, the player can acquire a large amount of money that is available in a game. Therefore, in case that the same condition is cleared, a player who increases the level value, playing a game enthusiastically, can acquire a large amount of money that is available in a game, more than other player, can purchase a weapon or an item with the money, and can carry out a game more advantageously than other player. As a result, it is possible to prevent the competitive spirits of both players from being reduced.

The present invention further provides the following. (4) The game system according to (1) described above, wherein the server comprises an arcade server communicably connected to the plurality of terminal devices via dedicated lines, and a center server communicably connected to the arcade server via the communication line. (5) The game system according to (1) described above, wherein the game result determination means determines a game result also on the basis of the number of players who participate in the play for clearing the conditions. (6) The game system according to (1) described above, wherein the game result determination means determines a game result on the basis of a capability value set for the player, along with or in place of the level value of the player. (7) The game system according to (4) described above, wherein the terminal device and the arcade server are provided with the level value storing means, the terminal device is provide with the level value setting means, and the arcade server is provided with the condition setting means, the condition achievement determination means, and the game result determination means.

The present invention further provides the following. (8) A server which is connected to a plurality of terminal devices via communication lines, and which configures a game system in which a game can be executed by each of a plurality of players operating each of the terminal devices, the server comprising:

level value storing means for storing a level value of a player;

level value setting means for setting a predetermined level in accordance with a game result, and storing a level, which is set with respect to the ID data of the player, in the level value storing means as the level value;

condition setting means for setting a condition that the player should achieve as a game result;

condition achievement determination means for determining whether or not the player clears the condition which is set in the condition setting means; and

game result determination means for determining, when the condition achievement determination means determines that the condition set by the condition setting means is cleared, a game result on the basis of the condition cleared by the player, and the level value of the player which is stored in the level value storing means.

According to the invention described in (8), a game result is determined on the basis of the condition cleared by the player and on the level value of the player. Therefore, for example, even if the degree of difficulty of the condition is low, and the level value of the player is high, the player can acquire a large amount of reward as a game result, in comparison with a player having a low level value. Therefore, a player who plays a game enthusiastically can acquire a reward corresponding to his own level value, and can gain an advantage over other player. As a result, it is possible to prevent the competitive spirits of both players from being reduced. Moreover, even in a condition with low degree of difficulty, by making it possible for a player to acquire a large amount of reward, as long as the level value of the player is high, it is possible to create an environment which proves that the way of carrying out a game where conditions are challenged in the order of low degree of difficulty to high degree of difficulty is not necessarily the desirable way of carrying out a game. Consequently, diversification can be generated in the ways of carrying out a game, whereby a strategic, complicated, and yet interesting game can be provided.

The present invention further provides the following. (9) A game control method, which causes a server, which is connected to a plurality of terminal devices via communication lines and which configures a game system in which a game can be executed by each of a plurality of players operating each of the terminal devices, to function as:

level value storing means for storing a level value of a player;

level value setting means for setting a predetermined level in accordance with a game result, and storing a level, which is set with respect to the ID data of the player, in the level value storing means as the level value;

condition setting means for setting a condition that the player should achieve as a game result;

condition achievement determination means for determining whether or not the player clears the condition which is set in the condition setting means; and

game result determination means for determining, when the condition achievement determination means determines that the condition set by the condition setting means is cleared, a game result on the basis of the condition cleared by the player, and the level value of the player which is stored in the level value storing means.

According to the invention described in (9), a game result is determined on the basis of the condition cleared by the player and on the level value of the player. Therefore, for example, even if the degree of difficulty of the condition is low, and the level value of the player is high, the player can acquire a large amount of reward as a game result, in comparison with a player having a low level value. Therefore, a player who plays a game enthusiastically can acquire a reward corresponding to his own level value, and can gain an advantage over other player. As a result, it is possible to prevent the competitive spirits of both players from being reduced. Moreover, even in a condition with low degree of difficulty, by making it possible for a player to acquire a large amount of reward, as long as the level value of the player is high, it is possible to create an environment which proves that the way of carrying out a game where conditions are challenged in the order of low degree of difficulty to high degree of difficulty is not necessarily the desirable way of carrying out a game. Consequently, diversification can be generated in the ways of carrying out a game, whereby a strategic, complicated, and yet interesting game can be provided.

Specifically, the present invention can rouse competitive spirits of players and create strategic characteristics to the way of carrying out a game.

Furthermore, the present invention is contrived in view of the above-described second problem, and the object thereof is to provide a game system which can develop attractiveness of online games, which is that the relationship among the players is prevented from being twisted due to the difference in the game skills among the players, and that a good relationship can be constructed among the players in which the players can communicate with one another by means of a game, a server which configures the game system, and a game control method which is executed by the server.

In order to solve the above-described second problem, the present invention (sometimes referred to as “the second invention” hereinafter) provides the following. (10) A game system in which a plurality of terminal devices are connected to a server via communication lines, and in which a game can be executed by each of a plurality of players operating each of the terminal devices, the game system comprising:

selecting means for a player to select either to perform a play alone or with other player in order to achieve a condition to be cleared, which is set in the game, in accordance with an input operation performed by the player;

player number setting means for setting the number of players who perform the play, on the basis of selection made by the selecting means;

player number storing means for storing the set number of players for each condition to be cleared;

entry number storing means for storing the number of entries of the players into the condition for each condition to be cleared;

entry number updating means for updating the number of entries of the players into the condition and storing the number of entries in the entry number storing means, on the basis of selection made by the selecting means;

determination means for determining whether or not the number of entries stored in the entry number storing means reaches the number of players stored in the player number storing means; and

condition setting means for setting the condition to be cleared with respect to the player who performs the play, when the determination means determines that the number of entries reaches the number of players.

According to the invention described in (10), a player himself can select either to perform a play alone or with other player in order to achieve a condition to be cleared, which is set in a game. Thus, a player who is good at the above-described set condition to be cleared, or a player having a high game skill can select to perform a play alone, and at the same time a player who is not good at the above-described set condition to be cleared, or a player having a low game skill can select to perform the play with other player. Therefore, it is possible to prevent that the game is discontinued by the player who cannot clear the condition that he is not good at, or the player having a low game skill. Further, since the player who challenges a condition that he is good at, or the player having a high game skill can select to perform the play alone, the player who is not good at the above-described set condition to be cleared, or the player having a low game skill does not depend on the player having a high game skill, thus the player having a high game skills does not have to feel troublesome. As a result, it is possible to develop attractiveness of online games, which is that the relationship among the players is prevented from being twisted due to the difference in the game skills among the players, and that a good relationship can be constructed among the players in which the players can communicate with one another by means of a game.

The present invention further provides the following. (11) The game system according to (10) described above, comprising standby image displaying means for displaying a standby image which shows information related to the number of players and/or the number of entries, in response to a determination made by the determination means that the number of entries does not reach the number of players.

According to the invention described in (11), when a player performs a play with other player, a standby image can be used to check how many of the abovementioned other players enter or how many more of the abovementioned other players should enter into the play.

The present invention further provides the following. (12) The game system according to (10) described above, comprising:

condition achievement determination means for determining whether or not the player clears the condition to be cleared; and

reward payout means for, when the condition achievement determination means determines that the player clears the condition, proportionally distributing the amount of money available in the game, which is set in advance in accordance with the type of the condition, in accordance with the number of players who cleared the condition, and granting the money to each player.

According to the invention described in (12), each player can select either to perform the play with other player although a small amount of reward is granted when clearing the condition, or to perform the play alone to acquire a large amount of reward. Thus, diversification can be generated in the game to improve the strategic characteristics.

The present invention further provides the following. (13) The game system according to (10) described above, comprising:

condition achievement determination means for determining whether or not the player clears the condition to be cleared; and

reward payout means for, when the condition achievement determination means determines that the player clears the condition, proportionally distributing the amount of money available in the game, which is set in advance in accordance with the type of the condition, in accordance with the number of players who cleared the condition, and granting the money to each player. (14) The game system according to (10) described above, wherein the server comprises an arcade server communicably connected to the plurality of terminal devices via dedicated lines, and a center server communicably connected to the arcade server via the communication line. (15) The game system according to (11) described above, wherein the standby image displaying means is provided in the terminal device. (16) The game system according to (14) described above, wherein the selecting means is provided in the terminal device, and the payer number storing means, the player number setting means, the entry number storing means, the entry number updating means, the determination means, and the condition setting means are provided in the arcade server. (17) The game system according to (15) described above, wherein the standby image displaying means comprises a touch panel which enables the player to perform an input operation.

The present invention further provides the following. (18) A server which is connected to a plurality of terminal devices via communication lines, and which configures a game system in which a game can be executed by each of a plurality of players operating each of the terminal devices, the server comprising:

selecting means for a player to select either to perform a play alone or with other player in order to achieve a condition to be cleared, which is set in the game, in accordance with an input operation performed by the player;

player number setting means for setting the number of players who perform the play, on the basis of selection made by the selecting means;

player number storing means for storing the set number of players for each condition to be cleared;

entry number storing means for storing the number of entries of the players into the condition for each condition to be cleared;

entry number updating means for updating the number of entries of the players into the condition and storing the number of entries in the entry number storing means, on the basis of selection made by the selecting means;

determination means for determining whether or not the number of entries stored in the entry number storing means reaches the number of players stored in the player number storing means; and

condition setting means for setting the condition to be cleared with respect to the player who performs the play, when the determination means determines that the number of entries reaches the number of players.

According to the invention described in (18), a player himself can select either to perform a play alone or with other player in order to achieve a condition to be cleared, which is set in a game. Thus, a player who is good at the above-described set condition to be cleared, or a player having a high game skill can select to perform a play alone, and at the same time a player who is not good at the above-described set condition to be cleared, or a player having a low game skill can select to perform the play with other player. Therefore, it is possible to prevent that the game is discontinued by the player who cannot clear the condition that he is not good at, or the player having a low game skill. Further, the player who challenges a condition that he is good at, or the player having a high game skill can select to perform the play alone, thus the player who is not good at the above-described set condition to be cleared, or the player having a low game skill does not depend on the player having a high game skill, thus the player having a high game skills does not have to feel troublesome. As a result, it is possible to develop attractiveness of online games, which is that the relationship among the players is prevented from being twisted due to the difference in the game skills among the players, and that a good relationship can be constructed among the players in which the players can communicate with one another by means of a game.

The present invention further provides the following. (19) A game control method, which causes a server, which is connected to a plurality of terminal devices via communication lines and which configures a game system in which a game can be executed by each of a plurality of players operating each of the terminal devices, to function as:

selecting means for a player to select either to perform a play alone or with other player in order to achieve a condition to be cleared, which is set in the game, in accordance with an input operation performed by the player;

player number setting means for setting the number of players who perform the play, on the basis of selection made by the selecting means;

player number storing means for storing the set number of players for each condition to be cleared;

entry number storing means for storing the number of entries of the players into the condition for each condition to be cleared;

entry number updating means for updating the number of entries of the players into the condition and storing the number of entries in the entry number storing means, on the basis of selection made by the selecting means;

determination means for determining whether or not the number of entries stored in the entry number storing means reaches the number of players stored in the player number storing means; and

condition setting means for setting the condition to be cleared with respect to the player who performs the play, when the determination means determines that the number of entries reaches the number of players.

According to the invention described in (19), a player himself can select either to perform a play alone or with other player in order to achieve a condition to be cleared, which is set in a game. Thus, a player who is good at the above-described set condition to be cleared, or a player having a high game skill can select to perform a play alone, and at the same time a player who is not good at the above-described set condition to be cleared, or a player having a low game skill can select to perform the play with other player. Therefore, it is possible to prevent that the game is discontinued by the player who cannot clear the condition that he is not good at, or the player having a low game skill. Further, the player who challenges a condition that he is good at, or the player having a high game skill can select to perform the play alone, thus the player who is not good at the above-described set condition to be cleared, or the player having a low game skill does not depend on the player having a high game skill, thus the player having a high game skills does not have to feel troublesome. As a result, it is possible to develop attractiveness of online games, which is that the relationship among the players is prevented from being twisted due to the difference in the game skills among the players, and that a good relationship can be constructed among the players in which the players can communicate with one another by means of a game.

### BRIEF DESCRIPTION OF THE DRAWINGS

FIG. 1 is a configuration diagram of the game system according to the present invention;

FIG. 2 is a perspective view showing the exteriors of eight terminal devices 1 installed in one arcade, and a card machine 6;

FIG. 3 is a perspective view showing the exterior of the terminal device 1;

FIG. 4 is a block diagram showing a hardware configuration of the terminal device 1;

FIG. 5 is a block diagram showing a hardware configuration of an arcade server 2;

FIG. 6 is a block diagram showing a hardware configuration of a center server 3;

FIG. 7 is a block diagram showing a hardware configuration of the card machine 6;

FIG. 8 is a figure showing a flow of a game played in the game system of the present embodiment;

FIG. 9 is a flow chart showing a flow of a processing of until an ID card is issued in the card machine 6, arcade server 2 and center server 3;

FIG. 10 is a figure showing information on participation of players;

FIGS. 11A to 11C are figures for explaining the detail of a data transmission processing performed by the arcade server 2;

FIG. 12 is a flow chart showing a flow of processings of until a game start in the terminal device 1, arcade server 2 and center server 3;

FIGS. 13A and 13B are figures showing an example of the historical data;

FIG. 14 is a figure showing an example of the player information;

FIG. 15 is a flow chart showing a routine of a game execution processing which is executed by the terminal device 1;

FIG. 16 is a flow chart showing a routine of a guild execution processing which is called up in the step S120 of the flow chart shown in FIG. 15 and is executed by the terminal device 1;

FIGS. 17A and 17B are figures schematically showing an image which is displayed on a first display 11 of the terminal device 1 when the sub routine shown in FIG. 16 is executed;

FIG. 18 is a flow chart showing a routine of a mission reference/acceptance processing which is called up in the step S131 of the flow chart shown in FIG. 16 and executed by the terminal device 1;

FIG. 19 is a flow chart showing a processing executed by the arcade server 2 in accordance with the sub routine shown in FIG. 18, which is executed by the terminal device 1;

FIG. 20 is a figure showing mission list data;

FIGS. 21A to 21D are figures schematically showing images displayed on the first display 11 of the terminal device 1 when the sub routine shown in FIG. 18 is executed;

FIG. 22 is a flow chart showing a notice board use processing which is called up in the step S133 of the flow chart shown in FIG. 16 and is executed by the terminal device 1, and a processing executed by the arcade server 2 in accordance with the abovementioned processing;

FIG. 23 is a figure showing an example of a message list;

FIGS. 24A to 24C are figures schematically showing images displayed on the first display 11 of the terminal device 1 when the processing shown in FIG. 22 is executed;

FIG. 25A is a flow chart showing a reward payment processing which is called up in the step S135 of the flow chart shown in FIG. 16 and is executed by the terminal device 1, and a processing executed by the arcade server 2 in accordance with the abovementioned processing corresponding to the embodiment of the first invention;

FIG. 25B is a flow chart showing a reward payment processing which is called up in the step S135 of the flow chart shown in FIG. 16 and is executed by the terminal device 1, and a processing executed by the store server 2 in accordance with the abovementioned processing corresponding to the embodiment of the second invention;

FIGS. 26A(a) and 26A(b) are figures showing examples of a reward determination table corresponding to the embodiment of the first invention;

FIG. 26B is a figure showing an example of a reward determination table corresponding to the embodiment of the second invention;

FIG. 27 is a flow chart showing a routine of a mission game execution processing which is called up in the step S121 of the flow chart shown in FIG. 15 and is executed by the terminal device 1;

FIG. 28 is a flow chart showing a processing executed by the arcade server 2 in accordance with the sub routine shown in FIG. 27, which is executed by the terminal device 1;

FIG. 29 is a figure showing an example of a chat message list;

FIGS. 30A to 30D are figures showing an example of images which are displayed on the first display 11 of the terminal device 1 by executing the processings shown in FIG. 27 and FIG. 28;

FIG. 31 is a flow chart showing a biographical data generation processing which is executed by the center server 3;

FIG. 32 is a figure showing an example of a historical data evaluation table;

FIG. 33 is a figure showing an example of an evaluation message creation table;

FIG. 34A is a flow chart showing a processing which is executed by the card machine 6 and center server 3 when displaying a biographical image corresponding to the embodiment of the first invention;

FIG. 34B is a flow chart showing a processing which is executed by the card machine 6 and center server 3 when displaying a biographical image corresponding to the embodiment of the second invention;

FIGS. 35A and 35B are figures showing an example of biographical images displayed on a display 61 of the card machine 6 when the processing shown in FIGS. 34A and 34B is executed; and

FIG. 36 is a configuration diagram showing another example of the game system according to the present invention.

### DESCRIPTION OF THE PREFERRED EMBODIMENTS

Embodiments related to the above-described first invention and second invention are described hereinafter. First, the description is provided with a focus on the embodiment related to the first invention in order to avoid a redundant description of the same parts, and then the embodiment of the second invention is mentioned regarding only the parts that are different from those of the first invention.

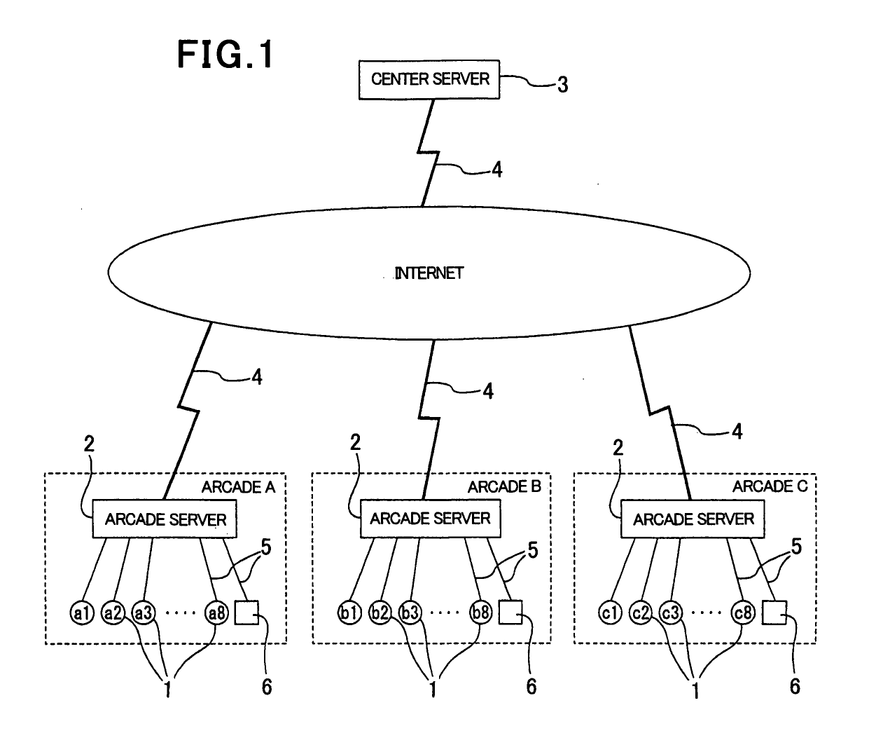

FIG. 1 is a configuration diagram of the game system according to the present invention. The game system comprises a plurality of terminal devices 1, an arcade server 2 connected communicably to the plurality of (eight devices here) terminal devices 1 by means of dedicated lines 5, a center server 3 which is connected communicably to a plurality of arcade servers 2 by means of a communication lines 4, and which manages a game played by a plurality of players using the terminal devices 1, and a card machine 6 connected to the arcade server 2 via the dedicated line 5 for each arcade 1. It should be noted that the arcade servers 2 can communicate with each other via the communication lines 4.

The terminal device 1 accepts a predetermined operation performed by a player using a touch panel 14 (not shown), and conducts a game on the basis of data transmitted from the arcade server 2 (or center server 3), data from another terminal device 1, or other data.

It should be noted that a unique machine ID is related to each machine of the terminal devices 1. The machine ID includes a code for each arcade server 2 connected to the terminal device 1, and a code for each terminal device 1 in the arcade in which the terminal devices 1 are disposed. For example, if the code of an arcade server A of an arcade A is A, and the code of the terminal device 1 in the arcade A is 1, the machine ID of the terminal device 1 is a1.

The arcade servers 2 are connected communicably to the plurality of terminal devices 1 (eight devices in this case) respectively and to the center server 3, and perform data transmission between the terminal devices 1 and the center server 3. The center server 3 is connected communicably to the plurality of arcade servers 2 and has historical data related to each player. The center server 3 performs data transmission with the terminal devices 1 via the arcade servers 2, and thereby performs authentication and the like of each player. The arcade server 2 is equivalent to the server in the present invention.

The card machine 6 can communicate with the center server 3 via the arcade server 2. The card machine 6 accepts an operation of the personal data input performed by a player, and issues an ID card 8 (not shown). The player is registered in the center server 3 by the personal data inputted at this time, and ID data which can identify the player is granted to each player by the center server 3. This ID data is granted beforehand to the ID card 8 to be issued. Further, a password, which is inputted by the player when the ID data is granted, is stored in a RAM 303, and used for authenticating the player when a game is started.

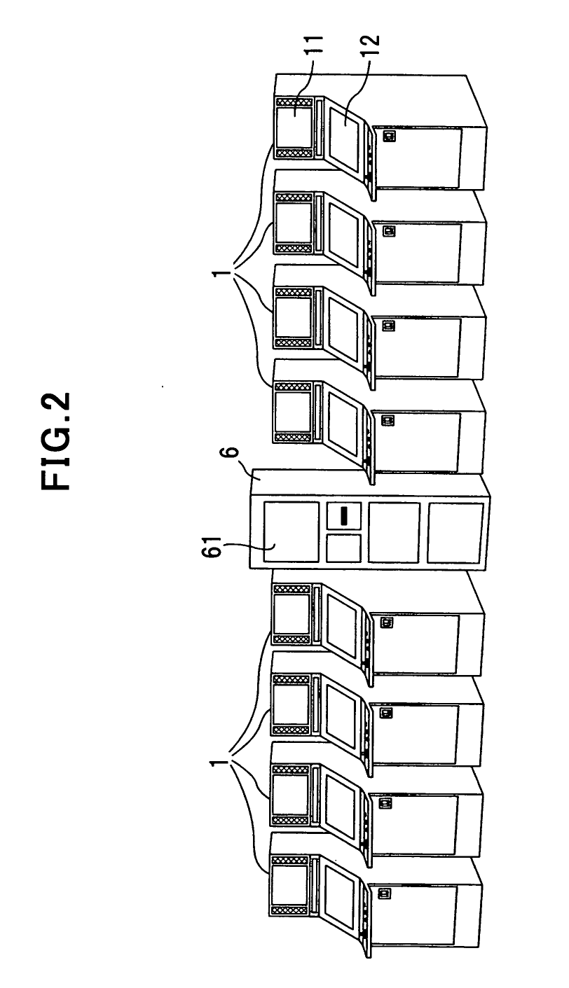

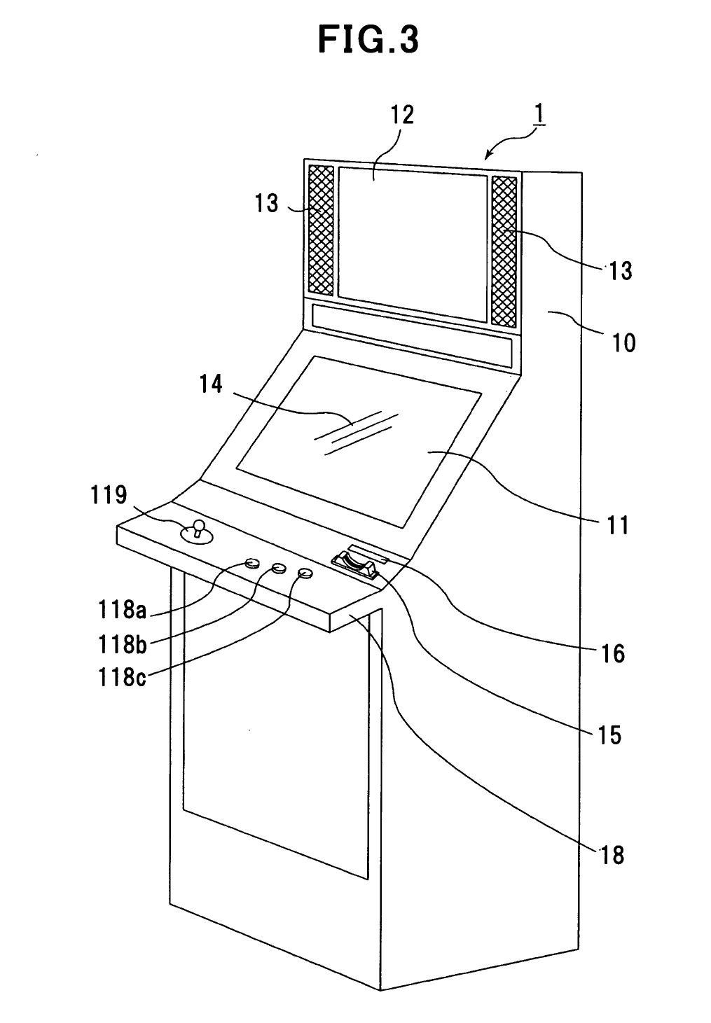

FIG. 2 is a perspective view showing the exteriors of eight terminal devices installed in one arcade, and the card machine. FIG. 3 is a perspective view showing the exterior of the terminal device. It should be noted that a game-arcade gaming device comprising two displays (a first display 11 and a second display 12) is explained, as an example of the terminal device hereinbelow. However, the present invention is not particularly limited to this example, thus a home vide-game device configured by connecting the home vide-game device to a home television, a personal computer which functions as a vide-game device by executing a vide game program, and the like can be applied similarly.

Furthermore, in the present embodiment, a game performed using the terminal device 1 is a MMORPG (Massively Multiplayer Online Role Playing Game) in which the elements of an action game are applied. A player who operates each terminal device 1 uses various buttons 118 and an operation lever 119 to operate a character corresponding to the player, and plays a game. Each character belongs to a venturer guild in the game (a trading association configured by a venturer), and accepts a mission (a condition in the game, which is set for the player) from the guild. After accepting the mission from the guild, a mission game is played in which the character ventures a virtual game space. In the mission game the character can be reinforced by causing the character to battle against a monster and increasing the level (level value), whereby an item can be acquired. A character corresponding to each of a plurality of players plays a game in the same virtual game space. Therefore, sometimes the character can challenge the mission along with a character corresponding to other player, or the character can exchange the information with the character of the other player. Once returning to the guild after clearing the above mission in the virtual game space, a reward corresponding to the type of mission can be acquired from the guild, and a new mission can be accepted.

As shown in FIG. 3, the terminal device 1 comprises a housing 10, a first display 11 provided on the front face of the housing 10, the first display 11 being inclined at a predetermined angle, and a second display 12 provided on the upper side of the first display 11. A game image showing a virtual game space where characters are disposed, an image showing a guild, and other images are displayed on the first display 11. Various images such as an image indicating a map of the virtual game space (overall view), a commercial image for a game, and other images are displayed on the second display 12.

The touch panel 14 is installed in front of the first display 11. The touch panel 14 can detect a contact by a player, and outputs a detection signal, which indicates a contact position when the contact is detected, to an operation input portion 114 (not shown) which is described hereinafter. The player can touch the touch panel 14 to input various instructions. The speakers 13 which output sound are provided at the sides of the second display 12.

The lower side of the first display 11 is provided with a coin insertion slot 15 into which a coin is inserted, and an ID card insertion slot 16 into which an ID card is inserted. A coin which is inserted into the coin insertion slot 15 is detected by a coin sensor 115 (not shown). Further, the ID data of an ID card inserted into the ID insertion slot 16 is read out by an ID card reader 116 (not shown).

The housing 10 is provided with an operation board 18 protruding forward. The front face of the operation board 18 is provided with an attack button 118a, a defense button 118b, a magic button 118c, and an operation lever 119. The attack button 118a is used to input an instruction for causing a character to perform an offensive move. The defense button 118b is used to input an instruction for causing the character to perform a defensive move. The magic button 118c is used to input an instruction for causing the character to perform an action to use magic. The operation lever 119 is used to input an instruction for moving the character.

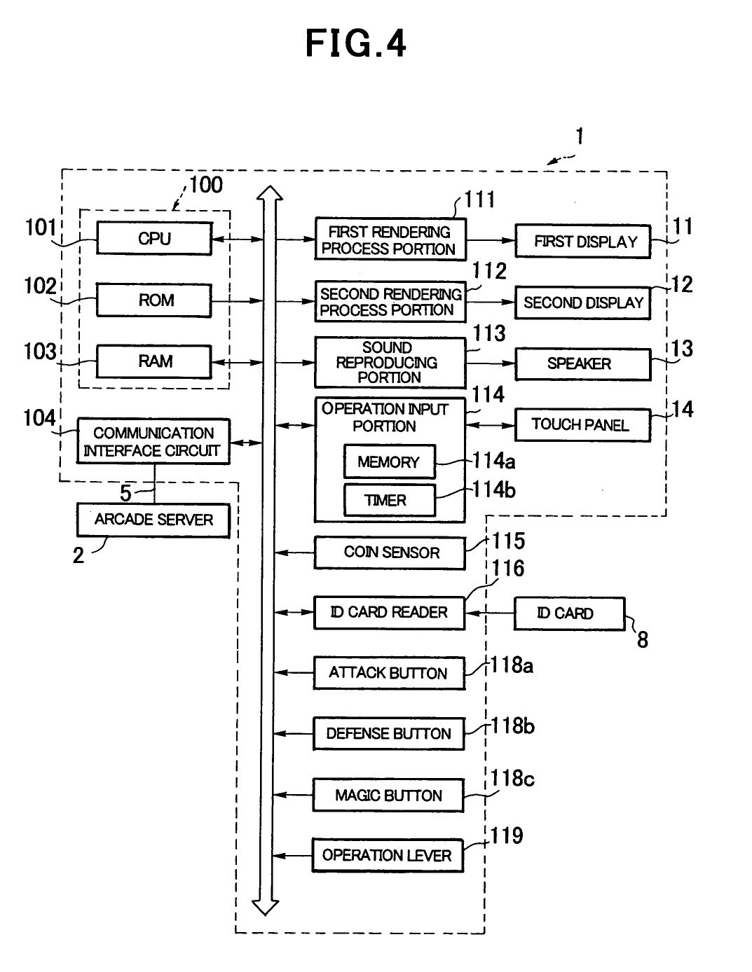

FIG. 4 is a block diagram showing a hardware configuration of the terminal device. A control portion 100 is to control the overall operation of the terminal device 1, and comprises a CPU 101, ROM 102, and RAM 103.

The ROM 102 stores various image data, programs, and the like. Specifically, the ROM 102 stores image data which indicates, for example, images displayed on the first display 11 and/or second display 12, such as various character images showing a character which can be operated by a player, a character operated by other player, and other characters, a monster image showing a monster which appears in a virtual game space, various background images for showing the virtual game space, an image showing a guild, and the like. Also the ROM 102 stores, for example, an object, texture data, background image, and the like that configure the character or monster. The object and the like that configure the character or monster are configured by a predetermined number of polygons such that they can be rendered three dimensionally. Moreover, the ROM 102 has stored therein a level (level value) of the player or of the character corresponding to the player, and a capability value setting table (not shown) where the character level (level value) and the capability value thereof are related to each other.

The ROM 102 may be a storage medium embedded in the terminal device 1, or may be an attachable/detachable storage medium. Further, the both may configure the ROM 102. In addition, among the various data stored in the ROM 102, data which can be stored in the attachable/detachable recording medium may be read out by, for example, a hard disk drive, optical disk drive, flexible disk drive, silicon disk drive, a driver such as a cassette medium reader, or the like. In this case, the recording medium is, for example, a hard disk, optical disk, flexible disk, CD, DVD, semiconductor memory, and the like.

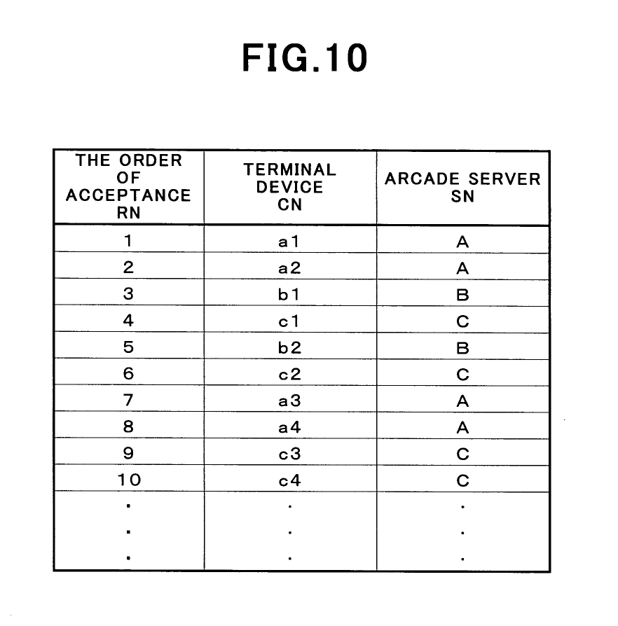

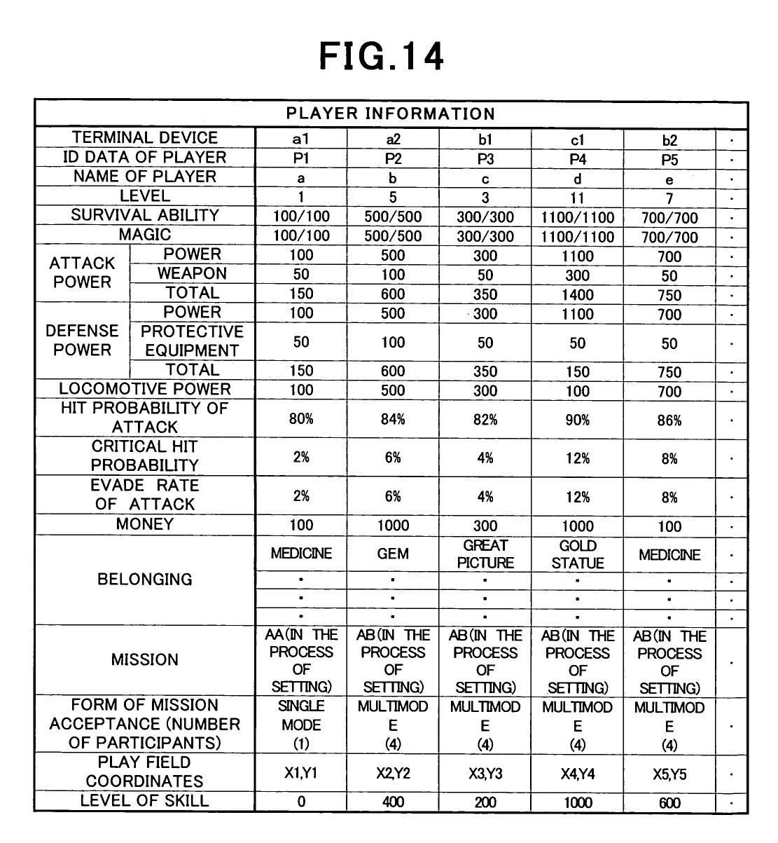

The RAM 103 stores information in processing, variables, and the like temporarily. For example, player participation information (see FIG. 10), player information (see FIG. 14) such as player information which contains, for example, data related to the level value of the player, and the like are stored. When storing the player information (see FIG. 14) which contains data related to the level value of the player, the RAM 103 functions as level storing means for storing the level value of the player. The CPU 101 selects either a single mode in which a single player participates in a single mission (condition) in a game, or a multimode in which a player participates in the mission with other player, according to an input operation performed by the player using the touch panel 14, and stores a result of the selection in the player information. It should be noted that the CPU 101 of the terminal device 1 in the present embodiment functions as the selecting means in the present invention (second invention).

A communication interface circuit 104 is used to perform data transmission (for example, the player participation information, player information, etc) with the arcade server 2 by means of the dedicated line 5. The communication interface circuit 104 transmits an instruction inputted by a player by means of the touch panel 14, the various buttons 118 or the operation lever 119 to the arcade server 2 via the dedicated line 5, and the arcade server 2 proceeds with the game based on the instruction. Also the communication interface circuit 104 receives a display command for the first display 11 and second display 12 from the arcade server 2 via the dedicated line 5. Various images are displayed each on the first display 11 and the second display 12 on the basis of the display command.

A first rendering process portion 111 displays a game image in which a character is disposed in the virtual game space, an image showing a guild, and the like on the first display 11, and comprises a VDP (Video Data Processor), a video RAM, and the like. The first rendering process portion 111 refers to the player information (see FIG. 14) stored in the RAM 103, and extracts the image data from the ROM 102, according to the above display command. The first rendering process portion 111 then stores the image data in the video RAM in accordance with priorities displayed on the first display 11 (for example, in the order of the background image, monster image, and character image), generates a game image, and outputs it to the first display 11. As a result, the game image is displayed on the first display 11. Further, when displaying the game image three dimensionally, the first rendering process portion 111 performs calculation for converting the object (for example, an object configuring a character or monster, and the like) stored in the ROM 102 from a position on the three dimensional space to a position on a pseudo three dimensional space, light source calculation processing, and the like, as well as a write processing of the image data (for example, mapping of the texture data for the region of the video RAM specified with a polygon) to be rendered to the video RAM on the basis of the results of the above calculations, thereby generating the game image, and outputs it to the first display 11. As a result, the three-dimensional game image is displayed on the first display 11.

A second rendering process portion 112 causes the second display 12 to display an image indicating a map of the virtual game space, a commercial image for a game, or other image, and comprises a VDP (Video Data Processor), a video RAM, and the like. The second rendering process portion 12 extracts a predetermined image from the ROM 102 according to the abovementioned display command. The second rendering process portion 112 then stores the image data in the video RAM in accordance with priorities displayed on the second display 12, thereby generating a predetermined image, and outputs it to the second display 12. As a result, the predetermined image is displayed on the second display 12.

A sound reproducing portion 113 outputs a predetermined sound, BGM and the like to the speakers 13 in accordance with an instruction from the arcade server 2. The touch panel 14 is a rectangular thin layer body provided in front of the first display 11, and is constituted such that a transparent pressure sensitive material in the form of a line, which is disposed at a predetermined pitch vertically and horizontally, is covered with a transparent cover. A conventionally known touch panel can be employed as the touch panel 14. The touch panel 14 outputs to the operation input portion 114 a detection signal indicating the contact position when being contacted.

The operation input portion 114 is a microcomputer comprising a memory 114a and a timer 114b, buffers the contact position, which is indicated by the detection signal outputted from the touch panel 14, as data to a predetermined region of the memory 114a, uses the timer 114b and the like to determine the detail of the instruction on the basis of the data sequentially, and supplies a result of determination as an operation command to the control portion 100.

The coin sensor 115 transmits a predetermined signal to the control portion 100 when a coin inserted into the coin insertion slot 15 is detected. The ID card reader 116 reads out the ID data from the ID card 8 which is inserted into the ID card insertion slot 16, and supplies it to the control portion 100. The attack button 118a is a button for causing a character to perform an offensive move, the defense button 118b is for causing the character to perform a defensive move, and the magic button 118c is for causing the character to perform an action to use magic. The various buttons 118 (118a to 118c) transmit the detection signal to the control portion 100 when detecting an operation by the player. The operation lever 119 transmits to the controller portion 100 a detection signal corresponding to a predetermined direction to which the player tilts the operation lever 119.

The present embodiment explains the case in which the terminal device 1 comprises the touch panel 14, various buttons 118, and operation lever 119 as the means for the player to input an instruction (input means). However, the terminal device 1 related to the present embodiment may comprise the touch panel 14 only, for example, or may comprise various buttons 118 and operation lever 119 only. Further, the input means that the terminal device 1 related to the present embodiment comprises is not limited to the above example, and, for example, the conventionally known input means such as a keyboard, mouse, pointing device and the like can be employed.

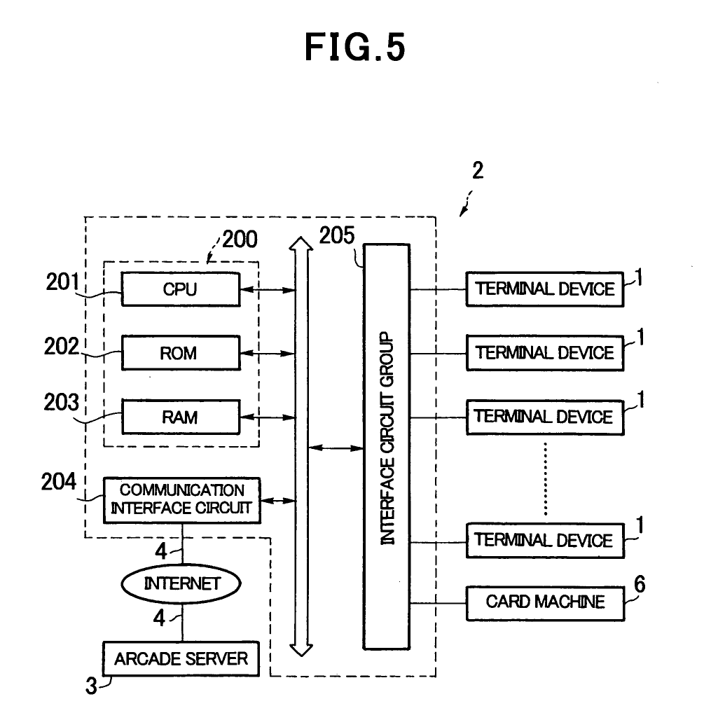

FIG. 5 is a block diagram showing a hardware configuration of an arcade server. The arcade server 2 comprises a control portion 200 which controls the overall operation of the arcade server 2. The control portion 200 comprises a CPU 201, ROM 202, and RAM 203.

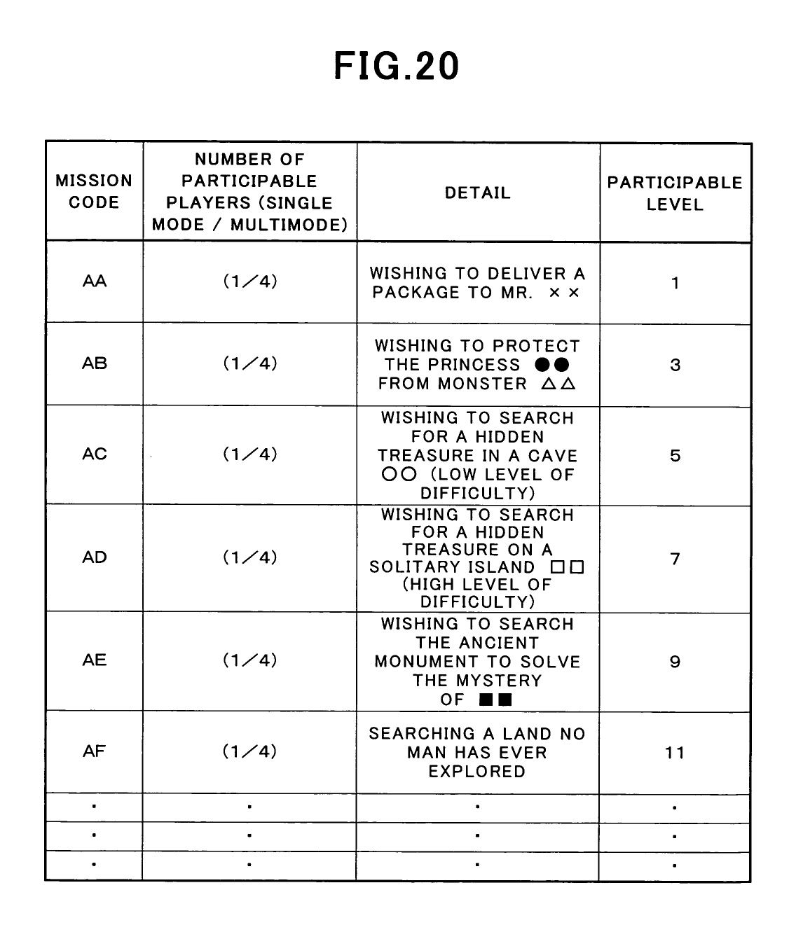

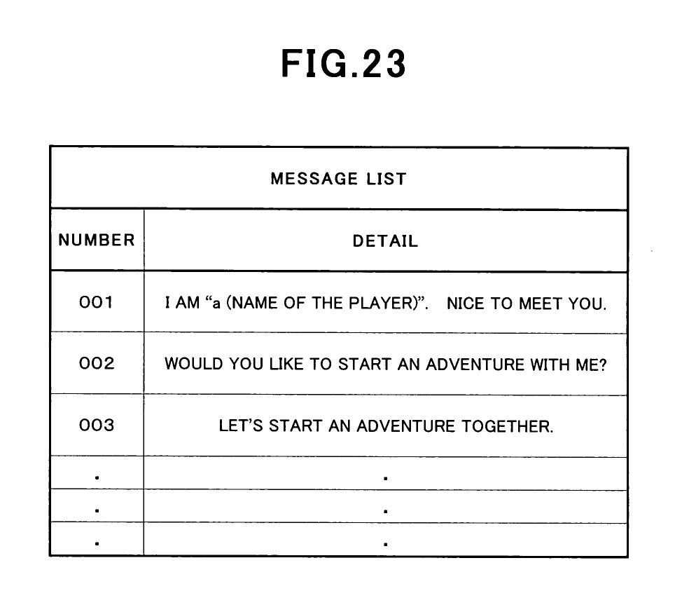

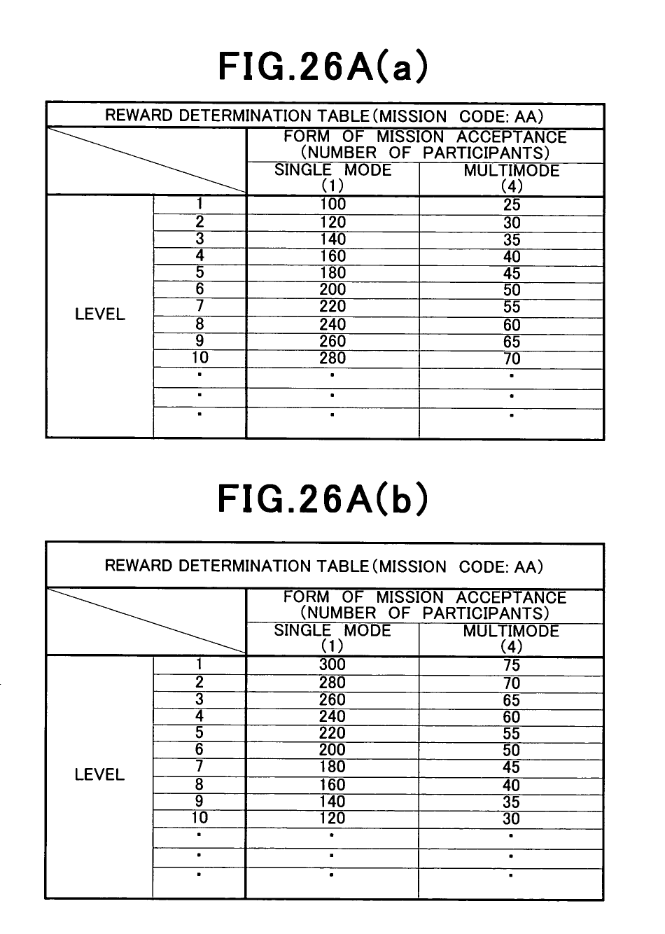

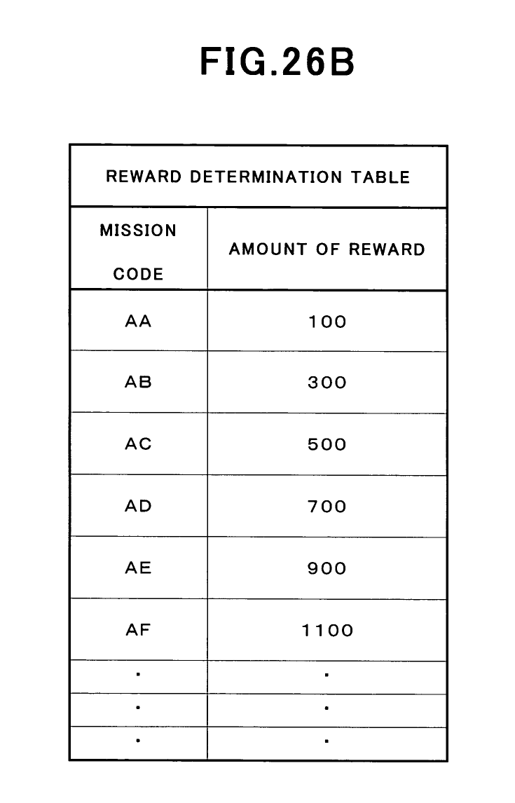

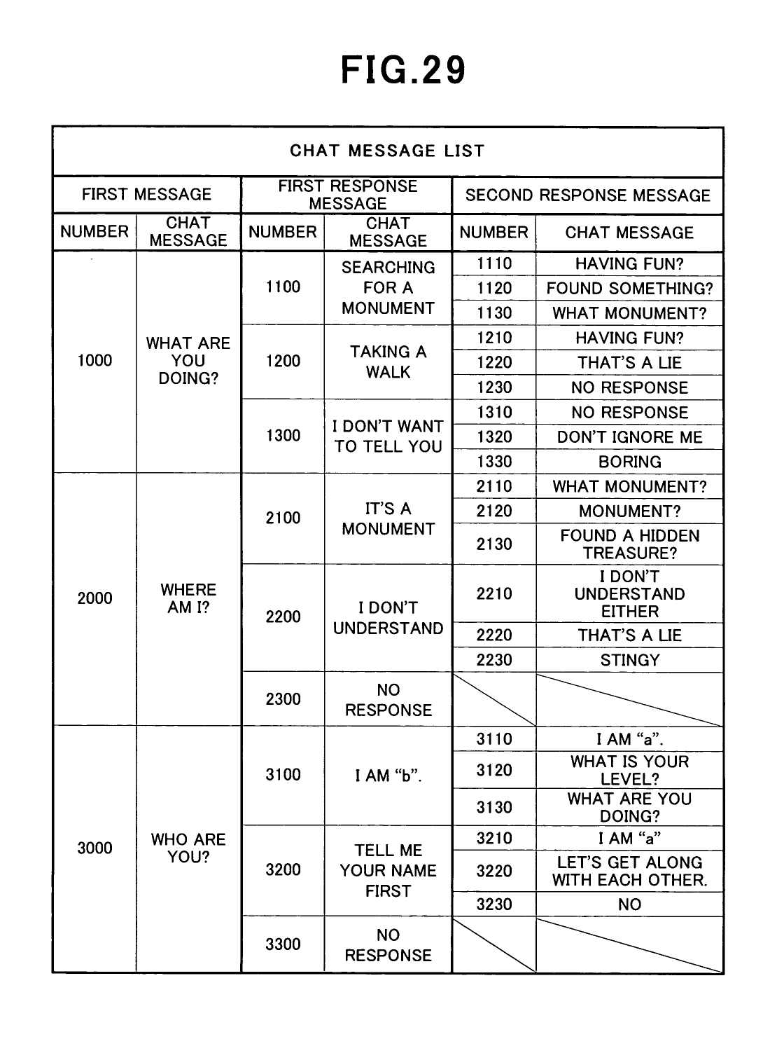

The ROM 202 stores a game control program. The CPU 201 of the arcade server 2 executes the game control program stored in the ROM 202, and performs various types of processing for proceeding with the game. Further, the ROM 202 stores various data, table data and the like used in the processing of a game, such as mission list data (see FIG. 20) showing a list of the missions set to a player in the game system of the present embodiment, mission reference data showing a detailed content and the like of each mission, a message list (see FIG. 23) in which is stored a message which can be inputted by the player in a guild notice board, a reward determination table (see FIG. 26) for determining the amount of a reward for clearing the mission, a chat message list (FIG. 29) used when exchanging the message (so called “chatting”)with other player in a mission game, and the like.

The ROM 202 may be a storage medium embedded in the arcade server 2, or may be an attachable/detachable storage medium. Further, the both may configure the ROM 202. In addition, among the various data stored in the ROM 202, data which can be stored in the attachable/detachable recording medium may be read out by, for example, a hard disk drive, optical disk drive, flexible disk drive, silicon disk drive, a driver such as a cassette medium reader, or the like. In this case, the recording medium is, for example, a hard disk, optical disk, flexible disk, CD, DVD, semiconductor memory, and the like.

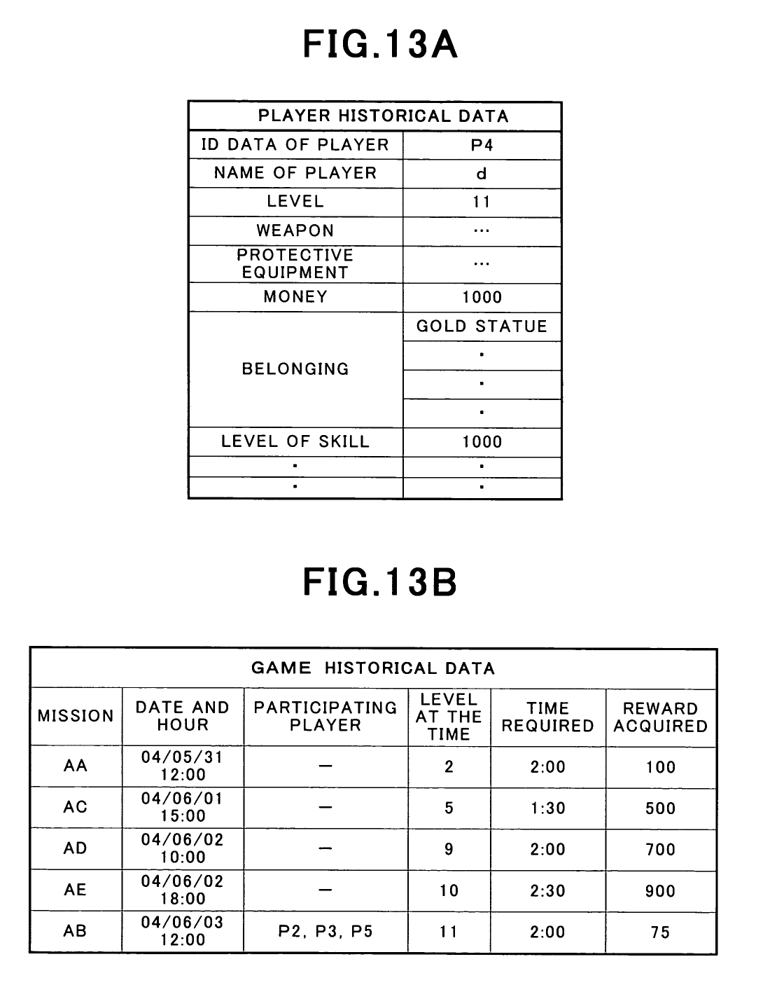

The RAM 203 temporarily stores information in processing, variables, and the like. For example, player participation information (see FIG. 10), player information (see FIG. 14) such as player information which contains, for example, data related to the level value of the player, and the like are stored. Further, when the historical data of the player (see FIGS. 13A and 13B) is supplied from the center server 3, the RAM 203 stores this historical data. The RAM 203 functions as the level storing means for storing the level value of the player.

Moreover, in the embodiment related to the second invention, the RAM 203 functions as the player number storing means for storing, for each mission, the number of players who perform a play in the mission. In this case, the RAM 203 also functions as the entry number storing means for storing, for each condition to be cleared, the number of entries of the players into the condition.

Furthermore, the CPU 201 functions as the player number setting means for setting the number of players who perform a play in the mission, on the basis of a selection made by the CPU 101 of the terminal device 1, which functions as the selecting means. The CPU 201 also functions as the entry number updating means for updating the number of entries stored in the RAM 203 functioning as the entry number storing means, on the basis of the selection made by the CPU 101 of the terminal device 1, which functions as the selecting means.

A communication interface circuit 204 is used for transmission of various data with the center server 3 and other arcade server 2 by means of a network such as the Internet or the like. Further, the arcade server 2 comprises an interface circuit group 205, and is connected to a plurality of terminal devices 1 (eight devices here) and a single card machine 6 from the interface circuit group 205 via the dedicated lines 5.

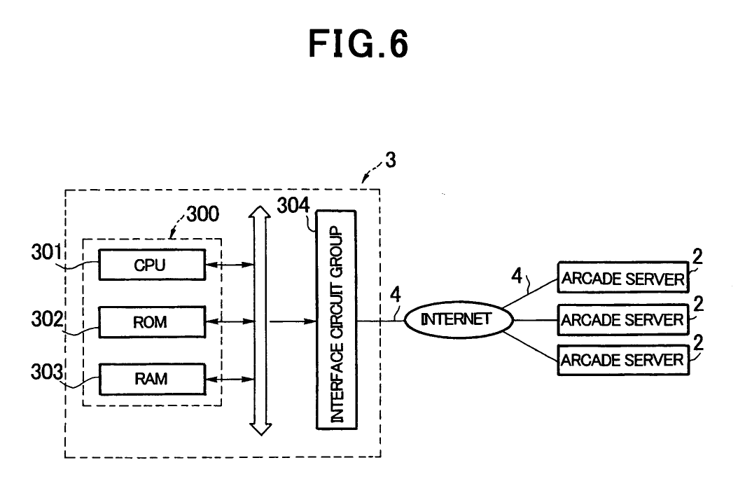

FIG. 6 is a block diagram showing a hardware configuration of the center server. The center server 3 comprises a control portion 300 which controls the overall operation of the center server 3. The control portion 300 comprises a CPU 301, ROM 302 and RAM 303.

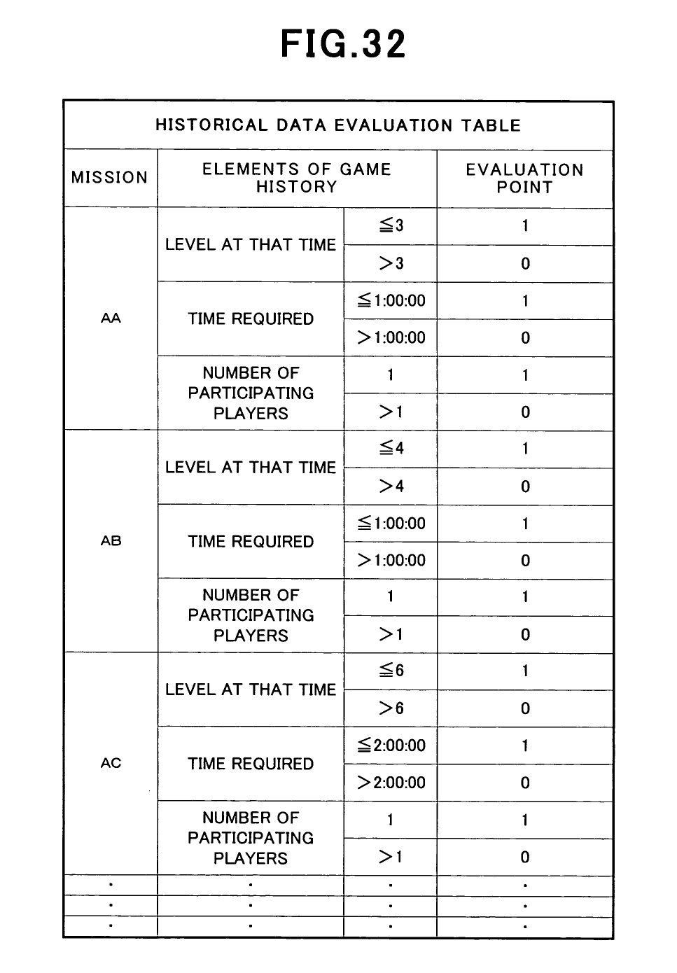

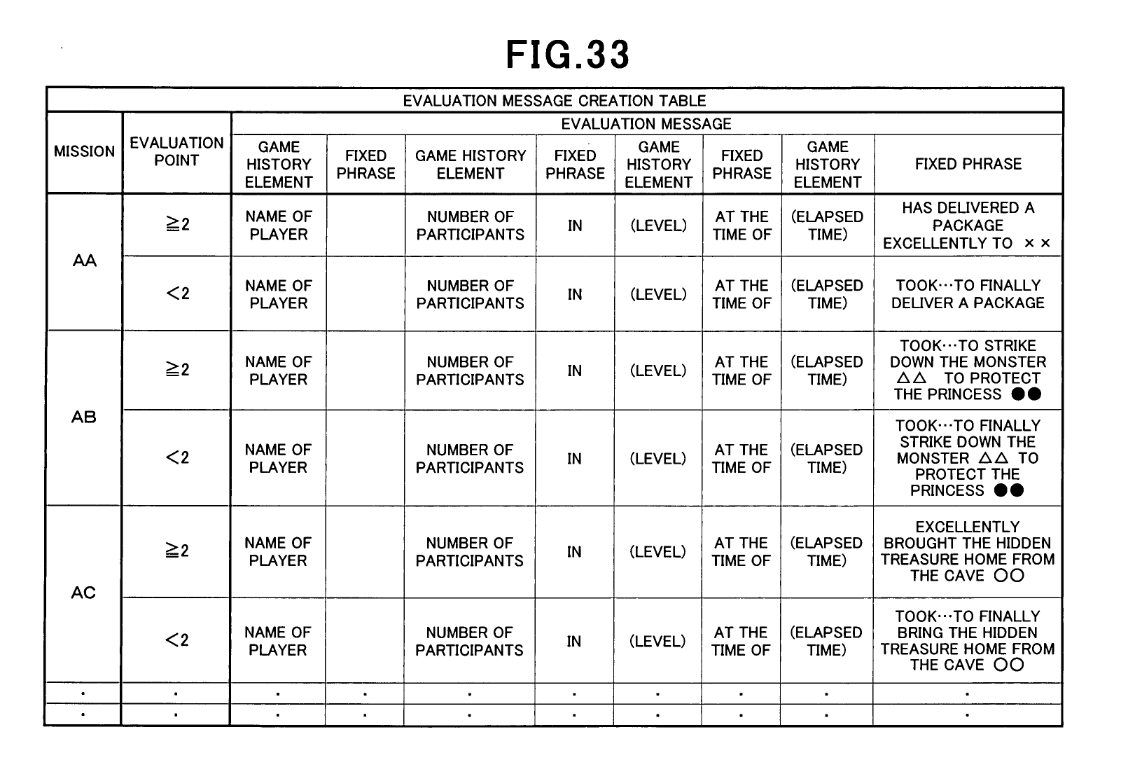

The ROM 302 stores a historical data evaluation table (see FIG. 32) for evaluating the game histories, and an evaluation message creation table (see FIG. 33) for creating an evaluation message. The ROM 302 may be a storage medium embedded in the center server 3, or may be an attachable/detachable storage medium. Further, the both may configure the ROM 302. In addition, among the various data stored in the ROM 302, data which can be stored in the attachable/detachable recording medium may be read out by, for example, a hard disk drive, optical disk drive, flexible disk drive, silicon disk drive, a driver such as a cassette medium reader, or the like. In this case, the recording medium is, for example, a hard disk, optical disk, flexible disk, CD, DVD, semiconductor memory, and the like.

The RAM 303 stores, for example, ID data, historical data (see FIGS. 13A and 13B), a password and the like of the player. The RAM 303 functions as the game history storing means which can store a plurality of game histories of the player, which comprise a plurality of types of elements. The communication interface circuit 304 is used for transmission of various data with the plurality of arcade servers 2 by means of a network such as the Internet or the like.

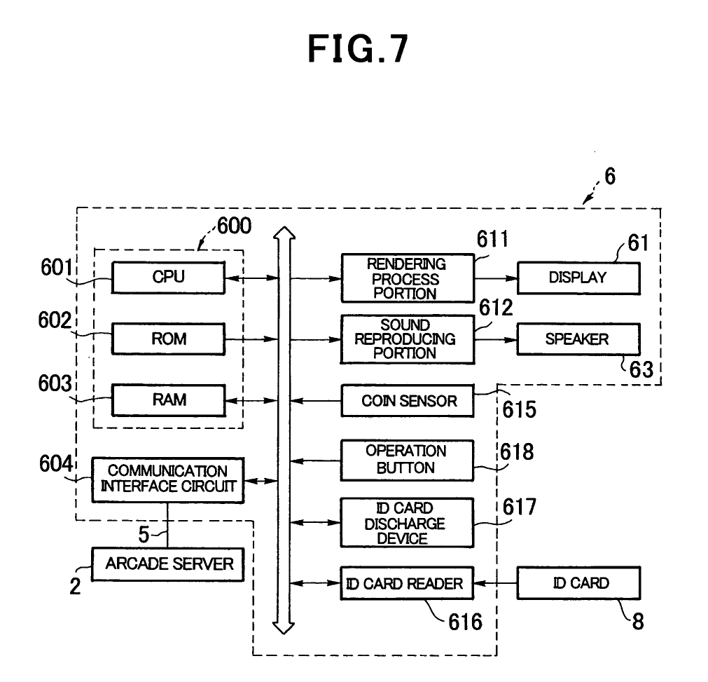

FIG. 7 is a block diagram showing a hardware configuration of the card machine. A control portion 600 is to control the overall operation of the card machine 6, and comprises a CPU 601, ROM 602, and RAM 603.

The ROM 602 stores various image data, programs, and the like such as, for example, image data which configures a biographical image, image data which configures an image representing an instruction for purchasing the ID card, and other image data.

The ROM 602 may be a storage medium embedded in the card machine 6, or may be an attachable/detachable storage medium. Further, the both may configure the ROM 602. In addition, among the various data stored in the ROM 602, data which can be stored in the attachable/detachable recording medium may be read out by, for example, a hard disk drive, optical disk drive, flexible disk drive, silicon disk drive, a driver such as a cassette medium reader, or the like. In this case, the recording medium is, for example, a hard disk, optical disk, flexible disk, CD, DVD, semiconductor memory, and the like.

The RAM 603 temporarily stores information in processing, variables, and the like. For example, the RAM 603 stores the historical data (see FIGS. 13A and 13B), evaluation message, biographical data, and the like. The CPU 601 uses an instruction inputted through an operation button 618, or ID data which is read from an ID card reader 616, which is described hereinafter, to transmit to the center server 3 a request signal for requesting the biographical data corresponding to the ID data. The biographical data received from the center server 3 is stored in the RAM 603. Moreover, in the embodiment related to the second invention, the CPU 601 uses an instruction inputted through an operation button 618, or ID data which is read from an ID card reader 616, which is described hereinafter, to generate a plurality of evaluation messages based on the historical data stored in the ROM 602, edit the plurality of evaluation messages in accordance with the time axis in the game, and generates biographical data indicating the game process of the player in the RAM 603. A communication interface circuit 604 is used for transmission of the data (for example, the historical data, and the like) with the arcade servers 2 by means of the dedicated lines 5. The rendering process portion 611 displays a biographical image and the like on the display 61, and comprises a VDP (Video Data Processor), a video RAM, and the like. A rendering process portion 611 uses the biographical data stored in the RAM 603 to extract various image data configuring a biographical image from the ROM 602, and to store the image data in the video RAM in accordance with priorities displayed on the display 61, thereby generating a biographical image, and outputting it to the display 61. As a result, the biographical image is displayed on the display 61.

A sound reproducing portion 613 outputs a predetermined sound, BGM and the like to speakers 63. A coin sensor 615 generates a predetermined signal to the control portion 600 when detecting a coin is inserted into the card machine 6. The operation button 618 comprises a plurality of buttons and is used to input various instructions to the card machine 6. The operation button 618 transmits a detection signal to the control portion 600 when detecting an operation by a player. An ID card discharge device 617 is used to discharge one ID card out of a plurality of ID cards stored in a predetermined place inside the card machine 6, when a predetermined amount of coins and the personal data are inputted into the card machine 6. The ID card reader 616 is used to read out the ID card from the ID card 8 which is inserted into the card machine 6.

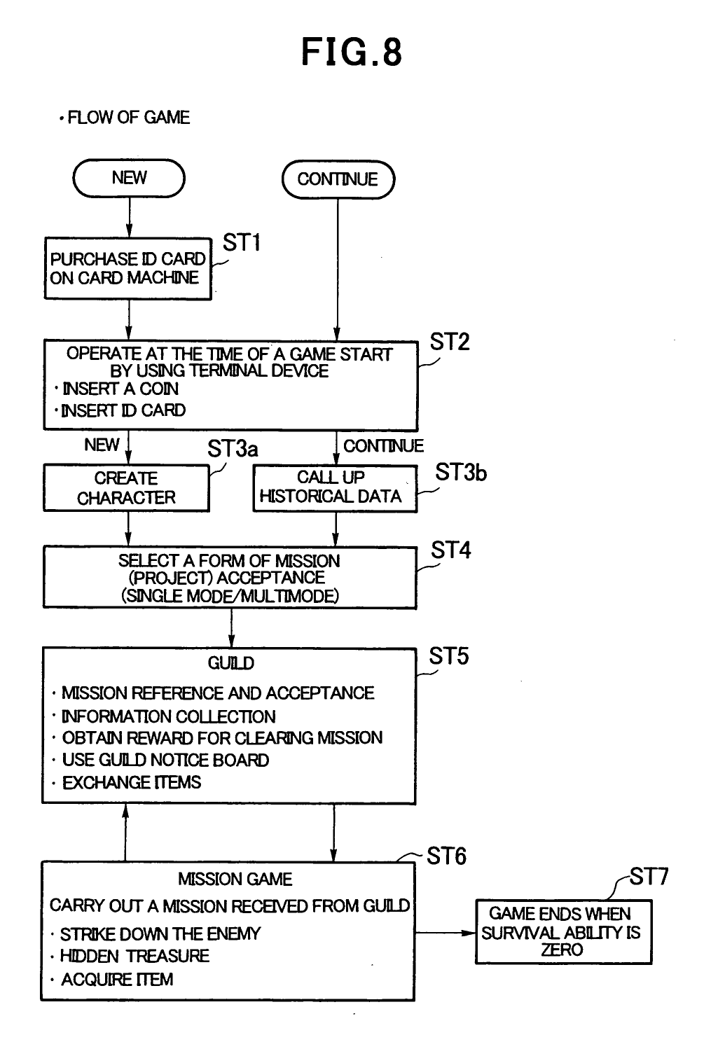

Next, a flow of a game played in the game system of the above-described embodiment is described. FIG. 8 is a figure showing a flow of a game played in the game system of the present embodiment. First of all, a player who tries to play a new game purchases the ID card 8 on the card machine 6 (ST 1). Specifically, the player inserts a predetermined amount of coins into the card machine 6, and inputs the personal data of the player using the operation button 618 (for example, a name or appellation, the date of birth, blood type, constellation, and the like), whereby the ID card 8 is discharged from the ID card discharge device 617. A player who ongoingly plays a game does not have to perform the procedure of ST 1, since he already has the ID card 8.

Next, the player who tries to play a new game or the player who ongoingly plays a game performs an operation at the time of a game start by means of the terminal device 1 (ST 2). The operation at the time of a game start includes, for example, inserting a coin into the coin insertion slot 15, insertion of the ID card 8 into the ID card insertion slot 16, and the like.

When playing a new game after performing the procedure of ST 2, a character is created (ST 3a). Specifically, the player inputs an instruction using the touch panel 14, thereby creating a character according to the preference of the player by selecting an appearance, capability, characteristics and the like of a character corresponding to the player (a character operated by the player). On the other hand, when ongoingly playing a game, since the historical data indicating the game result (see FIG. 13) is stored in the RAM 303 of the center server 3, the historical data is called up from the center server 3 to set the appearance, capability, characteristics and the like of the character at the time of the end of the game (ST 3b).

After finishing the procedure of ST 3 (ST 3a or ST 3b), a form of mission acceptance is selected next (ST 4). A mission is, as described above, accepted from the guild. Either a single mode in which a single player accepts a mission, or a multimode in which a player accepts the mission with other player can be selected. The more the number of players who clear the mission, the less the reward obtained when the mission is cleared. In addition, in the embodiment related to the second invention, a reward obtained when a mission is cleared is distributed proportionally in accordance with the number of the players who cleared the mission. Therefore, when the single mode is selected, since a single player has to clear a mission, the player can acquire lots of rewards, although the degree of difficulty of the mission is raised. On the other hand, when the multimode is selected, a player can only clear a mission with other player, only a small amount of reward is acquired, although the degree of difficulty of the mission is lowered.

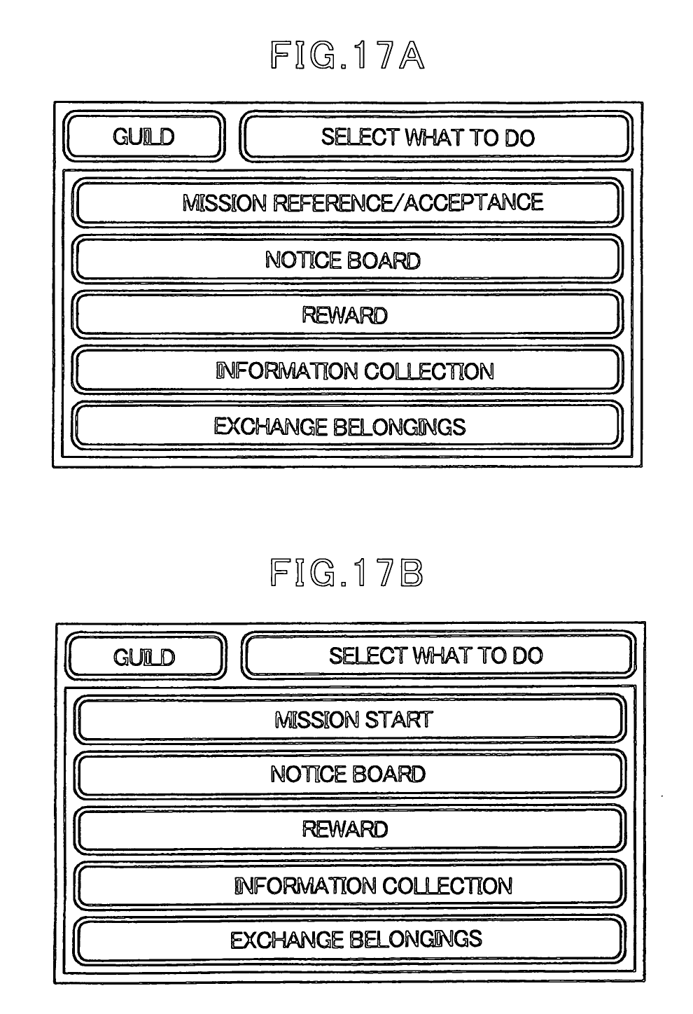

After the procedure of ST 4 is finished, a game is started, and the character corresponding to the player appears in the guild, and can take various actions in the guild (ST 5). In the guild the player can perform, for example, the followings (i) to (v) (see FIGS. 17A and 17B).

(i) Refer to or Accept a Mission (Only Before Mission Acceptance).

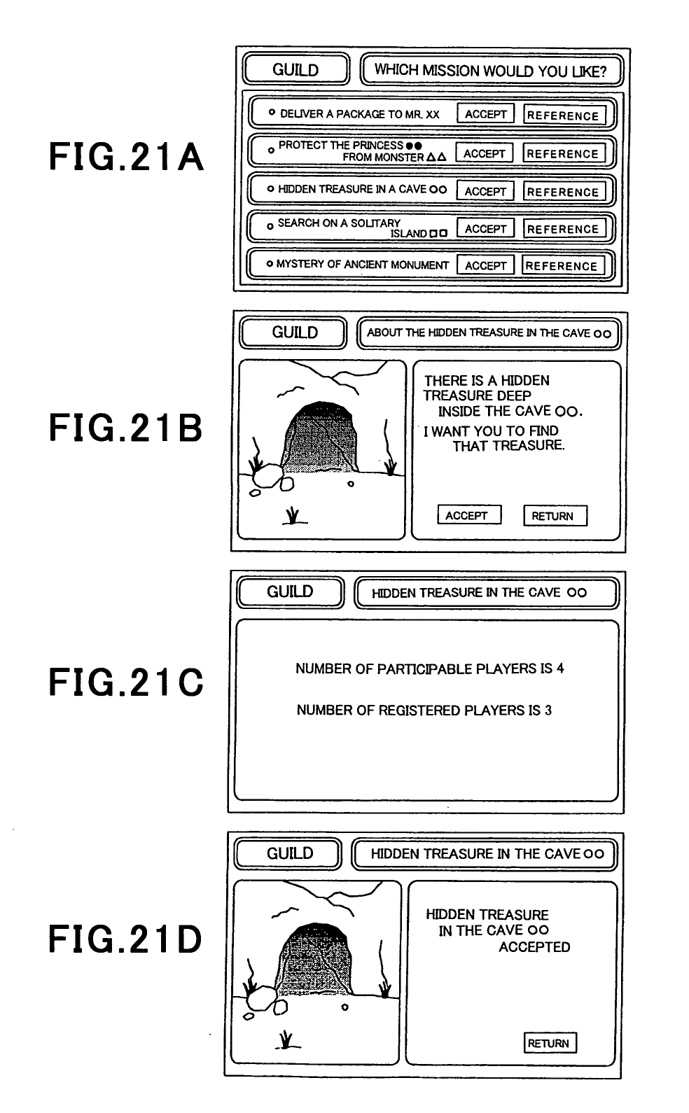

In the present embodiment, for example, there are a plurality of types of missions such as a serious mission and a comical mission (see FIG. 20, FIG. 21A). By selecting a mission that the player is interested in from these missions, the detail of the mission can be referred to (see FIG. 21B). Once the player refers to the mission, understands the detail thereof, and selects to participate therein, the player accepts the mission (see FIG. 21C)

(ii) Collect Information on Other Character or Mission.

Information on other character or mission can be obtained in a guild. Particularly, tips for attacking the mission, information on a monster which appears in the virtual game space, and information on an item or the like which can be acquired can be obtained by paying a predetermined amount of money which can be used on the game. For information on other character, it is possible to obtain information on that what kind of character exists in the virtual game space and what kind of adventure the character is involved in. It should be noted that the information which can be obtained in the procedure of (ii) is information which is set beforehand in a program, and not information which can be obtained from other player.

(iii) Obtain a Reward for Clearing the Mission (Only When Clearing a Mission).

Here, an experience value corresponding to the level value of a player who clears a mission (a character corresponding to the player), or money which can be used on a game is paid from the guild. However, when a mission is cleared in the multimode, the more the number of players who clear the mission, the less the reward. Further, in the embodiment related to the second invention, when the experience value corresponding to the level of a player who clears a mission (a character corresponding to the player), or the money which can be used on a game is paid from the guild, and when a mission is cleared in the multimode, the reward is divided by the number of players who clear the mission.

(iv) Use the Notice Board.

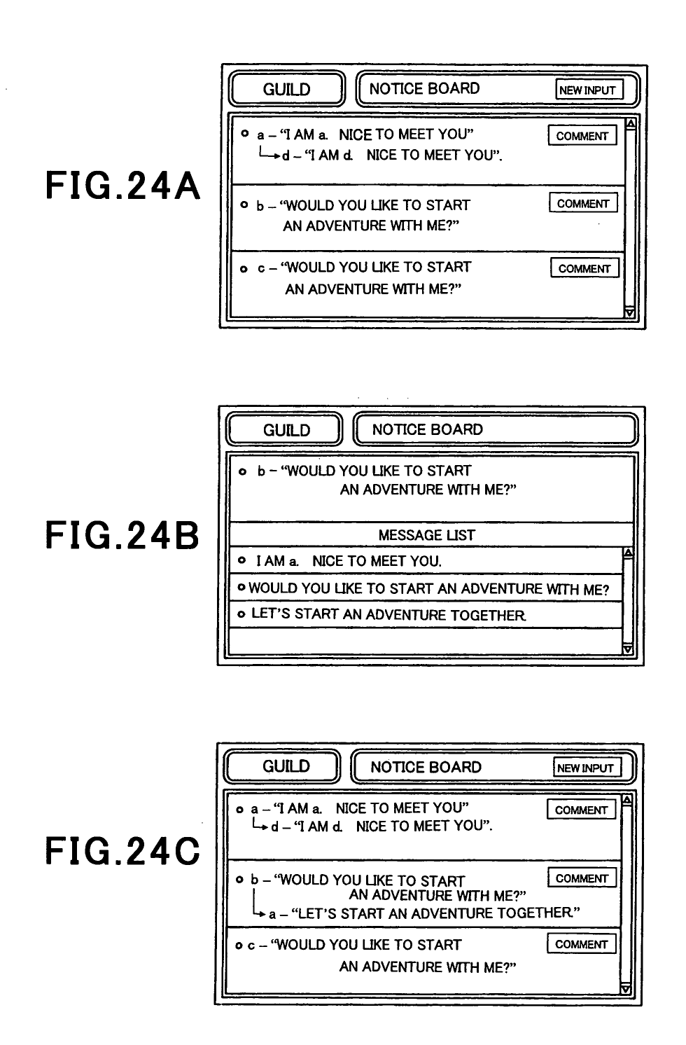

The notice board of a guild can be used by a player to write a message thereon. A message written by each player is displayed on the first display 11 of the terminal device 1 (see FIGS. 24A to 24C). The notice board can be used by the players to exchange the information, where a message is written to other player so that the information on the mission can be exchanged, and that a player can be invited to the mission.

(v) Trade a Belonging (an Item that the Character Possesses).

An item that the character acquired in the virtual game space, or an item acquired as a reward for clearing a mission can be traded through the guild.

(vi) Start a Mission and Move to a Mission Game (Only After Mission Acceptance)

When the mission is accepted in the above procedure of (i), a transition can be made to a mission game by performing this procedure of (vi).

In the above-described procedure of ST 5, the player can input various instructions by touching an image displayed on the first display 11 by means of the touch panel 14.

In ST 5, when the above-described procedure of (vi) is performed, a transition is made to a mission game (ST 6). The mission game is game in which a mission received from the guild is carried out, and forms the core of the game in the present embodiment. In the mission game of ST 6, a player uses the various buttons 118 and the operation lever 119 to operate the character corresponding to the player, and carry out an adventure in the virtual game space. If the survival ability of the character becomes zero due to an attack from a monster, or the like, the game ends (ST 7).

Furthermore, in the mission game, when a character image representing other character is displayed on the first display 11, a chat button is also displayed on the first display 11. At this time, when touching the chat button by means of the touch panel 14, a chat window is opened, and a plurality of types of chat messages are displayed in the chat window. The player uses the touch panel 14 to touch any one of the chat messages from the plurality of types of chat messages, and thereby can input a chat message. Moreover, by touching the character image representing a character, which is a destination of the chat message, by means of the touch panel 14, the chat message can be transmitted to the terminal device 1 of the player, which operates the character as the destination, via the arcade server 2.

Moreover, in the embodiment related to the second invention, by touching the chat message, and further by touching the character image representing a character, which is a destination of the chat message, by means of the touch panel 14, the chat message can be transmitted to the terminal device 1 of the player, which operates the character as the destination.

When clearing the mission in ST 6, the player returns to the guild of ST 5, receives a reward for clearing the mission, accepts a new mission, and moves to a mission game again. As described above, the game in the present embodiment is a game which proceeds by carrying out the guild (ST 5) and the mission game (ST 6) alternatively.

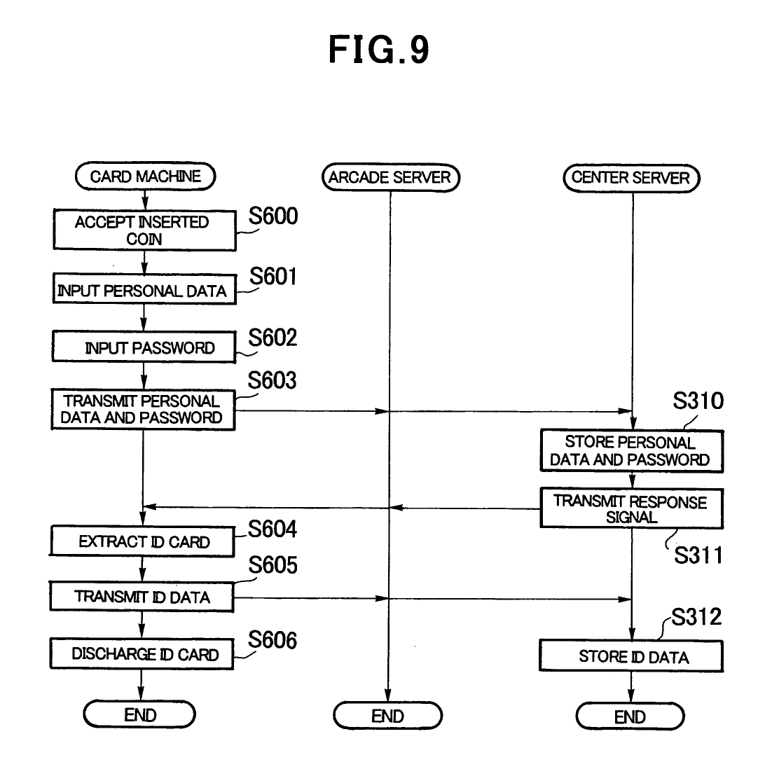

Next, a processing performed in the game system of the present embodiment when proceeding a game as described above is described. FIG. 9 is a flow chart showing a flow of a processing of until an ID card is issued in the card machine 6, arcade server 2 and center server 3.

First of all, the CPU 601 of the card machine 6 accepts that a coin is inserted into the card machine 6 (step S600). When receiving a predetermined signal outputted from the coin sensor 615 when the coin is detected, the CPU 601 accepts an input of the personal data (for example, a name or appellation, the date of birth, blood type, constellation, and the like) by an operation of a player (step S601). The CPU 601 further accepts an input of a password by an operation of the player (step S602). This password is used when authentication of the player is performed by means of the center server 3. Next, the CPU 601 transmits the inputted personal data and password to the center server 3 via the arcade server 2 through the dedicated line 5 by means of the communication interface circuit 604 (step S603).

The CPU 301 of the center server 3 stores the personal data and password transmitted from the terminal device 1 in the RAM 303 (step S310). Accordingly, the player is registered in the center server 3, and the CPU 301 then transmits a response signal to the terminal device 1 (step S311).

The CPU 601 of the card machine 6 extracts one ID card 8 from the plurality of ID cards 8 stored inside the card machine 6 (step S604). The CPU 601 then transmits the ID data stored in the extracted ID card 8 to the center server 3 (step S605), and discharges the ID card 8. As a result, the player can obtain the ID card 8. On the other hand, the center server 3 which receives the ID data relates the ID data to the personal data and password stored in the RAM 303, and thereafter stores it (step S312).

In the game system of the present embodiment, each terminal device 1 and the arcade server 2 connected to the terminal device 1 via the dedicated line 5 exchange data with each other, whereby a game proceeds. The player participation information which is stored in the RAM 203 of the arcade server 2 connected to the each terminal device 1 via the dedicated line 5, and in the RAM 303 of the center server 3 at this moment is described using FIG. 10.

FIG. 10 is a figure showing information on participation of players. Starting from the column on the left, information items on the order of acceptance (RN) which is the order where the center server 3 accepts participation to a game, on a machine ID (CN) which is identification information of the terminal device 1, and on an arcade server symbol (SN) which is identification information of the arcade server 2 are stored. In the game of the present embodiment, a predetermined number of players (20, for example) can participate in the same game, and the situation of the participation of the players is managed by the player participation information shown in FIG. 10.

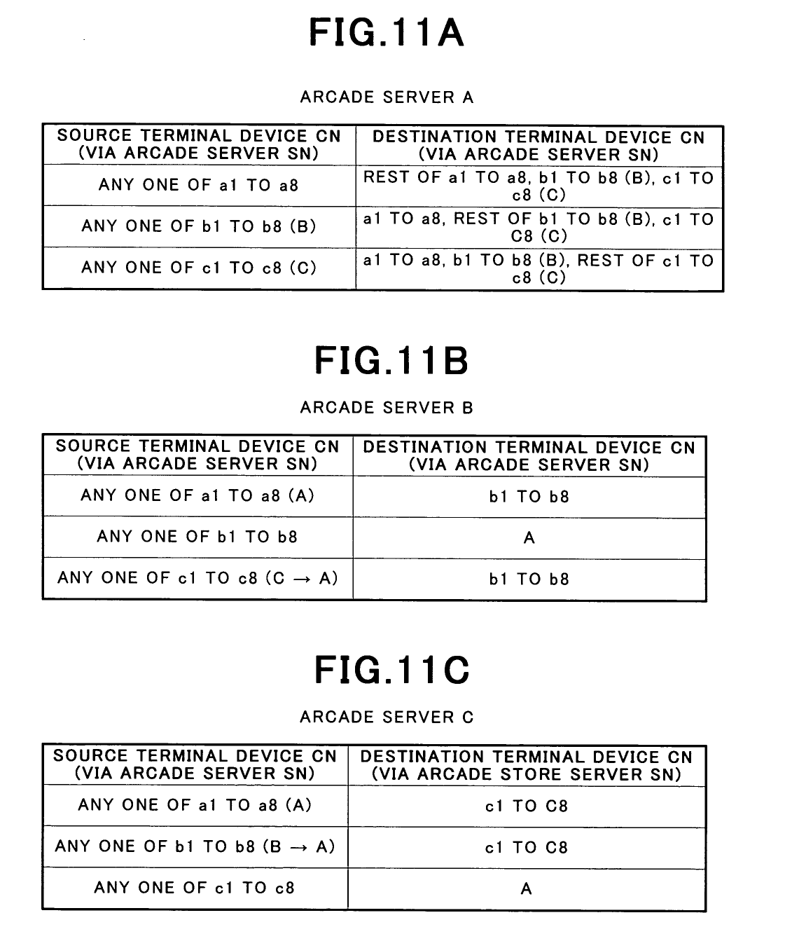

FIGS. 11A to 11C are figures for explaining the detail of a data transmission processing performed by the arcade servers A, B, and C. FIGS. 11A, 11B and 11C are figures for explaining the detail of the processing performed by the arcade servers A, B, and C respectively. The column on the left of the figure lists the machine ID (CN) of the terminal device 1 which is the source of data to be received by the arcade server 2 (arcade server A, B, or C), and the arcade server symbol (SN) of the arcade server 2 through which the data goes through before received by the arcade server 2. The column on the right of the figure lists the machine ID (CN) of the terminal device 1 which is the destination of data to be transmitted from the arcade server 2 (arcade server A, B, or C), and the arcade server symbol (SN) of the arcade server 2 through which the data goes through before received by the terminal device 1. It should be noted that when receiving the data transmitted from the terminal device 1 (for example, the terminal device a1 and the like) participating in a game, the CPU 201 that each arcade server A, B, and C comprises update various data stored in a predetermined region of the RAM 203.

The CPU 201 of the arcade server A receives data from any one of the terminal devices a1 to a8, as shown in the second line from the top of the FIG. 11A, and transmits the data to the rest of the terminal devices a1 to a8 and to the arcade servers B and C. The CPU 201 of the arcade server B then receives the data from any one of the terminal devices a1 to a8 via the arcade server A, as shown in the second line from the top of the FIG. 11B, and transmits the data to terminal devices b1 to b8. The CPU 201 of the arcade server C receives the data from any one of the terminal devices a1 to a8, as shown in the second line from the top of the FIG. 11C via the arcade server A, and transmits the data to terminal devices c1 to c8.

The CPU 201 of the arcade server B receives the data from any one of the terminal devices b1 to b8, as shown in the third line from the top of the FIG. 11B, and transmits the data to the arcade server A. The CPU 201 of the arcade server A then receives the data from any one of the terminal devices b1 to b8 via the arcade server B, as shown in the third line from the top of the FIG. 11A, and transmits the data to the terminal devices a1 to a8, the rest of the terminal devices b1 to b8, and the terminal devices c1 to c8. The CPU 201 of the arcade server C receives the data from any one of the terminal devices b1 to b8 via the arcade servers B and A, as shown in the third line from the top of the FIG. 11C, and transmits the data to the terminal devices c1 to c8.

Similarly, the CPU 201 of the arcade server C receives the data from any one of the terminal devices c1 to c8, as shown in the fourth line from the top of the FIG. 11C, and transmits the data to the arcade server A. The CPU 201 of the arcade server A then receives the data from any one of the terminal devices c1 to c8 via the arcade server C, as shown in the fourth line from the top of the FIG. 11A, and transmits the data to the terminal devices a1 to a8, the terminal devices b1 to b8, and the rest of the terminal devices c1 to c8. The CPU 201 of the arcade server B receives the data from any one of the terminal devices c1 to c8 via the arcade servers C and A, as shown in the fourth line from the top of the FIG. 11B, and transmits the data to the terminal devices b1 to b8.

In this manner, the CPU 201 transmits the data from each of the terminal devices 1 among the arcade servers A, B, and C, whereby the various data stored in the RAM 203 is updated every time the data from each of the terminal devices 1 is accepted. Therefore, each of the terminal devices 1 uses the data stored in the RAM 203 to proceed with the game, whereby the temporal synchronization in the proceeding of the game (matching the proceeding state of the game) can be controlled easily among the terminal devices 1.

Specifically, the arcade server 2 (the arcade server A here) which initially accepts participation to a game receives the data from the terminal device 1 connected by the dedicated line 5, transmits the data to all the other terminal devices 1, at the same time receives the data from the terminal device 1, which is connected to the other arcade server 2 (the arcade server B or C here) via the dedicated line 5, through the abovementioned other arcade server (the arcade server B or C), and transmits the data to all the other terminal devices 1. Further, the abovementioned other arcade server 2 (the arcade server B or C) receives the data from the terminal device 1, which is connected via the dedicated line 5, through the arcade server 2 (the arcade server A), and transmits the data to the terminal device 1 connected via the dedicated line 5.

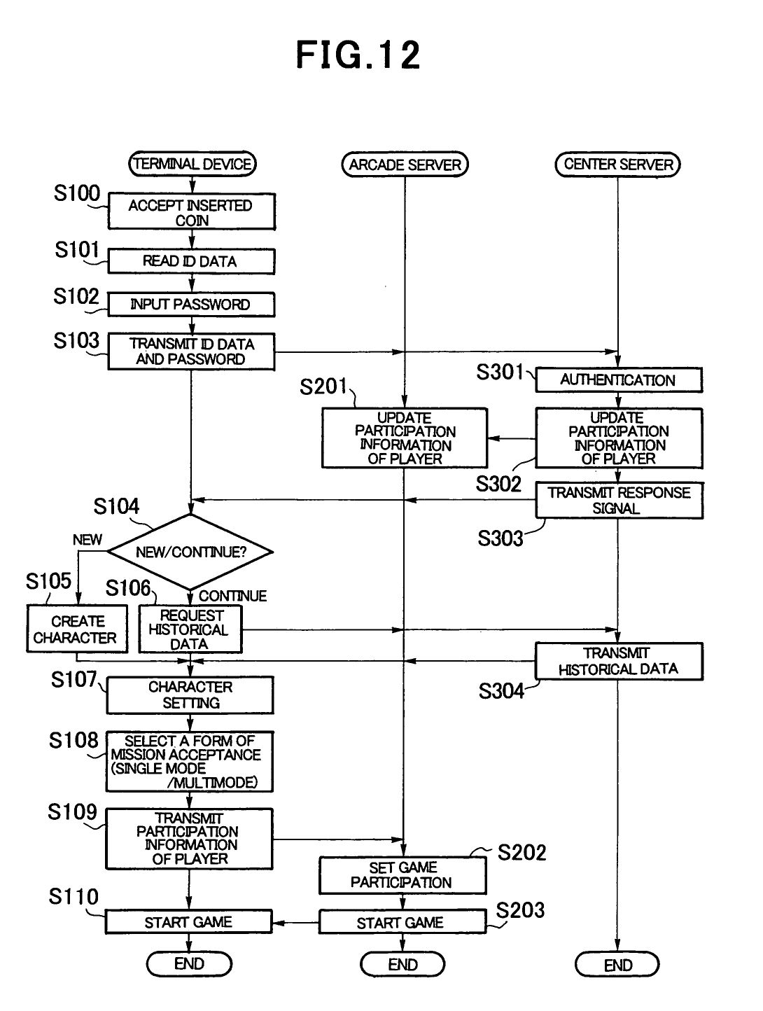

FIG. 12 is a flow chart showing a flow of processings of until a game start in the terminal device 1, arcade server 2 and center server 3. First, the CPU 101 of the terminal device 1 accepts that a coin is inserted into the coin insertion slot 15 (step S100). When receiving a predetermined signal outputted from the coin sensor 115 when the coin is detected, the CPU 101 reads the ID data of the player from the ID card 8 inserted into the ID card insertion slot 16, by means of the ID card reader 116 (step S101). Next, the CPU 101 accepts an input of a password by an operation of the player (step S102). The CPU 101 then transmits the read ID data and the password inputted by the operation of the player to the center server 3 through the arcade server 2 via the dedicated line 5 by means of the communication interface circuit 104 (step S103).

The CPU 301 of the center server 3 determines whether or not the ID data, which is received from the terminal device 1, exists in the ID data stored in the RAM 303, and, when it is determined that the ID data exists, performs authentication by determining whether the password of the player, which is related to the ID data and stored in the RAM 303, matches the password received from the terminal device 1 (step S301). It should be noted that the CPU 301 refers to the historical data stored in the RAM 303, and determines whether the player is one who tries to play a new game or one who ongoingly plays the game.

The CPU 301 of the center server 3 then updates the player participation information stored in the RAM 303 (see FIG. 10) (step S302), and transmits the player participation information to the arcade server 2 to update the player participation information stored in the RAM 203 of the arcade server 2 (step S201). Next the CPU 301 of the center server 3 transmits an authentication result as a response signal to the terminal device 1 (step S303).

The CPU 101 of the terminal device 1 determines whether the player who starts a game is one who plays a new game or one who ongoingly plays the game, on the basis of the response signal received from the center server 3 (step S104).

In the step S104, when it is determined that the player who stars a game is one who tries to play a new game, the CPU 101 performs creation of a character on the basis of an operation of the player (step S105). In this processing, the player uses the touch panel 14 while viewing the image display on the first display 11, to input instructions for selecting an appearance, capability, characteristics and the like of a character corresponding to the player (character operated by the player), and the CPU 101 creates a character corresponding to the instructions. The CPU 101 also sets the level value of a character, which corresponds to the player playing a new game, to an initial value (for example, level value 1). The CPU 101 then generates information on the player and player information (see FIG. 14) comprising a plurality of items such as a capability value of the character corresponding to the player based on the result of the processing in the step S105, stores the information in the RAM 103, and thereby performs character setting (step S107). The player information stored in the RAM 103 contains data related to the level value of the character corresponding to the player who plays a new game. The RAM 103 functions as the level storing means for storing the level value of the player. It should be noted that the player information shown in FIG. 14 indicates player information related to all of the players participating in the game, and the player information generated in this processing only indicates a predetermined item for one player. When executing the processings of the steps S105 and S107, the CPU 101 functions as the level setting means for setting a predetermined value in accordance with a game result, and storing, in the RAM 103 (level storing means), the level which is set by being related to the ID data of the player, as the level value.

It should be noted that in the embodiment related to the second invention, in the step S104, when it is determined that the player who stars a game is one who tries to play a new game, the CPU 101 performs creation of a character on the basis of an operation of the player (step S105). In this processing, the player uses the touch panel 14 while viewing the image display on the first display 11, to input instructions for selecting an appearance, capability, characteristics and the like of a character corresponding to the player (character operated by the player), and the CPU 101 creates a character corresponding to the instructions. The CPU 101 then generates information on the player and player information (see FIG. 14) comprising a plurality of items such as a capability value of the character corresponding to the player based on the result of the processing in the step S105, and thereby performs character setting (step S107). It should be noted that the player information shown in FIG. 14 indicates player information related to all of the players participating in the game, and the player information generated in this processing only indicates a predetermined item for one player.

In the step S104, on the other hand, when it is determined that the player who starts a game is one who ongoingly plays the game, the CPU 101 transmits a signal for requesting the historical data of the player to the center server 3 via the dedicated line 5 by means of the communication interface circuit 104 (step S106). Once the center server 3 receives the signal from the terminal device 1, the center server 3 reads out the historical data for the player from the RAM 303, and transmits the historical data to the terminal device 1 (step S304).

FIGS. 13A and 13B are figures showing an example of the historical data. The historical data shown in FIG. 13A is historical data of the player and the character at that moment (also referred to as “player historical data” hereinafter). The historical data shown in FIG. 13B is historical data indicating the game process of the player (character corresponding to the player) (also referred to as “game historical data” hereinafter). These historical data are updated in a predetermined time (for example, a time when a mission is cleared, when receiving a reward for clearing a mission, when a monster is struck down, etc.).

The player historical data includes items such as, for example, the ID data of the player, the name of the player, the level (level value), weapons, protective equipment, belongings of the character, the pocket money, the level of skill, and the like, as shown in FIG. 13A. Furthermore, as shown in FIG. 13B, the game historical data includes, for every mission cleared by the player, a plurality of historical data items comprising a plurality of types of elements such as the date and hour when the mission is cleared, the player participating in the mission, the level (level value) when the mission is cleared, the time required, a reward acquired, and the like.

In the step S304, such historical data shown in FIGS. 13A and 13B are transmitted from the center server 3 to the terminal device 1. The CPU 101 of the terminal device 1, which receives the historical data from the center server 3, uses the historical data to generate the information on the player and the player information comprising a plurality of items such as the capability value of the character corresponding to the player (see FIG. 14), stores the information in the RAM 103, and thereby performs the character setting (step S107). Regarding the capability value of the character, the CPU 101 refers to the capability value setting value table stored in the ROM 102 to determine the capability value of the character, on the basis of the level value of the player (character corresponding to the player) included in the historical data. It should be noted that the player information shown in FIG. 14 indicates player information related to all of the players participating in the game, and the player information generated in this processing only indicates a predetermined item for one player. When executing the processing of the step S107, the CPU 101 functions as the level setting means for setting a predetermined level in accordance with a game result, and storing, in the RAM 103 (level storing means), the level which is set by being related to the ID data of the player, as the level value.

It should be noted that the processing in the step S304 in the embodiment related to the second invention is approximately the same as above, but slightly differs as follows. Specifically, in the step S304, such historical data shown in FIGS. 13A and 13B are transmitted from the center server 3 to the terminal device 1. The CPU 101 of the terminal device 1, which receives the historical data from the center server 3, uses the historical data to generate the information on the player and the player information comprising a plurality of items such as the capability value of the character corresponding to the player (see FIG. 14), and thereby performs the character setting (step S107). Regarding the capability value of the character, the CPU 101 refers to the capability value setting value table stored in the ROM 102 to determine the capability value of the character, on the basis of the level of the player (character corresponding to the player) included in the historical data. It should be noted that the player information shown in FIG. 14 indicates player information related to all of the players participating in the game, and the player information generated in this processing only indicates a predetermined item for one player

After the processing of the step S107 is performed, the CPU 101 accepts that a form of mission acceptance is selected (step S108). In this processing, the player operates the touch panel 14 while viewing the image display on the first display 11, to input instructions for selecting either the single mode in which a single player accepts a mission, or a multimode in which a player accepts the mission with other player. The CPU 101 stores data corresponding to the inputted instructions in the column for the form of mission acceptance of the player information stored in the RAM 103 (see FIG. 14). It should be noted that the player information shown in FIG. 14 indicates player information related to all of the players participating in the game, and the data stored in the column for the form of mission acceptance in this processing is data of a single player only.

It should be noted that in the embodiment related to the second invention, the CPU 101 functions as the selecting means for selecting either to perform a play alone or with other player in order to achieve a certain mission in a game, in accordance with an input operation performed by a player using the touch panel 14.

Next, the CPU 101 transmits the player information on one player, which is stored in the RAM 103, to the arcade server 2 via the dedicated line 5 by means of the communication interface circuit 104 (step S109).

Next, the CPU 201 of the arcade server 2 uses the player information related to the single player to perform settings for allowing the player to participate in the game (step S202). In this processing, the CPU 201 adds the player information related to the single player, the player information being received from the terminal device 1, to the player information which is already stored in the RAM 203. Moreover, the CPU 201 sets a play field coordinates of the character corresponding to a player who newly participates in the game to an initial value (a value corresponding to the location of the guild) (see FIG. 14). In the embodiment related to the first invention, the CPU 201 performs the processing of the step S202, whereby the data related to the level value of the player is stored in the RAM 203. The RAM 203 functions as the level storing means for storing a level value of a player.

FIG. 14 shows the player information stored in the RAM 203 of the arcade server 2. As shown in FIG. 14, player information on a plurality of players (five players in the figure) is stored in the RAM 203 of the arcade server 2. The player information comprises a plurality of items, and, for example, information on the player, level (level value) of the character, capability value, information on the level of skills, and other items are stored, for example. As shown in the figure, information on a mission in the course of setting is stored in the column for the mission. Further, data regarding whether the single mode is selected or the multimode is selected is stored in the column for the form of mission acceptance. In addition, data regarding the position in the virtual game space in which the character exists at the moment is stored in the play field coordinates.

After the processing of the step S202 is executed, a game is started in the terminal device 1 and in the arcade server 2 (steps S110, S203). As shown in FIG. 12, each player can participate in the game played in the game system according to the present embodiment whenever the player wants, and a plurality of players can play the same game in the same virtual game space. This is one of the characteristics of the MMORPG. Moreover, during the game, the data is transmitted between the arcade server 2 and each of the terminal devices 1 participating in the game, and the temporal synchronization is controlled as described above using FIG. 11, thus the same player information is always stored in the RAM 203 of the arcade server 2 and the RAM 103 of the terminal device 1.

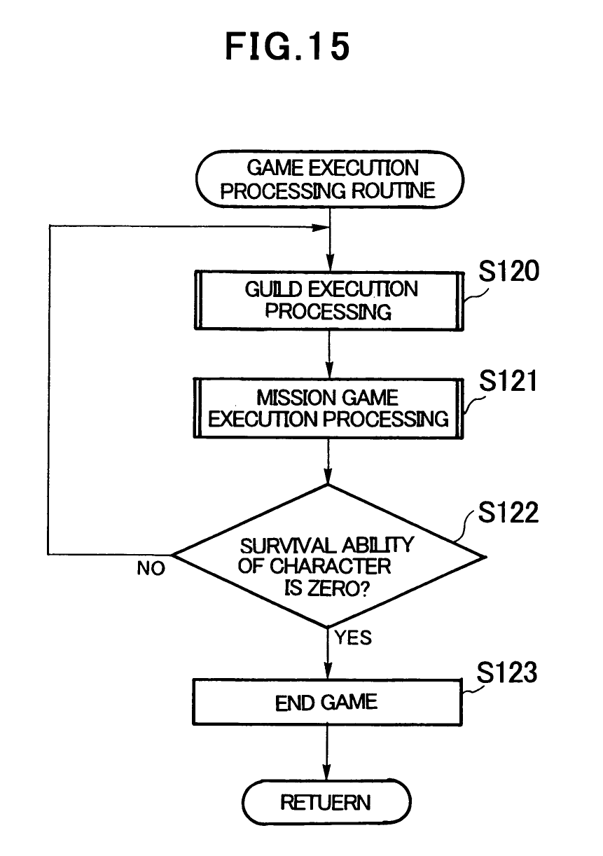

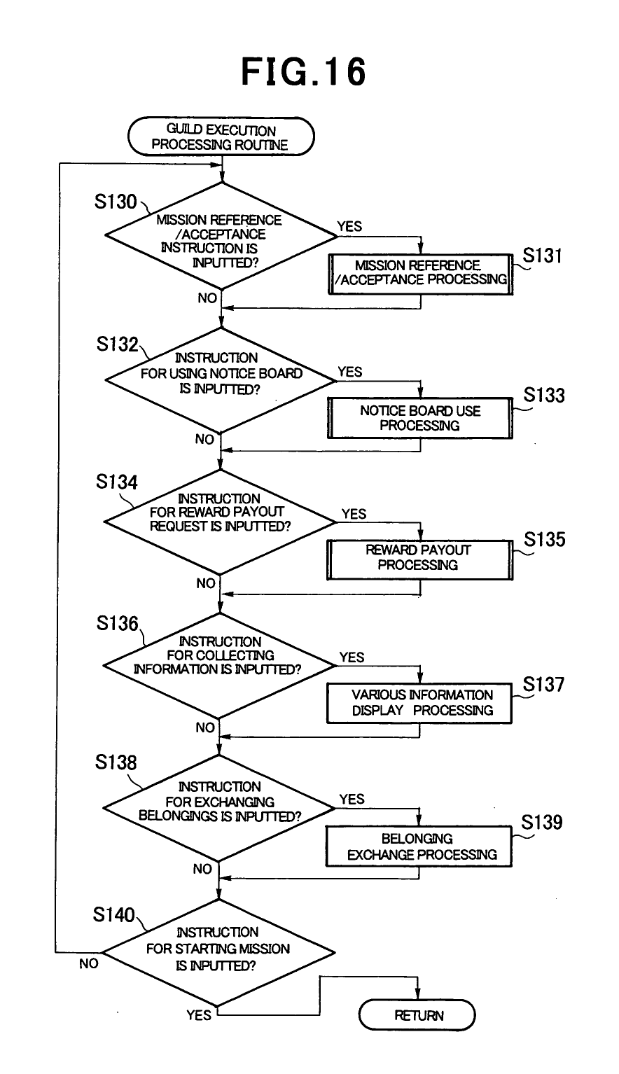

FIG. 15 is a flow chart showing an outline of the processing executed in the terminal device 1 during a game. First of all, the CPU 101 of the terminal device 1 performs a guild execution processing (step S120). In the guild execution process, which is explained hereinafter using FIG. 16, mission reference and acceptance, information collection, reception of a reward for clearing a mission, use of the guild notice board or exchange of the items, and the like can be performed, as shown in ST 5 of FIG. 8. Moreover, the guild execution processing ends when a character accepts a mission and thereafter the mission is started.

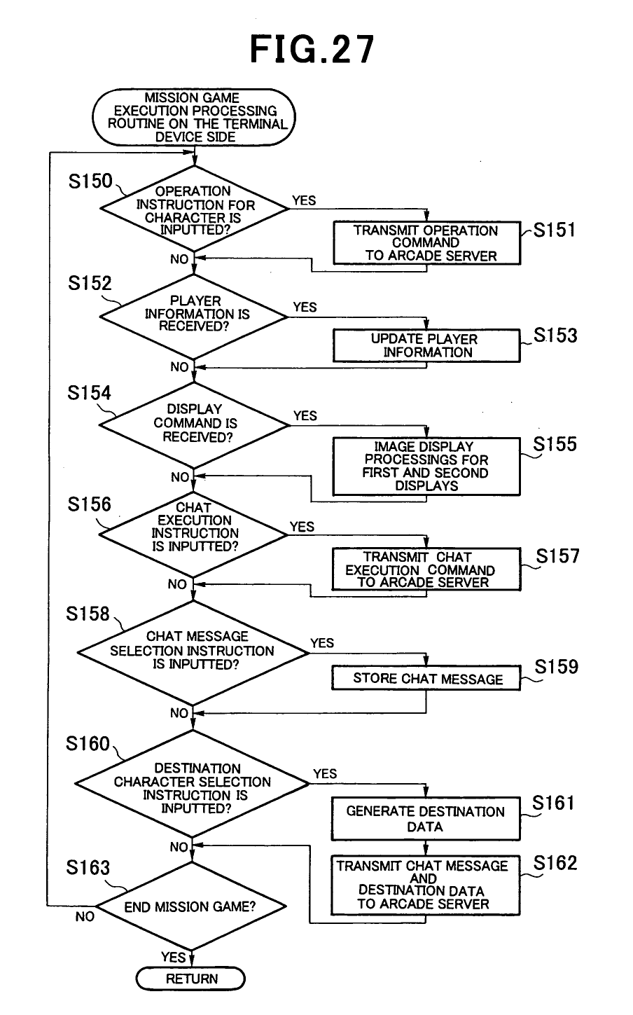

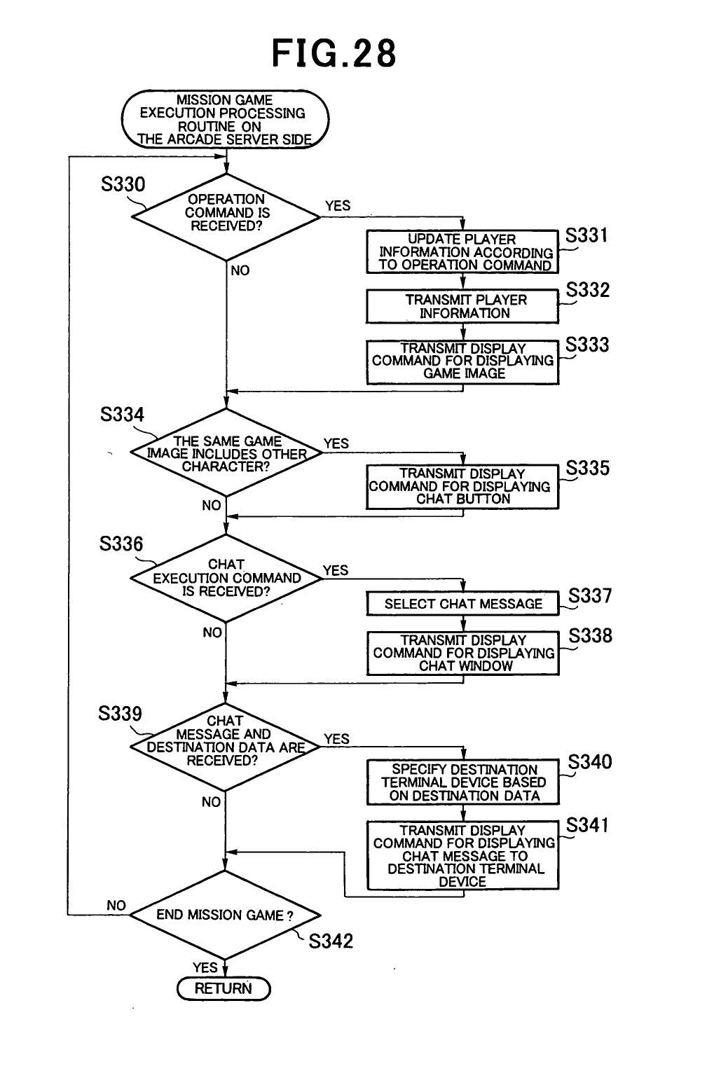

After the guild execution processing of the step S120 ends, the CPU 101 performs a mission game execution processing (step S121). The mission game execution processing is described hereinafter using FIG. 27 and FIG. 28. In the mission game execution processing, a player uses the various buttons 118 and the operation lever 119 to operate the character corresponding to the player, and carries out an adventure in the virtual game space. The player can also exchange a chat message with other player. This mission game execution processing ends when a predetermined condition for mission termination is satisfied. The condition for mission termination includes, for example, clearing a mission, returning to the guild, and reaching zero survival ability, and the like.

In the case where the condition for mission termination as described is satisfied, and the mission game execution processing of the step S121 ends, the CPU 101 determines whether or not the survival ability of the character becomes zero (step S122). When it is determined that the survival ability of the character becomes zero, the character cannot continue the game, thus various processings for ending the game are executed (step S123), and the sub routine is ended. When the game ends, the CPU 201 of the arcade server 2 transmits the game history stored in the RAM 203 to the center server 3. The center server 3 stores the game history received from the arcade server 2 in the RAM 303. In the embodiment related to the second invention, when it is determined that the survival ability of the character becomes zero, various processings for ending the game (for example, generating historical data based on the player information, transmitting the historical data to the center server 3, and other processings) are executed (step S123), and the sub routine is ended.

In the step S122, on the other hand, when it is determined that the survival ability of the character is not zero, it means that other conditions for mission termination (for example, clearing the mission, returning to the guild, and the like) are satisfied. Thus the processing is returned to the guild execution processing of the step S120. Therefore, in this game execution processing, the guild execution processing of the step S120 and the mission game execution processing of the step S121 are repeatedly executed until the survival ability of the character becomes zero. Of course, although not shown, when an instruction for ending the game is inputted by the player, the sub routine is ended after executing the processing of the step S123 for ending the game, regardless of whether the survival ability of the character is zero or not.

Next, the guild execution processing which executed after called up in the step S120 of the flow chart shown in FIG. 15 is described. FIG. 16 is a flow chart showing a routine of the guild execution processing which is called up in the step S120 of the flow chart shown in FIG. 15 and is executed by the terminal device 1. FIGS. 17A and 17B are figures schematically showing images which are displayed on the first display 11 of the terminal device 1 when the sub routine shown in FIG. 16 is executed.

When the guild execution processing shown in FIG. 16 is executed, an image as shown in FIG. 17A is displayed on the first display 11 by the first rendering process portion 111. An image such as “guild” which shows the current location of the character is disposed on the upper left of the screen, and an image showing an instruction for the player such as “please select what to do” is disposed on the upper right of the screen. An image showing options such as “mission reference/acceptance”, “notice board”, “reward”, “information collection”, “exchange of the belongings” are disposed from the top in the center of the screen. The player can input an instruction corresponding to the options by touching the image showing the selection using the touch panel 14.

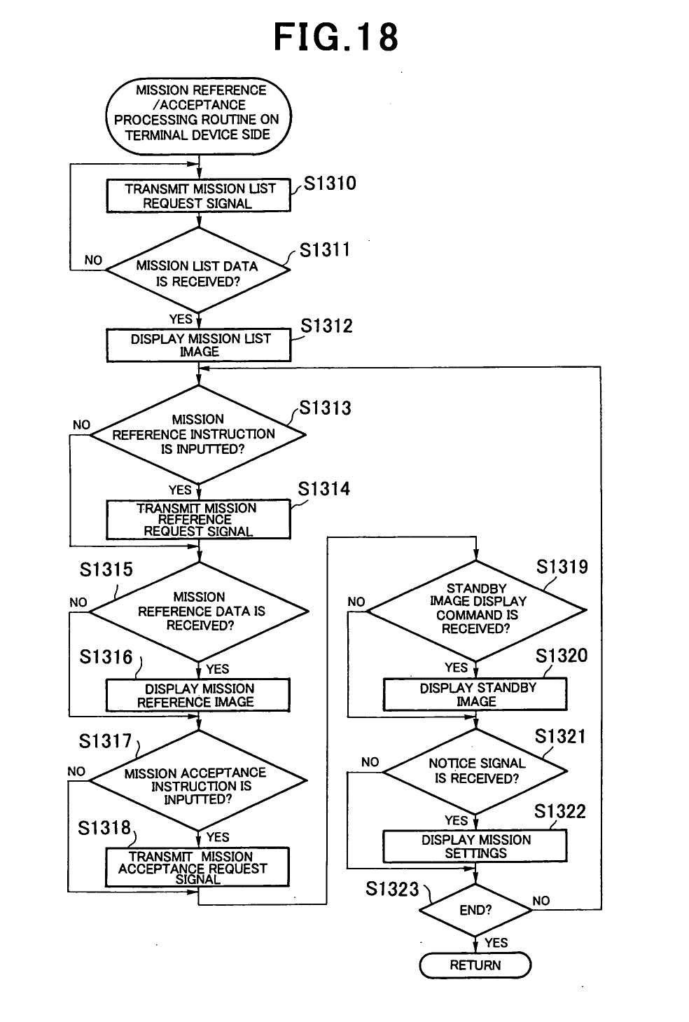

Once the sub routine shown in FIG. 16 is executed, the CPU 101 first determines whether an instruction for the mission reference/acceptance is inputted or not (step S130). The player inputs this instruction by touching the image showing the option of “mission reference/acceptance” by means of the touch panel 14. When it is determined that the instruction for the mission reference/acceptance is inputted, the CPU 101 executes the mission reference/acceptance processing (step S131). This mission reference/acceptance processing is described in detail hereinafter using FIG. 18. As shown in FIG. 17B, the option of “mission reference/acceptance” displayed on the first display 11 is changed to an option of “mission start”.

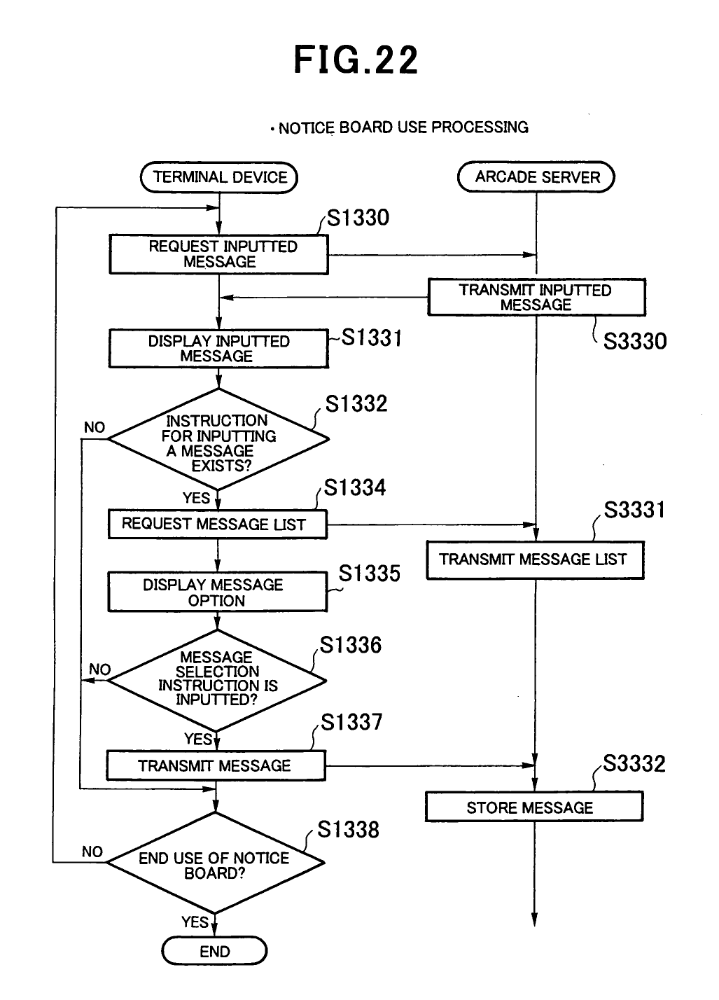

Next, the CPU 101 determines whether an instruction for using the notice board is inputted or not (step S132). The player inputs this instruction by touching the image showing the option of “notice board” by means of the touch panel 14. When it is determined that the instruction for using the notice board is inputted, the CPU 101 executes a notice board use processing (step S133). This notice board use processing is described in detail hereinafter using FIG. 22.

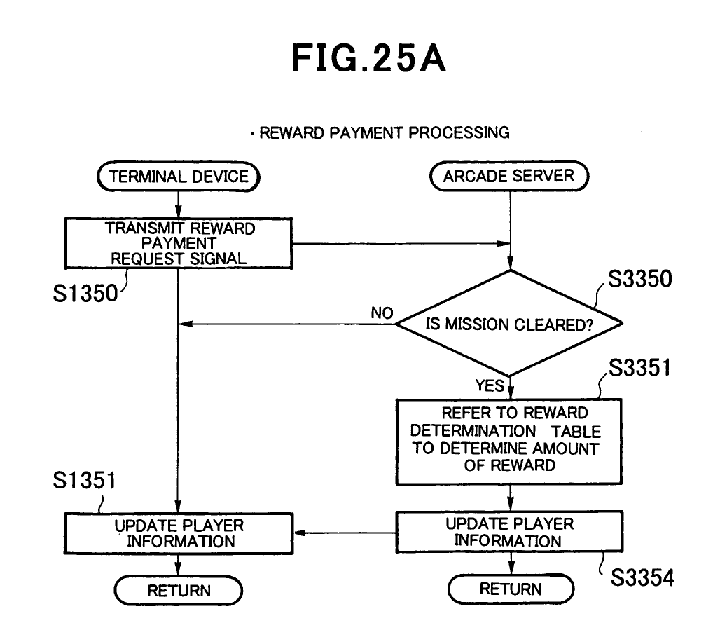

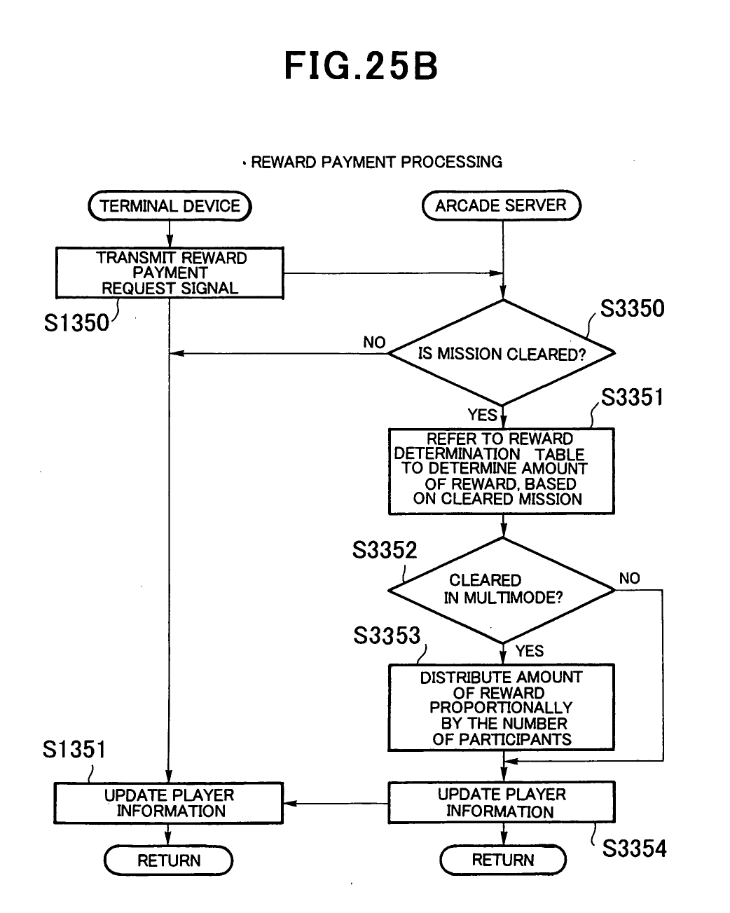

Next, the CPU 101 determines whether an instruction for a reward payout request is inputted or not (step S134). The player inputs this instruction by touching the image showing the option of “reward” by means of the touch panel 14. When it is determined that the instruction for a reward payout request is inputted, the CPU 101 executes a reward payout processing (step S135). This reward payout processing is described in detail hereinafter using FIG. 25.

Next, the CPU 101 determines whether an instruction for collecting information is inputted or not (step S136). The player inputs this instruction by touching the image showing the option of “information collection” by means of the touch panel 14. When it is determined that the instruction for information collection is inputted, various information display processings are performed (step S137). In the processings, the CPU 201 of the arcade server 2 executes the programs stored in the ROM 202, whereby the CPU 101 acquires the information selected from the ROM 203 (for example, the information related to other character or mission) from the arcade server 2, and, based on this information, displays an image representing this information on the first display 11 by means of the first rendering process portion 111.

Next, the CPU 101 determines whether an instruction for exchanging the belongings is inputted or not (step S138). The player inputs this instruction by touching the image showing the option of “exchange of the belongings” by means of the touch panel 14. When it is determined that the instruction for exchanging the belongings is inputted, a belonging exchange processing is performed (step S139). In this processing, when the player selects a belonging which the player wishes to sell to the guild from among the belongings of the character, the instruction is transmitted to the arcade server 2, and the CPU 201 of the arcade server 2 increases the money for the player information stored in the RAM 203, and performs a processing for deleting the data of the belonging. On the other hand, when the player selects an item sold by the guild, the instruction is transmitted to the arcade server 2, and the CPU 201 of the arcade server 2 reduces the pocket money for the player information stored in the RAM 203, and performs a processing for adding the data for the item.

Next, the CPU 101 determines whether the instruction for starting mission is inputted or not (step S140). The player inputs this instruction by touching the image showing the option of “mission start” by means of the touch panel 14, when the image shown in FIG. 17B is displayed on the first display 11. When it is determined that the instruction for the mission start is inputted, the sub routine ends. On the other hand, when it is determined that the instruction for the mission start is not inputted, the processing is returned to the step S130.

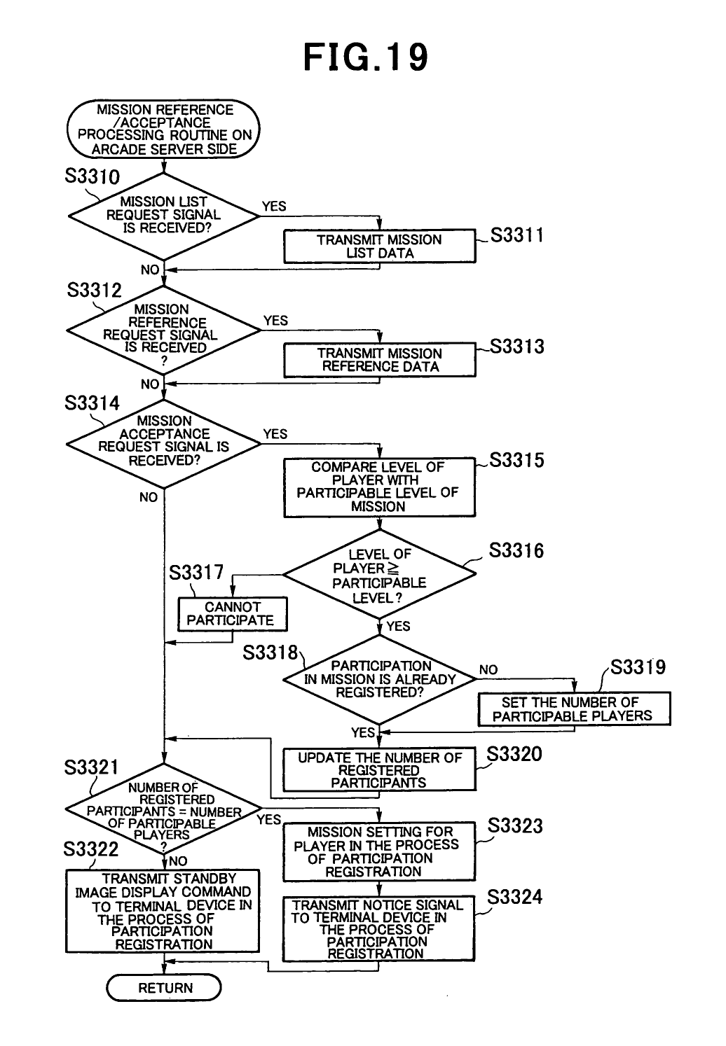

FIG. 18 is a flow chart showing a routine of the mission reference/acceptance processing which is called up in the step S131 of the flow chart shown in FIG. 16 and executed by the terminal device 1. FIG. 19 is a flow chart showing a processing executed by the arcade server 2 in accordance with the sub routine shown in FIG. 18, which is executed by the terminal device 1.

First of all, the CPU 101 of the terminal device 1 transmits a mission list request signal to the arcade server 2 via the dedicated line 5 by means of the communication interface circuit 104 (step S1310). This processing corresponds to a processing of a step S3310 of FIG. 19, where when the CPU 201 of the arcade server 2 receives the mission list request signal from the terminal device 1, the CPU 201 extracts mission list data, which is related to a mission in which the player can participate at the present moment, from the mission list data stored in the ROM 202, and transmits it to the terminal device 1.

FIG. 20 is a figure showing an example of the mission list data. Mission codes (for example, “AA”, “AB”, and the like) comprising two-digit symbols are stored in the leftmost column, the mission codes being allocated to the missions respectively. Further, the number of participable players in each mission is stored in the right column. “1” is stored as the number of participable players for the single mode, and “4” is stored as the number of participable players for the multimode. It should be noted that in the embodiment related to the second invention, the number of participable players is equivalent to the number of players in the present invention.

In the present embodiment, there is provided an explanation of the case where the number of participable players for the single mode is 1 and the number of participable players for the multimode is 4. The present invention, however, is not limited to this example. For example, a mission where the number of participable players for the single mode is 0 may exist. In this case, a player cannot participate in this mission by the single mode, thus the multimode has to be selected. The number of participable players for the multimode is also not particularly restricted.

The detail of the mission “AA” is “wishing to deliver a package to Mr. XX”, and the participable level (level value) is 1. It should be noted that the participable level (level value) is the minimum level (level value) necessary for accepting the mission, and if the player does not reach the level (level value), he cannot accept the mission. The detail of the mission “AB” is “wishing to protect the Princess ●● from monster ΔΔ”, and the participable level (level value) is 3. The detail of the mission “AC” is “wishing to search for a hidden treasure in a cave OO”, and the participable level (level value) is 5. The detail of the mission “AD” is “wishing to search for a hidden treasure on a solitary island □□”, and the participable level (level value) is 7. The detail of the mission “AE” is “wishing to search the ancient monument to solve the mystery of ▪▪”, and the participable level (level value) is 9. The detail of the mission “AF” is “searching a land no man has ever explored”, and the participable level (level value) is 11. The degree of difficulty of the mission becomes high in the order of “AA” to “AF”, and the participable level (level value) is so as to be higher in accordance with the degree of difficulty of the mission. The mission (condition) in the present invention is not limited to this example, of course, and is not particularly restricted as long as it can be set in a game.

After the processing of the step S1310, the CPU 101 determines whether or not the mission list data is received from the arcade server 2 (step S1311). When it is determined that the mission list data is not received, the processing is returned to the step S1310. On the other hand, when it is determined that the mission list data is received from the arcade server 2, the CPU 101 controls the first rendering process portion 111, and performs a processing for causing the first display 11 to display the image shown in FIG. 21A (step S1312).

FIG. 21A is a figure showing an example of an image displayed on the first display 11 when the processing of the step S1312 is performed. An image such as “guild” which shows the current location of the character is disposed on the upper left of the screen, and an image showing an instruction for the player, such as “which mission would you like?”, is disposed on the upper right of the screen. An image showing the details of the mission is displayed, such as “deliver a package to Mr. XX”, “protect the Princess ●● from monster ΔΔ”, “a hidden treasure in a cave OO”, “search on a solitary island □□”, and “mystery of an ancient monument” sequentially from the top in the center of the screen. An image showing options of “reference” and “acceptance” is disposed in accordance with each mission. The player can touch the image showing the options by means of the touch panel 14 to input an instruction corresponding to the options. For example, by touching the image showing the option of “reference” corresponding to “a hidden treasure in a cave OO” by means of the touch panel 14, information on “a hidden treasure in a cave OO” can be obtained. Further, by touching the image showing the option of “acceptance” corresponding to “a hidden treasure in a cave OO” by means of the touch panel 14, the mission “a hidden treasure in a cave OO” can be accepted.

After the processing of the step S1312, the CPU 101 determines whether or not an instruction of the mission reference is inputted (step S1313). This instruction can be inputted by touching the image showing the option of “reference” by means of the touch panel 14. When it is determined that an instruction of the mission reference is inputted, the CPU 101 transmits a mission reference request signal to the arcade server 2 via the dedicated line 5 by means of the communication interface circuit 104 (step S1314). This processing corresponds to a step S3312 of FIG. 19. The arcade server 2 which receives the mission reference request signal from the terminal device 1 extracts the mission reference data related to the mission requested from the mission reference data stored in the ROM 202 (for example, the data in which the detail of the mission is described, a dynamic image or static image showing the detail, and the like), and transmits the extracted mission reference data to the terminal device 1.

When it is determined in the step S1313 that an instruction for the mission reference is not inputted, or when the processing of the step S1314 is executed, the CPU 101 then determines whether or not the mission reference data is received (step S1315). When it is determined that the mission reference data is received, the CPU 101 controls the first rendering process portion 111, and performs a processing for causing the first display 11 to display the image shown in FIG. 21B (step S1316).

FIG. 21B is a figure showing an example of an image displayed on the first display 11 when the processing of the step S1316 is performed. An image such as “guild” which shows the current location of the character is disposed on the upper left of the screen, and an image showing the name of the mission to be referred to, such as “about a hidden treasure in a cave OO”, is disposed on the upper right of the screen. An image showing an entrance of the cave OO is disposed on the left side of the screen. On the right side of the screen, an image showing a message for explaining the detail of the mission is disposed, and also an image showing options of “acceptance” and “return” is disposed.

When it is determined in the step S1315 that the mission reference data is not received from the arcade server 2, or when the processing of the step S1316 is executed, the CPU 101 determines whether or not an instruction for the mission acceptance is inputted (step S1317). This instruction can be inputted by touching the image showing an option of “acceptance” by means of the touch panel 14. When it is determined that an instruction for the mission acceptance is inputted, the CPU 101 transmits a mission acceptance request signal to the arcade server 2 via the dedicated line 5 by means of the communication interface circuit 104 (step S1318). This processing corresponds to the processing of the step S3314 of FIG. 19.

In the step S1317, when it is determined that an instruction for the mission acceptance is not inputted, or when the processing of the step S1318 is executed, the CPU 101 determines whether or not a standby image display command is received from the arcade server 2 (step S1319). This processing corresponds to the processing of a step S3322 of FIG. 19, and the standby image display command comprises data related to the number of participable players to the mission and to the number of registered participants. It should be noted that in the embodiment related to the second invention, the number of registered participants is equivalent to the number of entries in the present invention.

In he step S1319, when it is determined that the standby image display command is received, the CPU 101 controls the first rendering process portion 111 on the basis of the standby image display command (step S1320). The first rendering process portion 111 uses the data related to the number of participable players and to the number of registered participants contained in the above-described standby image display command to extract predetermined image data from the ROM 102, and store the image data in the video RAM in the predetermined order of priority, thereby generating a standby image. The first rendering process portion 111 then outputs the standby image to the first display 11. As a result, the image shown in FIG. 21C, for example, is displayed on the first display 11.

FIG. 21C is a figure showing an example of an image displayed on the first display 11 when the processing of the step S1320 is performed. An image such as “guild” which shows the current location of the character is disposed on the upper left of the screen, and an image showing the name of the mission, such as “a hidden treasure in a cave OO”, is disposed on the upper right of the screen. Further, in the center of the screen, an image is displayed showing that the number of participable players is 4, and that the number of registered participants at the present moment is 3.

In the step S1319, when it is determined that the standby image display command is not received from the arcade server 2, or when the processing of the step S1320 is executed, the CPU 101 then determines whether or not a notice signal is received from the arcade server 2 (step S1321). This processing corresponds to he processing of a step S3324 of FIG. 19.

When it is determined in the step S1321 that the notice signal is received, the CPU 101 controls the first rendering process portion 111, and causes the first display 11 to display an image showing that the mission is set, as shown in FIG. 21D (step S1322).

FIG. 21D is a figure showing an example of an image displayed on the first display 11 when the processing of the step S1322 is performed. An image such as “guild” which shows the current location of the character is disposed on the upper left of the screen, and an image showing the name of the accepted mission, such as “a hidden treasure in a cave OO”, is disposed on the upper right of the screen. An image showing an entrance of the cave OO is disposed on the left side of the screen. On the right side, an image showing that the mission is accepted is disposed.

When it is determined in the step S1321 that the notice signal is not received, or when the processing of the step S1322 is executed, the CPU 101 determines whether or not to end the mission reference/acceptance processing (step S1323). The mission reference/acceptance processing ends when the player uses the touch panel 14 to input an instruction for returning the processing to the sub routine of FIG. 16 after ending this processing. In the step S1323, when it is determined to end the mission reference/acceptance processing, the sub routine ends. On the other hand, when it is determined not to end the mission reference/acceptance processing, the processing is moved to the step S1313.

Next, the flow chart shown in FIG. 19 is described. First of all, the CPU 201 of the arcade server 2 determines whether or not a mission list request signal is received from the terminal device 1 (step S3310). This processing corresponds to the processing of the step S1310 of FIG. 18. When it is determined that the mission list request signal is received from the terminal device 1, the CPU 201 of the arcade server 2 extracts the mission list data related to a mission in which the player can participate at the present moment, from the mission list data stored in the ROM 202, and transmits it to the terminal device 1 (step S3311). This processing corresponds to the step S1311 of FIG. 18, where a mission list image (see FIG. 21A) is displayed on the first display 11 of the terminal device 1 which receives the mission list data (FIG. 18, step S1312).

In the step S3310, when it is determined that the mission list request signal is not received, or when the processing of the step S3311 is executed, the CPU 201 of the arcade server 2 determines whether or not a mission reference request signal is received from the terminal device 1 (step S3312). This processing corresponds to the processing of the step S1314 of FIG. 18.

When it is determined in the step S3312 that the mission reference request signal is received from the terminal device 1, the CPU 201 extracts the mission reference data related to the mission requested from the mission reference data stored in the ROM 202, and transmits the extracted mission reference data to the terminal device 1 (step S3313). This processing corresponds to the step S1315, where a mission reference image (see FIG. 21B) is displayed on the first display 11 of the terminal device 1 which receives the mission reference data (FIG. 18, step S1316).

In the step S3312, when it is determined that the mission reference request signal is not received, or when the processing of the step S3313 is executed, the CPU 201 determines whether or not a mission acceptance request signal, which contains the data indicating the mission selected by the player, is received (step S3314). This processing corresponds to the step S1318 of FIG. 18. At this time, the CPU 201 functions as the condition selecting means for selecting any one condition from among a plurality of types of conditions in accordance with an input operation performed by a player. Furthermore, in the embodiment related to the second invention, in the step S3312, when it is determined that the mission reference request signal is not received, or when the processing of the step S3313 is executed, the CPU 201 determines whether or not a mission acceptance request signal is received (step S3314). This processing corresponds to the step S1318 of FIG. 18.

When it is determined in the step S3314 that the mission acceptance request signal is received, the CPU 201 of the arcade server 2 compares the level (level value) of the player, which is contained in the player information stored in the RAM 203 (see FIG. 14), with the participable level (level value) contained in the mission list data stored in the ROM 202 (see FIG. 20) (step S3315). Next, the CPU 201 determines whether the level (level value) of the player is above the participable level (level value) of the mission, on the basis of the comparison result in the step S3315 (step S3316). For example, for a player “d” in the player information shown in FIG. 14, since the level (level value) is 11, and the player can participate in the mission “AB” in which the participable level (level value) is 3. On the other hand, for a player “a” in the player information shown in FIG. 14, since the level (level value) is 1, the player cannot participate in the mission “AB”.

When it is determined in the step S3316 that the level (level value) of the player is not above the participable level (level value) of the mission, the CPU 201 moves the processing to the step S3321 without performing registration for participation of the player to the mission (step S3317).

On the other hand, in the step S3316, when it is determined that the level (level value) of the player is above the participable level (level value) of the mission, the CPU 201 determines whether or not other player already performs registration for participation to the mission (step S3318). If it is determined that the abovementioned other player does not perform the registration for participation to the mission, the CPU 201 refers to the mission list data stored in the ROM 202, and stores in the RAM 203 the data related to the number of participable players for the mission, thereby setting the number of participable players to the mission (step S3319). For example, if the player selects the single mode, the RAM 203 is caused to store the data indicating that the number of participable players is “1”. Furthermore, if the player selects the multimode, the RAM 203 is caused to store the data indicating that the number of participable players is “4”.

It should be noted that in the embodiment related to the second invention, the CPU 201 of the arcade server 2 functions as the player number setting means for setting the number of players (the number of participable players) who perform a play in order to achieve a condition to be cleared, which is set in a game.

In the step S3318, when it is determined that the other player already performs the registration for participation to the mission, or when the processing of the step S3319 is executed, the CPU 201 performs a processing for updating the number of registered participants (step S3320). When the processing of the step S3319 is executed, the CPU 201, in this processing, stores in the RAM 203 the data indicating that the number of participants for the mission is “1”. On the other hand, when the other player already performs the registration for participation to the mission, the CPU 201, in this processing, updates the number of participants stored in the RAM 203 so as to add 1 to the number of participants, since the data indicating the number of participants for the mission is stored in the RAM 203.

It should be noted that in the embodiment related to the second invention, the RAM 203 functions as the entry number storing means for storing the number of entries (the number of registered participants) into a mission for each mission. Further, the CPU 201 functions as the entry number updating means for updating the number of entries (the number of registered participants), which is stored in the RAM 203 functioning as the entry number storing means, on the basis of a selection made by the CPU 101 functioning as the selecting means.

In the step S3314, when it is determined that the mission acceptance request signal is not received, or when the processing of the step S3320 is executed, the CPU 201 determines whether or not the number of participants for a mission, in which the number of participants is updated (by adding 1) sequentially every time when the processing of the step S3320 is performed, is the same as the number of participants for the mission which is set in the step S3319 (step S3321). When the single mode is selected, the number of participable players for the mission is set to “1” in the step S3319, and the number of registered participants for the mission is stored as “1” in the RAM 203 in the step S3320, thus the determination in the step S3321 is “YES”. Further, when the multimode is selected, the number of participable players is set to “4” in the step S3319, and the number of registered participants for the mission is stored as “1” in the RAM 203 in the step S3320, thus the determination in the step S3321 is “NO”. The processing of the step S3320 is repeated thereafter, and when the number of registered participants for the mission is “4”, the determination in the step S3321 is

It should be noted that, in the embodiment related to the second invention, the CPU 101 functions as the determination means for determining whether or not the number of entries (the number of registered participants), which is stored in the RAM 203 functioning as the entry number storing means, reaches the number of players (the number of participable players), which is set by the CPU 201 functioning as the player number setting means.

When it is determined in the step S3321 that the number of registered participants is not the same as the number of participable players, the CPU 201 of the arcade server 2 transmits a standby image display command containing the data related to the number of registered participants and to the number of participable players to the terminal device 1 in the process of participation registration (step S3322). This processing corresponds to the processing of the step S1319 of FIG. 18, where a standby image (see FIG. 21C) is displayed on the first display 11 of the terminal device 1 which receives the standby image display command (FIG. 18, step S1320). Thereafter the sub routine ends.

It should be noted that, in the embodiment related to the second invention, the first display 11 of the terminal device 1 functions as the standby image displaying means for displaying a standby image which shows information related to the number of players and the number of entries

On the other hand, when it is determined in the step S3321 that the number of registered participants is the same as the number of participable players, the CPU 201 of the arcade server 2 updates the data for the player information on the column for mission (see FIG. 14), the player information being stored in the RAM 203, and allows the player, who is in the process of participation registration, to set the mission (step S3323). At this time the CPU 201 functions as the condition setting means for setting a mission (condition in a game) for the player to perform a processing for setting the condition selected by the CPU 201 which functions as the condition selecting means. Next, the CPU 201 transmits a notice signal indicating that the mission is set to the terminal device 1 in the process of participation registration (step S3324). This processing corresponds to the processing of the step S1321 of FIG. 18, where an image (see FIG. 21D) showing that the mission is set is displayed on the first display 11 of the terminal device 1 which receives the notice signal (FIG. 18, step S1322). Thereafter the sub routine ends. It should be noted that, in the embodiment related to the second invention, the CPU 201 functions as the condition setting means for, when the CPU 201 as the determination means determines that the number of entries reaches the number of players, setting a mission for the player who performs the play.

FIG. 22 is a flow chart showing a notice board use processing which is called up in the step S133 of the flow chart shown in FIG. 16 and is executed by the terminal device 1, and a processing executed by the arcade server 2 in accordance with the abovementioned processing. FIG. 23 is a figure showing an example of a message list which is used when the processing of the step S1334 on the flow chart shown in FIG. 22 is performed.

First, the CPU 101 of the terminal device 1 transmits request signal for requesting an inputted message to the arcade server 2 (step S1330). Once the arcade server 2 receives this request signal, the arcade server 2 transmits a message which is already inputted by the terminal device 1 and stored in the RAM 203 (inputted message), to the terminal device 1 which is the source of the request signal (step S3330).

Once the terminal device 1 receives the inputted message from the arcade server 2, the terminal device 1 displays an image showing the inputted message shown in FIG. 24A on the first display 11 by means of the first rendering process portion 111 (step S1331).

FIG. 24A is a figure showing an example of an image displayed on the first display 11 of the terminal device 1 when the processing of the step S1331 of FIG. 22 is executed. An image such as “guild” which shows the current location of the character is disposed on the upper left of the screen, and an image such as “notice board” is disposed on the upper right of the screen. An image for showing an option such as new input” is disposed on the right side. “New input” is not for inputting a message for the message of other player, but is an option used when inputting a new message. The player uses the touch panel 14 to touch the image of “new input”, and thereby can input an instruction for inputting a new message.

An inputted message which is inputted by each player is displayed in the center of the screen. For example, an image, “a—‘I am a. Nice to meet you’”, indicates a message, “I am a. Nice to meet you,” inputted by the player “a”. Further, an image for showing an option such as “comment” is disposed on the right side. “Comment” is not for inputting a new message, but is an option used when inputting a message to the message of the other player. The player uses the touch panel 14 to touch the image of “comment”, and thereby can input an instruction for inputting a message to the other player. Moreover, an image disposed right below the abovementioned message, such as “d—‘I am d. Nice to meet you’”, indicates a message, “I am d. Nice to meet you,” inputted by the player “d” in response to the message of the player “a”. An image such as “b—‘Would like to start an adventure with me?’”, and an image such as “c—‘Would like to start an adventure with me?’” are disposed on the lower side of the message of the player “d”. These are messages inputted by the player “b” and “c” to look for a player who can participate in the mission together.

After the processing of the step S1331, the CPU 101 determines whether or not an instruction for inputting a message is inputted (step S1332). The player can input the instruction for inputting a message by touching the image of “new input” or “comment” by means of the touch panel 14.

When it is determined in the step S1332 that the instruction for inputting a message is inputted, the CPU 101 of the terminal device 1 transmits a request signal for requesting a message list to the arcade server 2 (step S1334). The CPU 201 of the arcade server 2 receiving this request signal extracts the message list stored in the ROM 202, and transmits it to the terminal device 1 which is the source of the request signal (step S3331).

FIG. 23 is a figure showing an example of the message list. Message numbers are stored on the left column, and messages corresponding to the respective numbers are stored on the right column. For example, a message, “I am ‘a (name of a player)’. Nice to meet you”, is related to the number “001”. Further, a message “Would you like to start an adventure with me?”, is related to the number “002”. Furthermore, a message “Let's start an adventure together”, is related to the number “003”. Although not shown in the figure, a lot of other messages are stored in this message list.

The CPU 101 of the terminal device 1 which receives the message list from the arcade server 2 controls the first rendering process portion 111 on the basis of the message list, and performs a processing for displaying, on the first display 11, a message option in which any one message can be selected out of a plurality of messages (step S1335).

FIG. 24B is an image displayed on the first display 11 when the player “a” uses the touch panel 14 to input an instruction for inputting a message to a message of the player “b”, when the image shown in FIG. 24A is displayed on the first display 11. An image such as “guild” which shows the current location of the character is disposed on the upper left of the screen, and an image such as “notice board” is disposed on the upper right of the screen. There is disposed on the lower side thereof an image showing a message of the player “b” to which the player “a” inputs a message. Moreover, on the lower side of the image showing the message of the player “b”, a message list in which a plurality of options showing messages are listed vertically. When the image shown in FIG. 24B is displayed, the player uses the touch panel 14 to touch the image representing a message that the player wishes to input, and thereby can input an instruction for transmitting the message to the arcade server 2.

After the processing of the step S1335, the CPU 101 determines whether or not an instruction for selecting a message is inputted (step S1336). This instruction can be inputted by touching any one option of the plurality of options showing message by means of the touch panel 14, when the image shown in FIG. 24B is displayed on the first display 11.

When it is determined in the step S1336 that the instruction for selecting a message is inputted, the CPU 101 transmits the message to the arcade server 2 via the dedicated line 5 by means of the communication interface circuit 104 (step S1337). On the other hand, once receiving the message from the terminal device 1, the CPU 201 of the arcade server 2 causes the RAM 203 to store the message (step S3332). Here, the message stored in the RAM 203 is exchanged between the terminal device 1 and the arcade server 2 in the abovementioned step S1330, S1331, or S3330, and becomes a message displayed on the first display 11 of the terminal device 1, in other words, the inputted message.

The CPU 101 of the terminal device 1 thereafter determines whether to end the notice board use processing (step S1338). The notice board use processing ends when the player uses the touch panel 14 to input an instruction for returning the processing to the sub routine of FIG. 16 after ending this processing. When it is determined in the step S1338 to end the notice board use processing, the sub routine ends. On the other hand, when it is determined not to end the notice board use processing, the processing is returned to the step S1330. Then, the CPU 101 again transmits the request signal for requesting the inputted message (step S1330). The arcade server 2 receiving the request signal transmits the inputted message to the terminal device 1 (step S3330). The terminal device 1 receiving the inputted message from the arcade server 2 then displays the inputted message on the first display 11 (step S1331).

FIG. 24C is an image displayed on the first display 11 of the terminal device 1 when the player uses the touch panel 14 to touch an image of “let's start an adventure together”, when the image shown in FIG. 24B is displayed on the first display 11. Unlike the image shown in FIG. 24A, the image shown in FIG. 24C is displayed with an additional message of “let's start an adventure together”, which is inputted by the player “a” to the message of the player “b”.

FIG. 25A is a flow chart for the embodiment related to the first invention, and FIG. 25B is a flow chart for the embodiment related to the second invention. Each of the flow charts shows a reward payment processing which is called up in the step S135 of the flow chart shown in FIG. 16 and is executed by the terminal device 1, and a processing executed by the arcade server 2 in accordance with the abovementioned processing. First of all, in FIG. 25A, the CPU 101 of the terminal device 1 transmits a reward payment request signal to the arcade server 2 (step S1350). Once receiving the reward payment request signal from the terminal device 1, the CPU 201 of the arcade server 2 uses the player information stored in the RAM 203 (see FIG. 14) to determine whether or not the player clears the mission (step S3350). At this time the CPU 201 functions as the condition achievement determination means for determining whether or not a player clears a condition (mission). When it is determined in the step S3350 that the player clears the mission, the CPU 201 of the arcade server 2 refers to a reward determination table to determine the amount of reward, based on the type of the cleared mission, the level value of the player, and the form of mission acceptance (the number of participants in the mission) (step S3351).

In FIG. 25B for explaining the embodiment related to the second invention, when it is determined in the step S3350 that the player clears the mission, the CPU 201 of the arcade server 2 refers to a reward determination table to determine the amount of reward, based on the cleared mission (step S3351). At this time the amount of available money in the game, which is paid out in accordance with the type of the mission, is determined.

FIG. 26A(a) is a figure showing an example of the reward determination table for a mission “AA” in the embodiment related to the first invention. This reward determination table is stored in the ROM 202 of the arcade server 2 as data. It should be noted that the reward determination table for the mission “AA” is taken as an example here, but the reward determination table for other mission is also stored in the ROM 202 as data.

In the reward determination table shown in FIG. 26A(a), the amount of reward is related to the combination of the level value of the player (character corresponding to the player) and the form of mission acceptance (the number of participants to a mission). For example, if the level value of the player is 1 and the form of mission acceptance is the single mode, the amount of reward is 100.

Further, in the reward determination table shown in FIG. 26A(a), even if the same mission (the mission “AA” here) is cleared, the higher the level value of the player, the higher the amount of reward. For example, if the form of mission acceptance is the single mode, the amount of reward increases such as 100, 120, 140 and the like, as the level value of the player increases such as 1, 2, 3, and the like.

Therefore, when the amount of reward is determined in reference to the reward determination table shown in FIG. 26A(a), even in the case of a mission with low degree of difficulty, if the level value of the player is high, the player can obtain a large amount of reward as a game result, in comparison with a player having a low level value.

It should be noted that in the embodiment related to the first invention, the amount of reward may be determined in reference to the reward determination table shown in FIG. 26A(b), for example, instead of the reward determination table shown in FIG. 26A(a). FIG. 26A(b) is a figure showing another example of the reward determination table for the mission “AA” in the embodiment related to the first invention.

In the reward determination table shown in FIG. 26A(b), the amount of reward is related to the combination of the level value of the player (character corresponding to the player) and the form of mission acceptance (the number of participants to a mission), as in the case of FIG. 26A(a). However, the amount of reward related is different from that of the reward determination table shown in FIG. 26A(a). Specifically, in the reward determination table shown in FIG. 26A(b), the higher the level value of the player, the lower the amount of reward, even if the same mission (here, the mission “AA”) is cleared. For example, if the form of mission acceptance is the single mode, the amount of reward decreases such as 300, 280, 260, and the like, as the level value of the player increases such as 1, 2, 3, and the like.

Therefore, when the amount of reward is determined in reference to the reward determination table shown in FIG. 26A(b), even if the same mission is cleared, if the level value of the player is high, the player obtains only a small amount of reward as a game result, in comparison with a player having a low level value.

FIG. 26B is a figure showing an example of the reward determination table in the embodiment related to the second invention. Mission codes comprising two-digit symbols are stored in the left column of the reward determination table, and amount of rewards corresponding to the mission codes are stored in the right column of the same. For example, the amount of reward corresponding to the mission “AA” is 100, and the amount of reward corresponding to the mission “AB” is 300.

When executing the processing of the step S3351, when the CPU 201 functioning as the condition achievement determination means determines that the player clears a condition, the CPU 201 of the arcade server 2 functions as the game result determination means for determining the amount of money available in a game, which is granted to the player as a game result, on the basis of the condition cleared by the player, and on the basis of the level value of the player which is stored in the RAM 203 which functions as the level value storing means.

After the processing of the step S3351, the CPU 201 updates the player information stored in the RAM 203 (see FIG. 14) (step S3354). Specifically, the data in the column for the mission is cleared, and the amount of money is increased by the amount of reward. The CPU 101 of the terminal device 1 synchronize the player information updated in the arcade server 2 to update the player information (step S1351).

In the embodiment related to the second invention, after the processing of the step S3351, the CPU 201 refers to the player information stored in the RAM 203 (see FIG. 14), and determines whether or not the player clears the mission in the multimode (step S3352). When it is determined that the mission is cleared in the multimode, the amount of reward determined in the step S3351 is distributed proportionally in accordance with the number of participants in the mission (step S3353). For example, when four players participate in the mission “AA”, the amount of reward is 25.

In the step S3352, when it is determined that the player clears the mission in the single mode instead of the multimode, or when the processing of the step S3353 is executed, the CPU 201 updates the player information stored in the RAM 203 (see FIG. 14) (step S3354). Specifically, the data in the column for the mission is cleared, and the amount of money is increased by the amount of reward. The CPU 101 of the terminal device 1 synchronize the player information updated in the arcade server 2 to update the player information (step S1351). When executing the processings of the steps S3353 through S3354, the CPU 201 functions as the reward payout means for, when the CPU 201 functioning as the condition achievement determination means determines that the player clears a mission, proportionally distributing the amount of money available in a game, which is set in advance in accordance with the type of the mission, in accordance with the number of players who clear the mission, and grants the money to the each player.

Moreover, the embodiment related to the second invention explains the game in which the amount of reward for clearing a mission is proportionally distributed in accordance with the number of participating players in the mission. However, the present invention is not limited to this example. For example the amount of reward for clearing a mission may be proportionally distributed each player in accordance with the level of the players who participate in the mission. In this case, if a player in a level 1 and a player in a level 2 clear a mission where the amount of reward is 300, for example, the amount of reward that the player at the level 1 can acquire is 100, and the amount of reward that the player at the level 2 can acquire is 200.

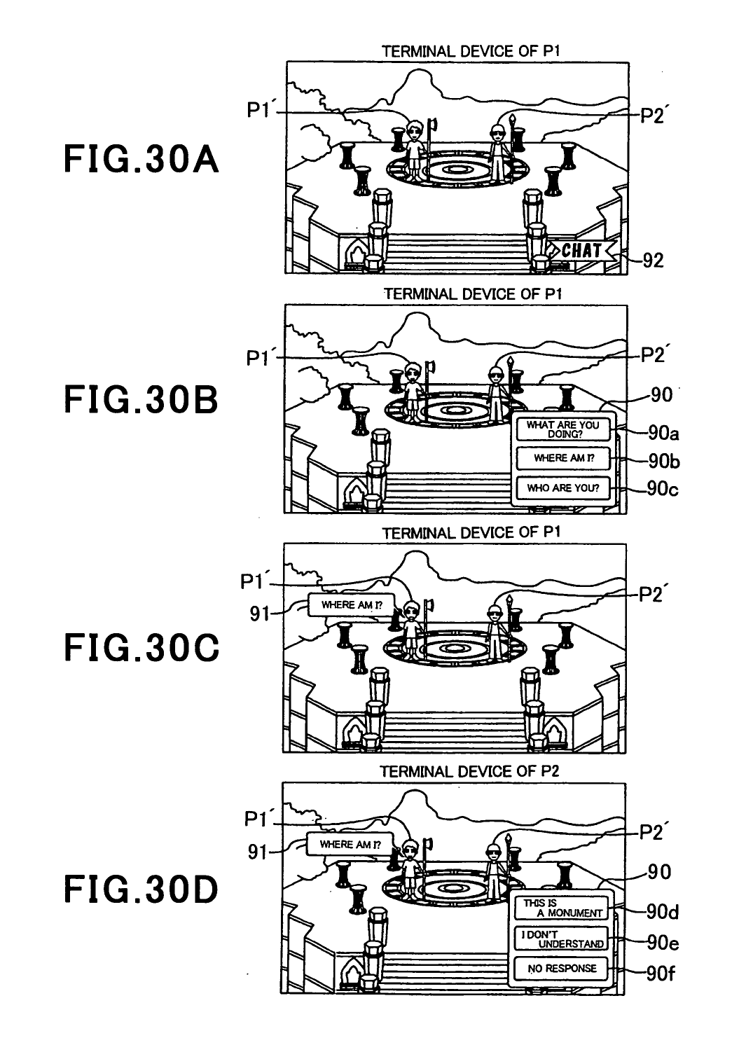

A mission game is now described next. FIG. 27 is a flow chart showing a routine of a mission game execution processing which is called up in the step S121 of the flow chart shown in FIG. 15 and is executed by the terminal device 1. FIG. 28 is a flow chart showing a processing executed by the arcade server 2 in accordance with the sub routine shown in FIG. 27, which is executed by the terminal device 1. FIG. 29 is a figure showing an example of a chat message list. FIG. 30 is a figure showing an example of an image which is displayed on the first display 11 of the terminal device 1 by executing the processings shown in FIG. 27 and FIG. 28.

First, the CPU 101 of the terminal device 1 determines whether or not an operation instruction for a character is inputted (step S150). The player can input the operation instruction for a character by operating the various buttons 118 or the operation lever 119. When the operation instruction for a character is inputted, the CPU 101 transmits an operation command to the arcade server 2 (step S151). This processing corresponds to a step S330 in FIG. 28.

In the step S150, when it is determined that the operation instruction for a character is not inputted, or when the processing of the step S151 is executed, the CPU 101 determines whether or not the player information is received from the arcade server 2 (step S152). This processing corresponds to a step S332 of FIG. 28. When it is determined that the player information is received, the CPU 101 updates the player information stored in the RAM 103 on the basis of the abovementioned player information (step S153).

In the step S152, when it is determined that the player information is not received from the arcade server 2, or when the processing of the step S153 is executed, the CPU 101 determines whether or not a display command is received from the arcade server 2 (step S154). This processing corresponds to a step S333, S335, S338, or S341 in FIG. 28.

When it is determined in the step S154 that the display command is received, the CPU 101 executes the image display processing for the first display 11 or the second display 12 (step S155). In this processing, the CPU 101 supplies the display command to the first rendering process portion 111 or the second rendering process portion 112. The first rendering process portion 111 refers to the player information stored in the RAM 103 (see FIG. 14) according to the abovementioned display command, and extracts the image data from the ROM 102. Then, by storing the video data in the video RAM in accordance with the order of priority displayed on the first display 11 (in the order of a background image, monster image, and character image, for example), the first rendering process portion 111 generates a game image, and outputs it to the first display 11. As a result, the game image is displayed on the first display 11.

Also, when displaying the game image three dimensionally, the first rendering process portion 111 performs calculation for converting the object (for example, an object configuring a character or monster, and the like) stored in the ROM 102 from a position on the three dimensional space to a position on a pseudo three dimensional space, light source calculation processing, and the like, as well as a write processing of the image data (for example, mapping of the texture data for the region of the video RAM specified with a polygon) to be rendered to the video RAM on the basis of the results of the above calculations, thereby generating the game image, and outputs it to the first display 11. As a result, the three-dimensional game image is displayed on the first display 11. The second rendering process portion 112 extracts a predetermined image from the ROM 102 in accordance with the abovementioned display command. Then, by storing the video data in the video RAM in accordance with the order of priority displayed on the second display 12, the second rendering process portion 112 generates a predetermined image, and outputs it to the second display 12. As a result, the predetermined image is displayed on the second display 12.

In the step S154, when the display command for displaying the game image is received from the arcade server 2 (FIG. 28, step S333), the processing of the step S155 is performed, whereby the game image is displayed in the first display 11 (see FIG. 30A). The image shown in FIG. 30A is displayed on the first display 11 of the terminal device 1 operated by a player “P1”, and a character image P1′ corresponding to the player “P1” and a character image P2′ corresponding to a player “P2” are disposed.

Furthermore, in the step S154, when the display command for displaying a chat button is received from the arcade server 2 (FIG. 28, step S335), the processing of the step S155 is performed, whereby a chat button 92 is displayed on the first display 11 (see FIG. 30A). A chat button 92 such as “CHAT” is disposed on the lower right of the image shown in FIG. 30A. The player inputs an instruction for performing chatting by touching the chat button 92 by means of the touch panel 14.

In the step S154, when the display command for displaying the chat window is received from the arcade server 2 (FIG. 28, step S338), the processing of the step S155 is performed, whereby a chat window 90 having three chat messages 90a to 90c is displayed on the first display 11 (see FIG. 30B). The chat window 90 having the three chat messages 90a to 90c such as “What are you doing?”, “Where am I?”, and “Who are you?” respectively is disposed on the lower right of the image shown in FIG. 30B. The player can select a chat message that the player wishes to transmit by touching any one of the chat messages by means of the touch panel 14. Thereafter the player “P1” transmits the selected chat message to the terminal device 1 of the player “P2” by touching the character image P2′ corresponding to the player “P2” by means of the touch panel 14.

In the step S154, when the display command for displaying a chat message is received from the arcade server 2 (FIG. 28, step S341), the processing of the step S155 is performed, whereby a chat message 91 is displayed on the first display 11 (see FIGS. 30C and 30D). The image shown in FIG. 30C is the first display 11 of the terminal device 1 operated by the player “P1” when the chat message 90b is selected by means of the touch panel 14 when the image shown in FIG. 30B is displayed. The chat message 91 such as “Where am I?” is displayed in the vicinity of the character image P1′ corresponding to the player “P1”. Here, the image shown in FIG. 30D is displayed on the first display 11 of the terminal device 1 which is the destination of the chat message and is operated by the player “P2”. The chat message 91 such as “Where am I?” is displayed in the vicinity of the character image P1′ corresponding to the player “P1”. Further, the chat window 90 having three chat messages 90d to 90f such as “This is a monument”, “I don't understand”, and “No response” respectively is displayed on the lower right of the screen.

In the step S154, when it is determined that the display command is not received, or when the processing of the step S155 is executed, the CPU 101 determines whether or not an instruction for performing chatting is inputted (step S156). The player can input this instruction by touching the chat button 92 by means of the touch panel 14. When it is determined that the instruction for performing chatting is inputted, the CPU 101 transmits a chat execution command to the arcade server 2 (step S157). This processing corresponds to a step S336 of FIG. 28.

In the step S156, when it is determined that the instruction for performing chatting is not inputted, or when the processing of the step S157 is executed, the CPU 101 determines whether or not an instruction for selecting a chat message is inputted (step S158). The player can input this instruction by touching any one of the chat messages 90a to 90c included in the chat window 90, by means of the touch panel 14.

When it is determined in the step S158 that the instruction for selecting a chat message is inputted, the CPU 101 stores the selected chat message in the RAM 103 (step S159). In the step S158, when it is determined that the instruction for selecting a chat message is not inputted, or when the processing of the step S159 is executed, the CPU 101 determines whether or not an instruction for selecting a character as the destination of a chat message is inputted (step S160). The player can input this instruction by touching the character image P2′ by means of the touch panel 14.

When it is determined in the step S160 that the instruction for selecting a destination character is inputted, the CPU 101 stores destination data indicating the terminal device 1 which is the destination of a chat message in the RAM 103 (step S161). The CPU 101 then transmits the chat message stored in the RAM 103 and the destination data to the arcade server 2 (step S162).

In the step S160, when it is determined that the instruction for selecting a destination character is not inputted, or when the processing of the step S162 is executed, the CPU 101 refers to the player information stored in the RAM 103 (see FIG. 14), and determines whether or not a predetermined condition for mission termination is satisfied (step S163). The condition for mission termination includes, for example, clearing a mission, returning to the guild, and reaching zero survival ability, and the like.

When it is determined that the mission game is not ended, the processing is moved to the step S150. On the other hand, when it is determined that the mission game is ended, the sub routine ends.

The processing of the arcade server 2 is explained. First, the CPU 201 determines whether or not an operation command is received from the terminal device 1 (step S330). When it is determined that the operation command is received, the CPU 201 updates the player information stored in the RAM 203 in accordance with the operation command (step S331), and transmits the player information to the terminal device 1 (step S332). This processing corresponds to the step S152 of FIG. 27.

The CPU 201 then transmits a display command for displaying a game image on the first display 11 of the terminal device 1 to the terminal device 1 on the basis of the player information (step S333). This processing corresponds to the step S154 of FIG. 27.

In the step S330, when it is determined that the operation command is not received, or when the processing of the step S333 is executed, the CPU 201 refers to the player information, and determines whether or not a game image displayed on the first display 11 of the terminal device 1 includes other character (step S334). When it is determined that other character is included, the CPU 201 transmits a display command for displaying a chat button to the arcade server 2 (step S335). This processing corresponds to the step S154 of FIG. 27.

In the step S334, when it is determined that the same game image does not include other character, or when the processing of the step S335 is executed, the CPU 201 determines whether or not a chat execution command is received (step S336). This processing corresponds to the step S157 of FIG. 27. When it is determined that the chat execution command is received, the CPU 201 selects a predetermined number of chat messages (three, for example) from the chat message list stored in the ROM 202.

FIG. 29 is a figure showing an example of a chat message list. A four-digit number for identifying a chat message, and a chat message corresponding to the number are stored in the leftmost column. These indicate a first message. The column on the right side thereof has stored therein three first response messages with respect to one first message. Furthermore, the column on the right side thereof has stored therein three second response messages with respect to one first response message. The first message is a message which is displayed on the first display 11 of the terminal device 1 into which the instruction for performing chatting is inputted by touching the chat button 92 using the touch panel 14 (see FIG. 30B). The first response message is a message displayed on the first display 11 of the terminal device 1 which receives the first message (see FIG. 30D). The second response message is, although not shown, a message displayed on the first display 11 of the terminal device 1 which receives the first response message.

After executing the processing of the step S337, the CPU 201 transmits a display command for displaying a chat window having the chat message selected in the step S337 to the terminal device 1 (step S338). This processing corresponds to the step S154 of FIG. 27.

In the step S336, when it is determined that the chat execution command is not received, or when the processing of the step S338 is executed, the CPU 201 determines whether or not the chat message and the destination data are received (step S339). This processing corresponds to the step S162 of FIG. 27. When it is determined in the step S339 that the chat message and the destination data are received, the CPU 201 specifies the terminal device 1, which is the destination of the chat message, on the basis of the destination data (step S340), and transmits the display command for displaying the chat message to the terminal device 1 which is the destination (step S341). This processing corresponds to the step S154 of FIG. 27.

Next, the CPU 201 refers to the player information stored in the RAM 203 (see FIG. 14), and determines whether or not the predetermined condition for mission termination is satisfied (step S342). When it is determined that the predetermined condition for mission termination is not satisfied, the processing is returned to the step S330, and when it is determined that the predetermined condition for mission termination is satisfied, the sub routine ends.

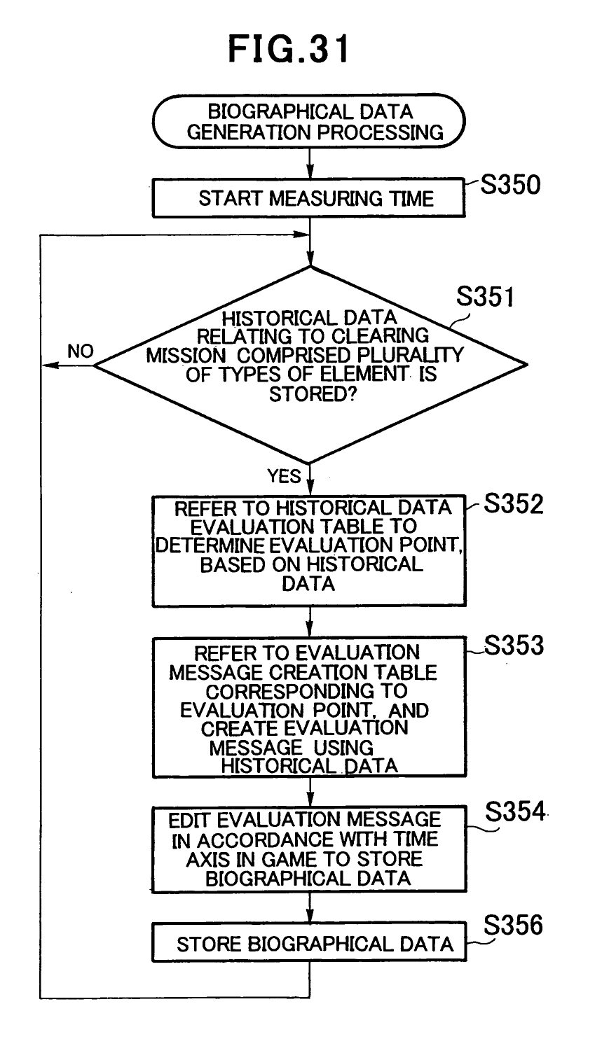

FIG. 31 is a flow chart showing a biographical data generation processing which is executed by the center server 3. This processing is executed when a game related to the present embodiment is started. First of all, the CPU 301 starts a timing processing for measuring a time elapsed since the game related to the present embodiment is started (step S350). This processing may include setting a timer in the RAM 303 to measure an elapsed time by performing an interruption processing or the like at a predetermined cycle to count up the timer value stored in the RAM 303, or providing a timer in the control portion 300. The time axis in the game is configured by the elapsed time measured by the center server 3. It should be noted that the current time may be acquired through the Internet at a predetermined cycle, instead of performing the processing of the step S350.

Next, the CPU 301 determines whether or not the RAM 303 has stored therein the historical data comprising a plurality of types of elements related to clearing a mission (see FIG. 13B) (step S351). It should be noted that when the terminal device 1 executes the processing of the step S123 of the sub routine shown in FIG. 15, the game history related to the player who operates the terminal device 1 is transmitted from the arcade server 2 to the center server 3, and the game history is stored in the RAM 303. The step S351 is performed to determine whether or not game history comprising a plurality of types of elements related to clearing a mission exists in the game history newly stored in the RAM 303. It should be noted that in the embodiment related to the second invention, when the terminal device 1 executes the processing of the step S123 of the sub routine shown in FIG. 15, the historical data is transmitted from the terminal device 1 to the center server 3, and the historical data is stored in the RAM 303. The step S351 is performed to determine whether or not the historical data comprising a plurality of types of elements related to clearing a mission exists in the historical data which is newly stored in the RAM 303.

The CPU 301 then refers to the historical data evaluation table stored in the ROM 302 on the basis of the historical data stored in the RAM 303 (see FIG. 13B), and determines an evaluation point (step S352). FIG. 32 is a figure showing an example of the historical data evaluation table. In the historical data evaluation table, en element of a game history is related to an evaluation point for each mission. For example, in the case of the mission “AA”, the evaluation point is 1 if the level (level value) at that time is 3 or lower, and the evaluation point is 0 if the level (level value) is above 3. Therefore, the evaluation is high if a mission is cleared on a low level (level value). Further, the evaluation point is 1 if the time required is within an hour, and the evaluation point is 0 if the time required exceeds one hour. Therefore, the evaluation is high if a mission is cleared in a short period of time. Also, the evaluation point is 1 if the number of participants in a mission is 1, and the evaluation point is 0 if the number of participants exceeds 1 (two or more). Therefore, the evaluation is high if selecting a single mission, instead of multi-missions.

It should be noted that when the historical data evaluation table shown in FIG. 32 is referred to on the basis of the game historical data shown in FIG. 13B, the evaluation point for the mission “AA” of the player “d” is 2, the evaluation point for the mission “AB” is 1, and the evaluation point for the mission “AC” is 2.

After the processing of the step S352, the CPU 301 refers to the evaluation message creation table in accordance with the evaluation point, and creates an evaluation message by using the game history (historical data) stored in the RAM 303 (step S353). FIG. 33 is a figure showing an example of the evaluation message creation table. In the evaluation message creation table, an evaluation message in the case where the evaluation point is 2 or more, and an evaluation message in the case where the evaluation point is less than 2 are stored for each mission. Each evaluation message has columns for entering an element of the game history, and columns for a fixed phrase, and these columns are arranged alternately. By inserting an element of the game history into each column, an evaluation message can be created.

When creating an evaluation message with reference to the evaluation message creation table shown in FIG. 33 by using the game history data shown in FIG. 13B, the following message can be obtained. Specifically, since the evaluation point for the mission “AA” of the player “d” is 2, the evaluation message is “‘d’ has delivered a package excellently to XX ‘by himself’ in ‘two hours’ at the time of ‘level (level value) 2’”, which shows a good evaluation. Furthermore, since the evaluation point for the mission “AB” of the player “d” is 1, the evaluation message is “It took ‘two hours’ for ‘d’ at the time of ‘level (level value) 11’ to strike down the monster ΔΔ to protect the Princess ●● by ‘three people’”, which is a bad evaluation.

After the processing of the step S353, the CPU 301 edits the evaluation message created in the step S353, in accordance with the time axis in the game, and generates biographical data (step S354). For example, in a step S353, when creating evaluation messages for the mission “AA” to “AE” shown in FIG. 13B, these evaluation messages are edited in accordance with the time axis in the game in the step S354, thus the evaluation messages are listed in the order of the missions “AA”, “AC”, “AD”, “AE”, and “AB”. Next, the CPU 301 stores the biographical data in the RAM 303 (step S356), and returns the processing to the step S351.

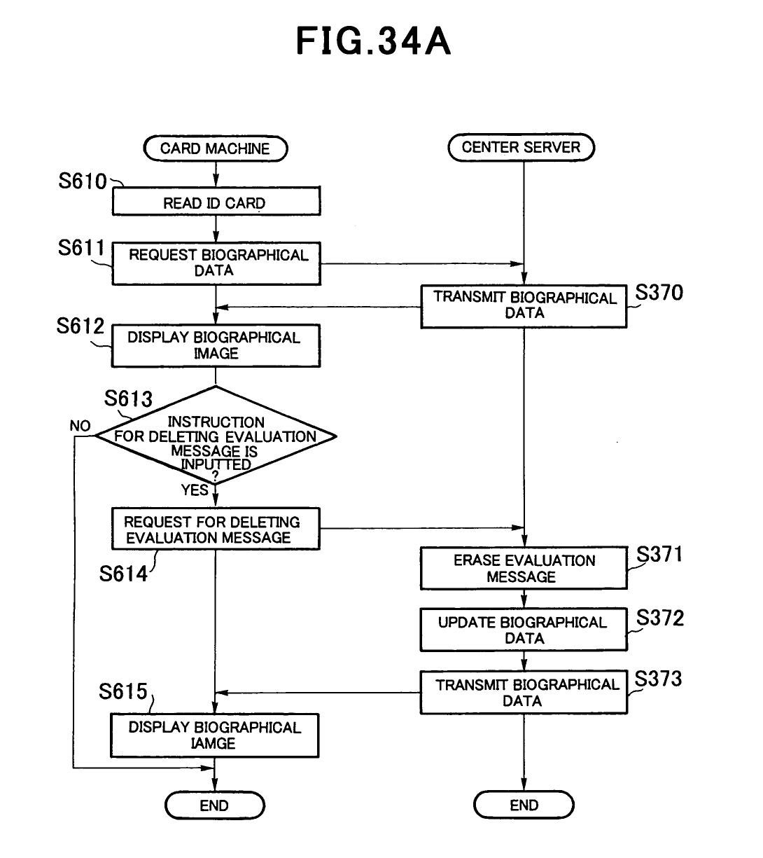

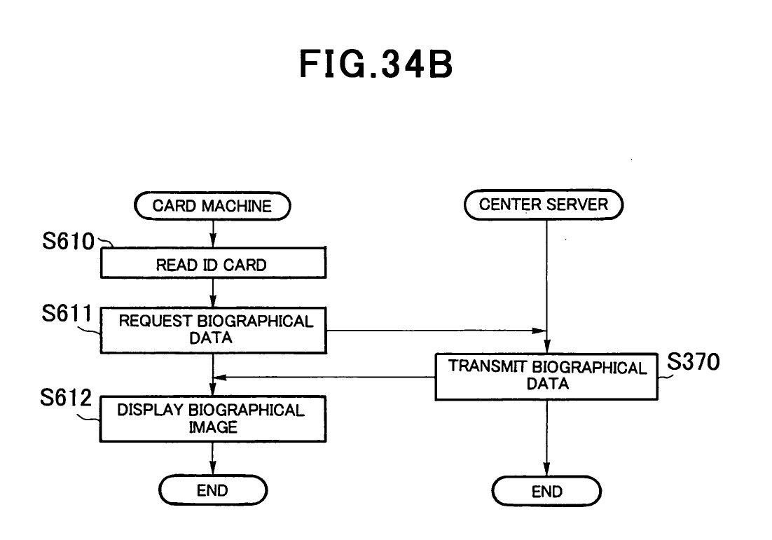

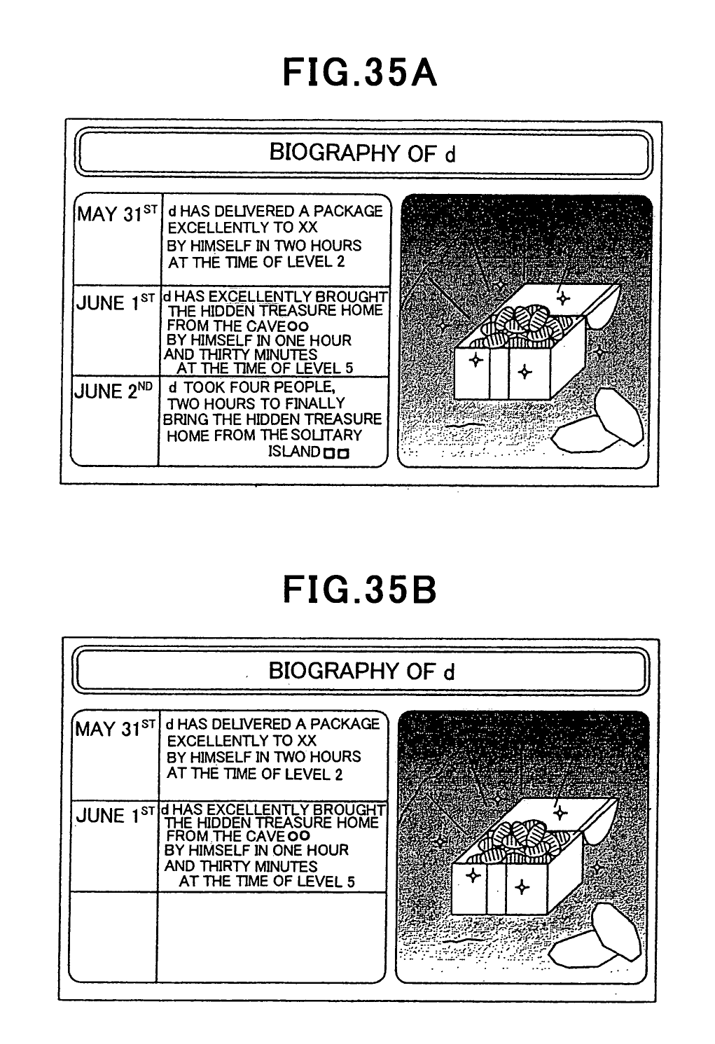

FIG. 34A is a flow chart showing a processing which is executed by the card machine 6 and center server 3 when displaying a biographical image, in the embodiment related to the first invention. FIG. 35 is a figure showing an example of a biographical image displayed on a display 61 of the card machine 6 when the processing shown in FIG. 34A is executed. First, the CPU 601 reads out the ID data of the player from the ID card 8 by means of the ID card reader 616 (step S610). The CPU 601 which reads out the ID data from the ID card 8 using the ID card reader 616 transmits a request signal for requesting the biographical data corresponding to the ID data to the center server 3 through the arcade server 2 via the dedicated line 5 by means of the communication interface circuit 604 (step S611). Once receiving the request signal, the CPU 301 of the center server 3 extracts the biographical data corresponding to the ID data from the biographical data stored in the RAM 303 (biographical data which is stored in the RAM 303 in the step S356 of FIG. 31), and transmits this biographical data to the card machine 6 which is the source of the request signal (step S370). Further, the CPU 301 may extract the image data showing the detail of the biographical data from the ROM 302, along with the biographical data, and transmits this image data along with the biographical data.

The CPU 601 of the card machine 6, which receives the abovementioned biographical data from the center server 3, display a biographical image as shown in FIG. 35A on the display 61 by means of the rendering process portion 611 on the basis of the abovementioned biographical data (step S612).

FIG. 35A is a figure showing an example of the biographical image displayed on the display 61 of the card machine 6 when the processing shown in FIG. 34A is executed. An image such as “biography of d” is disposed on the upper side of the screen. A biographical image showing the biographical data in the form of a drawing is disposed on the left side of the screen. Specifically, an evaluation message related to clearing a mission, and the date when the mission is cleared are related to each other and disposed. The two evaluation messages from the top show a good evaluation, and the bottom evaluation message shows a bad evaluation. Also, an image showing the detail of the biographical data is disposed on the right side of the screen.

Next, it is determined whether or not an instruction for deleting an evaluation message is inputted by an operation of the player (step S613). The player can input this instruction by operating the operation button 618 of the card machine 6. When it is determined that the instruction for deleting an evaluation message is not inputted, the sub routine ends.

On the other hand, when it is determined that the instruction for deleting an evaluation message is inputted, the CPU 601 transmits a request signal for requesting deletion of an evaluation message to the center server 3 (step S614). Once receiving the request signal, the CPU 301 of the center server 3 performs a processing for erasing an evaluation message from the RAM 303 on the basis of the request signal (step S371). Next, the CPU 301 updates the biographical data stored in the RAM 303 based on a result of the processing of the step S371 (step S372), and transmits the updated biographical data to the card machine 6 (step S373). The CPU 601 of the card machine 6 which receives the updated biographical data from the center server 3 displays the biographical image as shown in FIG. 35B on the display 61 using the rendering process portion 611, on the basis of the abovementioned biographical data (step S615).

FIG. 35B is a biographical image displayed on the display 61 when the instruction for deleting an evaluation message on the bottom (evaluation message showing a bad evaluation) is inputted during the biographical image of FIG. 35A is displayed on the display 61 of the card machine 6, wherein the evaluation message on the bottom is deleted.

FIG. 34B is a flow chart showing a processing which is executed by the card machine 6 and center server 3 when displaying a biographical image, in the embodiment related to the second invention. First, the CPU 601 reads out the ID data of the player from the ID card 8 by means of the ID card reader 616 (step S610). The CPU 601 which reads out the ID data from the ID card 8 using the ID card reader 616 transmits a request signal for requesting the biographical data corresponding to the ID data to the center server 3 through the arcade server 2 via the dedicated line 5 by means of the communication interface circuit 604 (step S611). Once receiving the request signal, the CPU 301 of the center server 3 extracts the biographical data corresponding to the ID data from the biographical data stored in the RAM 303 (biographical data which is stored in the RAM 303 in the step S356 of FIG. 31), and transmits this biographical data to the card machine 6 which is the source of the request signal (step S370). Further, the CPU 301 may extract the image data showing the detail of the biographical data from the ROM 302, along with the biographical data, and transmit this image data along with the biographical data.

The card machine 6, which receives the abovementioned biographical data from the center server 3, displays a biographical image as shown in FIG. 35A on the display 61 by means of the rendering process portion 611 on the basis of the abovementioned biographical data (step S612), and ends the sub routine.

FIG. 35A is a figure showing an example of the biographical image displayed on the display 61 of the card machine 6 when the processing shown in FIG. 34B is executed. An image such as “biography of d” is disposed on the upper side of the screen. A biographical image showing the biographical data in the form of a drawing is disposed on the left side of the screen. Specifically, an evaluation message related to clearing a mission, and the date when the mission is cleared are related to each other and disposed. Also, an image showing the detail of the biographical data is disposed on the right side of the screen.

As described above, the game system related to the first invention can be designed such that a game result is determined based on a condition cleared by a player and on the level value of the player. Thus, for example, even in case of a condition with low degree of difficulty, if the level value of the player is high, the player can obtain a large amount of reward as a game result, in comparison with a player having a low level value (see FIG. 26A(a)). Moreover, for example, the game system can be designed such that even if the same condition is cleared, if the level value of a player is high, the player obtains only a small amount of reward as a game result, in comparison with a player having a low level value (see FIG. 26A(b)). Therefore, the present invention can achieve an effect allowing that the fascinating aspect of the game itself can be extended in various ways.

When the amount of reward is determined in reference to the reward determination table shown in FIG. 26A(a), the player who enthusiastically plays a game can acquire a reward in accordance with his own level value, and can gain an advantage over the abovementioned other player. As a result, it is possible to prevent the competitive spirits of both players from being reduced. Further, even in the case of a condition with low degree of difficulty, if the player has a high level value, he can obtain a large amount of reward in comparison with a player having a low level value even if they clear the same condition. Therefore, it is possible to create an environment which proves that the way of carrying out a game where conditions are challenged in the order of low degree of difficulty to high degree of difficulty is not necessarily the desirable way of carrying out a game. Consequently, diversification can be generated in the ways of carrying out a game, whereby a strategic, complicated, and yet interesting game can be provided.

The embodiment related to the first invention explains the case in which the game result determination means determines the amount of money available in a game, which is granted to a player as a game result. However, the present invention is not limited to this example. For example, the game result determination means may determine an item to be granted to a player, or determine a game process (for example, the detail of the story, and the like).

Moreover, the embodiment related to the first invention explains the case in which the game result determination means determines a game result on the basis of a condition cleared by a player, the level value of the player, and the number of players who participate in the condition. However, the present invention is not limited to this example. For example, the game result determination means may determine a game result on the basis of a condition cleared by the player, and the level value of the player. Further, the game result determination means may determine a game result on the basis of a capability value set for the player (for example, the reputation of the player in the game, degree of proficiency of the player, and the like), along with or in place of the level value of the player.

The embodiment related to the first invention explains the case in which the RAM 103 of the terminal device 1 and the RAM 203 of the arcade server 2 function as the level value storing means, the CPU 101 of the terminal device 1 functions as the level value setting means, the CPU 201 of the arcade server 2 functions as the condition setting means, the condition achievement determination means, and the game result determination means. However, the present invention is not limited to this example. Which one of the terminal device 1, arcade server 2, and center server 3 comprises each of the means configuring the present invention can be selected accordingly.

For example, the RAM 203 of the arcade server 2 may function as the level value storing means, and the CPU 201 of the arcade server 2 may function as the level value setting means, the condition setting means, the condition achievement determination means, and the game result determination means. When designing the present invention in the above manner, the ROM 202 of the arcade server 2 has stored therein the game control program of the present invention, which causes the RAM 203 of the arcade server 2 to function as the level value storing means, and causes the CPU 201 of the arcade server 2 to function as the level value setting means, the condition setting means, the condition achievement determination means, and the game result determination means. Then, the CPU 201 of the arcade server 2 executes the game control program of the present invention, which is stored in the ROM 202, whereby the arcade server 2 comprises the level value storing means, level value setting means, condition setting means, condition achievement determination means, and game result determination means.

Furthermore, according to the embodiment related to the second invention, a player himself can select either the single mode in which a player participates in a mission in a game alone, or the multimode in which the player participates with other player, thus a player who is good at the mission, or a player having a high game skill can select the single mode, and at the same time a player who is not good at the mission, or a player having a low game skill can select the multimode. Therefore, it is possible to prevent that the game is discontinued by the player who cannot clear the condition that he is not good at, or the player having a low game skill. Since the player who tries to challenge a mission that he is good at, or the player having a high game skill can select the single mode, the player who is not good at the above-described set condition to be cleared, or the player having a low game skill does not depend on the player having a high game skill, thus the player having a high game skills does not have to feel troublesome. As a result, it is possible to develop attractiveness of online games, which is that the relationship among the players is prevented from being twisted due to the difference in the game skills among the players, and that a good relationship can be constructed among the players in which the players can communicate with one another by means of a game.

The embodiment of the second invention explains the case in which the terminal device 1 comprises the selecting means (CPU 101), and the arcade server 2 comprises the player number storing means (RAM 203), player number setting means (CPU 201), entry number storing means (RAM 203), entry number updating means (CPU 201), determination means (CPU 201), and condition setting means (CPU 201). In this case, a program which causes the CPU 101 to function as the selecting means is stored in the ROM 102 of the terminal device 1, and the ROM 202 of the arcade server 2 has stored therein a program which causes the CPU 201 to function as the player number setting means, entry number updating means, determination means, and condition setting means, and which also causes the RAM 203 to function as the player number storing means and entry number storing means. In this manner, the ROM 102 of the terminal device 1 may store a part of the game control program of the present invention, and the ROM 202 of the arcade server 2 may store the rest of the program.

Also, the ROM 202 of the arcade server 2 may have stored therein a program, i.e. the game control program of the present invention, which causes the CPU 201 to function as the selecting means, player number setting means, entry number updating means, determination means, and condition setting means, and which also causes the RAM 203 to function as the player number storing means and entry number storing means. In this case, the arcade server 2 is equivalent to the server of the present invention, which comprises the selecting means, player number storing means, player number setting means, entry number storing means, entry number updating means, and condition setting means.

The game control program of the present invention may also be stored in the ROM 302 of the center server 3. In this case, the center server 3 is equivalent to the server of the present invention. Moreover, the ROM 202 of the arcade server 2 may store a part of the game control program of the present invention, and the ROM 302 of the center server 3 may store the rest of the program.

The embodiment mentioned above explains the game system which comprises the plurality of terminal devices 1, the arcade server 2 connected communicably with the plurality of terminal devices 1 via the dedicated lines 5, and the center server 3 connected with the plurality of arcade servers 2 via the communication lines 4. However, the present invention is not limited to this example. For example, the present invention can be applied to a game system composed of a single game device (terminal device), a game system connected with a plurality of game devices (terminal devices) via communication lines, a game system in which a plurality of game devices (terminal devices) are connected to the server via the Internet, and other game system.

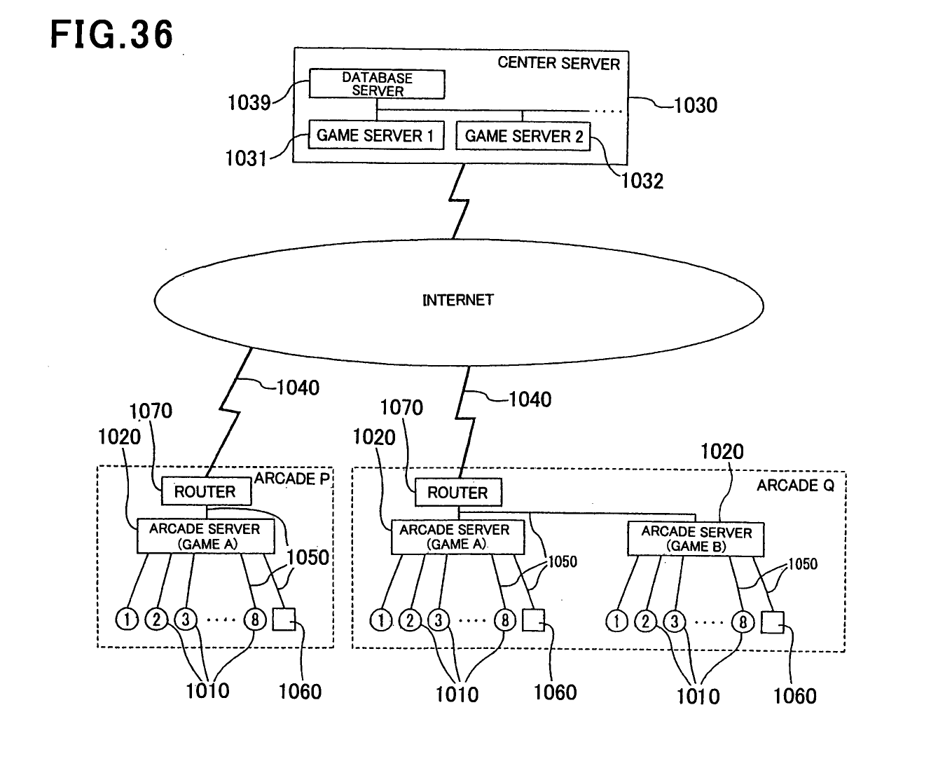

Next, another example of the game system according to the present invention is described. FIG. 36 is a configuration diagram showing another example of the game system according to the present invention. The game system comprises a plurality of terminal devices 1010, an arcade server 1020 connected communicably to the plurality of terminal devices 1010 via dedicated lines 1050, and a center server 1030 connected communicably to the plurality of arcade servers 1020 via communication lines 1040, and also a card machine 1060 for each arcade, which is connected to the arcade server 1020 via the dedicated line 1050. It should be noted that an arcade server 1020 for a game A, and an arcade server 1020 for a game B are installed in an arcade Q.

The center server 1030 comprises a database server 1039, and a plurality of game servers 1031,1032, and the like. The database server 1039 performs (1-1) data management for every ID data granted to each player, (1-2) authentication of a player at the time of a game start, and (1-3) transmission processing of game data.

Specifically, the database server 1039 manages (stores, sets, updates, and the like) ID data granted to each player, a password used when authenticate the player, the type of a game played by the player, the game data, and the like, regarding the abovementioned (1-1). Moreover, the game data includes, for example, the proceeding state of the game (character specific data, and the like), a character operated by the player, a level value or capability value of the character, an increased or decreased value in the capability value, and the like.

The database server 1039 also uses, for example, the ID data and password to authenticate the player, and permits participation in the game, regarding the abovementioned (1-2). Regarding the abovementioned (1-3), the database server 1039 further transmits the data of the character, from among the abovementioned game data, to the terminal device 1 on the basis of, for example, the ID data of the player.

The game servers 1031, 1032, and the like are installed in accordance with each executable game in the game system according to the present embodiment. It should be noted that one of the plurality of game servers corresponds to the game according to the present embodiment. The game servers 1031, 1032, and the like (also referred to as “game servers 1031 and the like” hereinafter) performs (2-1) a matching processing between the terminal devices 1010 installed in different arcades, and (2-2) traffic control for data transmission after matching.

Specifically, regarding the abovementioned (2-1), the game servers 1031 and the like determine, when a player participates in a game by operating the terminal device 1010, whether or not other player participates in the game. When it is determined that other player participates in the game, the game servers 1031 and the like matches the terminal device 1010 with a terminal device 1010 operated by the abovementioned other player. On the other hand, when it is determined that other player does not participate in the game, a CPU player is set. When setting the CPU player, the arcade server 1020 may be set as the CPU player, or the center server 1030 (or example, the game servers 1031 and the like) may be set as the CPU player.

The game servers 1031 and the like also performs traffic control for data transmission between the terminal devices 1 which are subjected to matching by the matching processing of the (2-1), regarding the abovementioned (2-2). For example, the game servers 1031 and the like transmit the data received from the terminal device 1, which is connected to the arcade server (for the game A) 1020 of an arcade P, to the terminal device 1 which is connected to the arcade server (for game A) 1020 of the arcade Q. In this manner, the arcade server 1020 according to the present embodiment directly receives the data only from the center server 1030, and does not perform data transmission directly between the arcade servers 1020.

The arcade server 1020 is connected to the center server 1030 via a router 1070. The router 1070 has a predetermined routing table. In the case where the plurality of arcade servers 1020 are installed in the same arcade, as with the case of the arcade Q shown in the figure, once receiving game data and the like from the center server 1030, the router 1070 refers to the routing table, and transmits the game data to the arcade server 1020 connected to the terminal device 1010, which is the destination, via the dedicated line 1050. Furthermore, in the case of performing data transmission between the terminal devices 1010 connected to each of the plurality of arcade servers 1020 installed in the same arcade, once receiving game data and the like from the terminal device 1010 via the arcade server 1020, the router 1070 refers to the routing table, and transmits the game data to the arcade server 1020 connected to the terminal device 1010, which is the destination, via the dedicated line 1050.

The arcade server 1020 performs (3-1) traffic control for data transmission between the center server 1030 and the terminal device 1010, or between the terminal devices 1010 connected to each of the plurality of arcade servers 1020 installed in the same arcade, and (3-2) downloading an application to the terminal device 1.

Specifically, regarding the abovementioned (3-1), the arcade server 1020 performs traffic control for transmission of the game data and the like between the center server 1030 and the terminal device 1010. However, when the terminal device 1010 as the destination is connected to the same arcade server 1020 or to a different arcade server 1020 installed in the same arcade, the game data and the like is not transmitted to the center server 1030, but to the terminal device 1010.

Moreover, regarding the abovementioned (3-2), at the time when a request signal for requesting downloading from the center server 1030 is received from the terminal device 1010, the arcade server 1020 downloads an application to this terminal device 1010. The application includes various data for the detail of a game (for example, image data, and the like), and a program, as well as a program for a board for allocating the functions on the game to input means (for example, a plurality of input switches, or the like, which is not shown) that the terminal device 1010 comprises. Further, downloading an application is performed not only by the arcade server 1020, but also by the center server 1030.

The terminal device 1010 is connected to the arcade server 1020 via the dedicated line 1050. The terminal device 1010 (4-1) performs downloading of an application, and (4-2) proceeds with a game. Specifically, regarding the abovementioned (4-1), once the power is turned on, the terminal device 1010 transmits a request signal for requesting downloading of an application to the arcade server 1020 and downloads an application. The downloaded application is stored in a region in a RAM or the like of the terminal device 1010 where the application can be stored temporarily. Moreover, regarding the abovementioned (4-2), the terminal device 1010 uses the downloaded application to proceed with a game. The game is proceeded as follows. The terminal device 1010 receives data for every ID data granted to each player by the database server 1039 at the time of a game start. During the game, the data of the terminal device 1010 in the same game and of other terminal device 1010 is transmitted/received through the center server 1030 via the arcade server 1020. However, when the abovementioned other terminal device 1010 is connected to the same arcade server 1020, or is connected to a different arcade server 1020 installed in the same arcade, the game data and the like are not transmitted to the center server 1030 but to the terminal device 1010. When the game ends, the game data which is updated during the game, or a game result itself is transmitted to the database server 1039. It should be noted that not only the terminal device 1010, but also the arcade server 1020 may perform proceeding of the game.

The card machine 1060 can communicate with the center server 1030 via the arcade server 1020. The card machine 1060 accepts an input operation of the personal information, which is performed by a player, and sells an ID card in which the ID data is stored. The ID card is used when a game is started, and the ID data is read by the ID card reader which the terminal device 1010 comprises.

In this embodiment, the RAM which is equipped in the game server 1031 of the center server 1030 functions as the level storing means for storing the level value of a player. The CPU which is equipped in the game server 1031 of the center server 1030 or the like functions as the level setting means for setting a predetermined level in accordance with a game result, and arcades, in the RAM (level storing means) equipped in the game server 1031 or the like, the level which is set by being related to the ID data of the player, as the level value. The CPU equipped in the terminal device 1010 functions as the condition setting means for setting a condition to be achieved as a game result by a player. The CPU equipped in the terminal device 1010 functions as the condition achievement determination means for determining whether or not the player clears a set condition. The CPU equipped in the terminal device 1010 functions as the game result determination means for, when it is determined that a condition is cleared, determining a game result on the basis of the condition cleared by the player, and the level value of the player.

Also in the embodiment, the CPU equipped in the terminal device 1010 functions as the selecting means for a player to select either to perform a play alone or to perform the play with other player in order to achieve a condition to be cleared, which is set in a game, in accordance with an input operation performed by the player. The CPU equipped in the game server 1031 of the center server 1030 or the like functions as the player number setting means for setting the number of players who perform the play. The RAM equipped in the game server 1031 of the center server 1030 functions as the player number storing means for storing the set number of players for each condition to be cleared. The RAM equipped in the game server 1031 of the center server 1030 or the like functions as the entry number storing means for storing, for each condition to be cleared, the number of entries of players into the condition. The CPU equipped in the game server 1031 of the center server 1030 or the like functions as the entry number updating means for updating the number of entries of players into the condition on the basis of a selection made by the selecting means, and storing the updated number of entries in the RAM (entry number storing means) equipped in the game server 1031 of the center server 1030 or the like. The CPU equipped in the game server 1031 of the center server 1030 functions as the determination means for determining whether or not the number of entries reach the number of players. The CPU equipped in the game server 1031 of the terminal device 1010 or the like functions as the condition setting means for setting a condition to be cleared for a player who performs the play, when the determination means determines that the number of entries reach the number of players.

Embodiments of the present invention is explained above. However, the embodiments merely illustrate concrete examples, and do not particularly limit the present invention, thus specific configurations for the means and the like can be changed accordingly in terms of the design. Further, the effects described in the embodiments of the present invention merely mention the most suitable effects generated by the present invention, thus the effects of the present invention are not limited to those described in the embodiments of the present invention.

What is claimed is:

1. A game system in which a plurality of terminal devices are connected to a server via communication lines, and in which a game can be executed by each of a plurality of players operating each of the terminal devices, the game system comprising:
a level value storing unit which stores a level value of a player;
a level value setting unit which sets a predetermined level in accordance with a game result, and stores a level, which is set with respect to the ID data of the player, in the level value storing unit as the level value;
a condition setting unit which sets a condition that the player should achieve as a game result;
a condition achievement determination unit which determines whether or not the player clears the condition which is set in the condition setting unit; and
a game result determination unit which determines, when the condition achievement determination unit determines that the condition set by the condition setting unit is cleared, a game result on the basis of the condition cleared by the player, and the level value of the player which is stored in the level value storing unit.

2. The game system according to claim 1, comprising a condition selecting unit which selects any one condition from a plurality of types of conditions in accordance with an input operation performed by a player, wherein the condition setting unit sets a condition selected by the condition selecting unit.

3. The game system according to claim 1, wherein the game result determination unit determines the amount of money which is available in a game and is granted to the player as a game result.

4. The game system according to claim 1, wherein the server comprises an arcade server communicably connected to the plurality of terminal devices via dedicated lines, and a center server communicably connected to the arcade server via the communication line.

5. The game system according to claim 1, wherein the game result determination unit determines a game result also on the basis of the number of players who participate in a play for clearing the conditions.

6. The game system according to claim 1, wherein the game result determination unit determines a game result on the basis of a capability value set for the player, along with or in place of the level value of the player.

7. The game system according to claim 4, wherein the terminal device and the arcade server are provided with the level value storing unit, the terminal device is provided with the level value setting unit, and the arcade server is provided with the condition setting unit, the condition achievement determination unit, and the game result determination unit.

8. A server which is connected to a plurality of terminal devices via communication lines, and which configures a game system in which a game can be executed by each of a plurality of players operating each of the terminal devices, the server comprising:
a level value storing unit which stores a level value of a player;
a level value setting unit which sets a predetermined level in accordance with a game result, and stores a level, which is set with respect to the ID data of the player, in the level value storing unit as the level value;
a condition setting unit which sets a condition that the player should achieve as a game result;
a condition achievement determination unit which determines whether or not the player clears the condition which is set in the condition setting unit; and
a game result determination unit which determines, when the condition achievement determination unit determines that the condition set by the condition setting unit is cleared, a game result on the basis of the condition cleared by the player, and the level value of the player which is stored in the level value storing unit.

9. A game control method, which causes a server, which is connected to a plurality of terminal devices via communication lines and which configures a game system in which a game can be executed by each of a plurality of players operating each of the terminal devices, to function as:
a level value storing unit which stores a level value of a player;
a level value setting unit which sets a predetermined level in accordance with a game result, and stores a level, which is set with respect to the ID data of the player, in the level value storing unit as the level value;
a condition setting unit which sets a condition that the player should achieve as a game result;
a condition achievement determination unit which determines whether or not the player clears the condition which is set in the condition setting unit; and
a game result determination unit which determines, when the condition achievement determination unit determines that the condition set by the condition setting unit is cleared, a game result on the basis of the condition cleared by the player, and the level value of the player which is stored in the level value storing unit.

10. A game system in which a plurality of terminal devices are connected to a server via communication lines, and in which a game can be executed by each of a plurality of players operating each of the terminal devices, the game system comprising:
a selecting unit for a player to select either to perform a play alone or with other player in order to achieve a condition to be cleared, which is set in the game, in accordance with an input operation performed by the player;
a player number setting unit which sets the number of players who perform the play, on the basis of selection made by the selecting unit;
a player number storing unit which stores the set number of players for each condition to be cleared;
an entry number storing unit which stores the number of entries of the players into the condition for each condition to be cleared;
an entry number updating unit which updates the number of entries of the players into the condition and stores the number of entries in the entry number storing unit, on the basis of selection made by the selecting unit;
a determination unit which determines whether or not the number of entries stored in the entry number storing unit reaches the number of players stored in the player number storing unit; and
a condition setting unit which sets the condition to be cleared with respect to the player who performs the play, when the determination unit determines that the number of entries reaches the number of players.

11. The game system according to claim 10, comprising a standby image displaying unit for displaying a standby image which shows information related to the number of players and/or the number of entries, in response to a determination made by the determination unit that the number of entries does not reach the number of players.

12. The game system according to claim 10, comprising:
a condition achievement determination unit which determines whether or not the player clears the condition to be cleared; and
a reward payout unit which, when the condition achievement determination unit determines that the player clears the condition, proportionally distributes the amount of money available in the game, which is set in advance in accordance with the type of the condition, in accordance with the number of players who cleared the condition, and grants the money to each player.

13. The game system according to claim 10, comprising:
a condition achievement determination unit which determines whether or not the player clears the condition to be cleared; and
a reward payout unit which, when the condition achievement determination unit determines that the player clears the condition, proportionally distributes the amount of money available in the game, which is set in advance in accordance with the type of the condition, in accordance with the level of players who cleared the condition, and grants the money to each player.

14. The game system according to claim 10, wherein the server comprises an arcade server communicably connected to the plurality of terminal devices via dedicated lines, and a center server communicably connected to the arcade server via the communication line.

15. The game system according to claim 11, wherein the standby image displaying unit is provided in the terminal device.

16. The game system according to claim 14, wherein the selecting unit is provided in the terminal device, and the player number storing unit, the player number setting unit, the entry number storing unit, the entry number updating unit, the determination unit, and the condition setting unit are provided in the arcade server.

17. The game system according to claim 15, wherein the standby image displaying unit comprises a touch panel which enables the player to perform an input operation.

18. A server which is connected to a plurality of terminal devices via communication lines, and which configures a game system in which a game can be executed by each of a plurality of players operating each of the terminal devices, the server comprising:
a selecting unit for a player to select either to perform a play alone or with other player in order to achieve a condition to be cleared, which is set in the game, in accordance with an input operation performed by the player;
a player number setting unit which sets the number of players who perform the play, on the basis of selection made by the selecting unit;
a player number storing unit which stores the set number of players for each condition to be cleared;
an entry number storing unit which stores the number of entries of the players into the condition for each condition to be cleared;
an entry number updating unit which updates the number of entries of the players into the condition and stores the number of entries in the entry number storing unit, on the basis of selection made by the selecting unit;
a determination unit which determines whether or not the number of entries stored in the entry number storing unit reaches the number of players stored in the player number storing unit; and
a condition setting unit which sets the condition to be cleared with respect to the player who performs the play, when the determination unit determines that the number of entries reaches the number of players.

19. A game control method, which causes a server, which is connected to a plurality of terminal devices via communication lines and which configures a game system in which a game can be executed by each of a plurality of players operating each of the terminal devices, to function as:
a selecting unit for a player to select either to perform a play alone or with other player in order to achieve a condition to be cleared, which is set in the game, in accordance with an input operation performed by the player;
a player number setting unit which sets the number of players who perform the play, on the basis of selection made by the selecting unit;
a player number storing unit which stores the set number of players for each condition to be cleared;
an entry number storing unit which stores the number of entries of the players into the condition for each condition to be cleared;
an entry number updating unit which updates the number of entries of the players into the condition and stores the number of entries in the entry number storing unit, on the basis of selection made by the selecting unit;
a determination unit which determines whether or not the number of entries stored in the entry number storing unit reaches the number of players stored in the player number storing unit; and
a condition setting unit which sets the condition to be cleared with respect to the player who performs the play, when the determination unit determines that the number of entries reaches the number of players.
